(19) United States
(12) Patent Application Publication
(10) Pub. No.: US 2026/0329541 A1
(43) Pub. Date: Oct. 22, 2026

(54) CHIP DESIGN ARCHITECTURES AND OPERATIONS

(71) Applicant: NEO Semiconductor, Inc., San Jose, CA (US)

(72) Inventor: Fu-Chang Hsu, San Jose, CA (US)

(21) Appl. No.: 19/467,683

(22) Filed: Feb. 2, 2026

Related U.S. Application Data
(60) Provisional application No. 63/751,839, filed on Jan. 31, 2025.
(60) Provisional application No. 63/816,489, filed on Jun. 2, 2025.

(51) Int. Cl. G06F 7/544; G06F 7/483

(52) U.S. Cl. CPC G06F 7/5443; G06F 7/483

(57) ABSTRACT

An AI processing apparatus includes a memory array storing weight data having positive and negative values represented in binary integer and fraction parts. A multiply-accumulate (MAC) circuit coupled to the memory array receives input data and comprises unit circuits generating currents representing products of input and weight bits, with sign handling for opposing or selectively enabled current paths corresponding to positive and negative products. A summing node combines the currents into a summed voltage representing a net signed accumulation. A comparator circuit compares the summed voltage against adjustable or dynamically scaled reference voltages to produce comparison outputs. An encoder encodes the comparison outputs into a multi-bit digital representation, and an activation circuit applies a non-linear function to the digital representation to generate a final output. The MAC circuit processes floating-point data by sequentially handling exponent and fraction components to produce and combine intermediate results at different power-of-two levels.

### CROSS REFERENCE TO RELATED APPLICATIONS

This application claims the benefit of priority under 35 U.S.C. 119(e) based upon U.S. Provisional Patent Application having Application No. 63/751,839 filed on Jan. 31, 2025, and entitled “Chip Design Architecture and Operations,” and U.S. Provisional Patent Application having Application No. 63/816,489 filed on Jun. 2, 2025, and entitled “Chip Design Architecture and Operations,” both of which are hereby incorporated herein by reference in their entireties.

### FIELD OF THE INVENTION

The present invention relates generally to the field of semiconductor memory devices and associated array architectures, and more particularly to three-dimensional (3D) memory cells, array structures, operations, and processes for fabricating such devices.

### BACKGROUND OF THE INVENTION

Conventional memory systems face significant challenges as electronic devices demand ever-higher performance, lower power consumption, and greater computational efficiency. Traditional architectures that separate memory storage from processing logic suffer from substantial energy and latency penalties due to frequent data movement across buses between memory and computing units, a limitation commonly referred to as the “memory wall.” In neural network applications, this bottleneck becomes particularly pronounced during inference and training phases that require massive parallel multiply-accumulate operations on large volumes of weights and activations. Existing 3D memory structures have not fully addressed the integration of efficient analog or digital computing capabilities directly within high-density arrays, nor have they adequately resolved issues related to precision in low-power floating-point approximations, sign bit management for positive and negative weights, and scalable current summation and comparison mechanisms in compute-in-memory designs.

### SUMMARY

In various exemplary embodiments, chip design architectures and operations are disclosed relating to high-density non-volatile and volatile memory systems, including NOR-type flash memory, floating-body cell (FBC) configurations, and emerging compute-in-memory architectures. Such architectures are increasingly important in artificial intelligence (AI), machine learning, and neural network processing, where memory arrays are used not only for data storage but also for performing on-chip computations such as multiply-accumulate (MAC) operations, weight storage with sign handling, and activation functions within the memory itself.

In one embodiment, an AI processing apparatus comprises a memory array configured to store weight data having positive and negative values represented in binary integer and fraction parts with corresponding power-of-two values. A multiply-accumulate (MAC) circuit coupled to the memory array receives input data and includes unit circuits that generate currents representative of products of input and weight bits, with sign handling to produce currents in opposing directions or selectively enabled paths for positive and negative products. A summing node combines the currents to produce a summed voltage representative of a net signed accumulation. A comparator circuit compares the summed voltage against adjustable or dynamically scaled reference voltages to generate comparison outputs. An encoder encodes the comparison outputs into a multi-bit digital representation, and an activation circuit applies a non-linear function to the digital representation to generate a final output. The MAC circuit processes floating-point data by sequentially handling exponent and fraction components to generate and combine intermediate results corresponding to different power-of-two levels.

In another embodiment, a neural network computing system includes a memory array serving as synapses interconnecting multiple neuron layers of the neural network, storing weight data in binary integer and fraction parts with corresponding power-of-two values and minimum/maximum ranges. A MAC circuit receives input data representing activations from a prior neuron layer and generates signed currents with sign handling for positive and negative products. A summing node produces a summed voltage for net signed accumulation corresponding to a neuron output in a subsequent layer. A comparator circuit compares the summed voltage against adjustable or dynamically scaled reference voltages to generate comparison outputs. An encoder encodes the comparison outputs into a multi-bit digital representation, and an activation circuit applies a non-linear activation function to produce a final neuron output for propagation to a next neuron layer. The MAC circuit processes floating-point data by sequentially handling exponent and fraction components to generate and combine intermediate results corresponding to different power-of-two levels.

In a further embodiment, a method for performing computations in a neural network using in-memory processing includes storing weight data, including positive and negative values represented in binary integer and fraction parts with corresponding power-of-two values and minimum/maximum ranges, in a memory array that functions as synapses connecting neuron layers of the neural network. Input data representing activations from a prior neuron layer is received. Signed currents are generated in a MAC circuit coupled to the memory array, with each current corresponding to a product of an input data bit and a weight data bit and sign handling producing currents in opposing directions or selectively enabled paths for positive and negative products. The signed currents are summed to produce a summed voltage representative of a net signed accumulation for a neuron output. The summed voltage is compared against a plurality of adjustable or dynamically scaled reference voltages to generate comparison outputs. The comparison outputs are encoded into a multi-bit digital representation, and a non-linear activation function is applied to the digital representation to produce a final neuron output for propagation to a subsequent neuron layer. The MAC circuit processes floating-point data by sequentially handling exponent and fraction components to generate and combine intermediate results corresponding to different power-of-two levels.

Additional features and benefits of the exemplary embodiments of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1A shows an exemplary architecture of a neural network.

FIG. 1B shows one layer of the neural network.

FIG. 2 shows an embodiment of the binary fraction system according to the invention.

FIGS. 3A-B show an embodiment of the multiplication and accumulation MAC operation of a memory array using a binary fraction according to the invention.

FIGS. 4A-B show exemplary embodiments related to the disclosed architecture.

FIG. 5 shows an embodiment for implementing adder circuits.

FIGS. 6A-E show circuits associated with other embodiments of the invention.

FIGS. 7A-B show embodiments of a memory array and associated circuits.

FIGS. 8A-B show embodiments of switching circuits.

FIGS. 9A-B show embodiments to implement multiplication and accumulation (MAC) operations according to the invention.

FIGS. 10A-B show embodiments to implement multiplication and accumulation (MAC) operations according to the invention.

FIGS. 11A-B show formatting of a floating-point number.

FIG. 12A shows embodiments for in-memory computation using floating-point data.

FIG. 12B shows operation of a shift register shown in FIG. 12A.

FIGS. 13A-C show embodiments for in-memory computation using floating-point data.

FIG. 14 shows an embodiment of a multiply-accumulate circuit and its operation.

FIGS. 15A-16B demonstrate embodiments to adjust the data size and resolution for activation functions according to the invention.

FIGS. 17-20B demonstrate “back-propagation” operation used in a training process according to the invention.

FIGS. 21A-D show embodiments for in-memory computation using floating-point data.

FIGS. 22A-B show embodiments of a memory array and circuit architecture and exemplary neural network according to the invention.

FIG. 23A shows an embodiment of an AI chip architecture according to the invention.

FIG. 23B shows an embodiment in which the controller die and multiple DRAM dies are bonded together to form a high-bandwidth memory HBM chip.

FIG. 23C shows an embodiment in which the HBM die and the controller die are bonded on top of the GPU by using 3D bonding or integration technologies.

FIG. 24A shows one layer of a neural network.

FIG. 24B shows an exemplary neural network architecture.

FIG. 24C shows another embodiment of a memory array and circuit architecture using 3D memory cell technologies.

FIG. 25A-B shows exemplary neural networks according to the disclosed architecture.

FIGS. 26A-D show embodiments for running AI operations of the neural network.

FIG. 27A shows an embodiment of the architecture of a memory die.

FIG. 27B shows an exemplary embodiment related to the disclosed architecture.

FIGS. 28A-28C show the operation of a bank.

FIGS. 29A-29B show an embodiment of steps for bank operation.

FIGS. 30A-30B show another embodiment of steps for bank operation.

FIGS. 31A-D show embodiments of circuit implementation.

FIG. 32 shows an exemplary embodiment related to the disclosed architecture.

FIGS. 33A-B show embodiments of a synapse circuit for handling overflow in the adder.

FIG. 34A shows an embodiment of a chip implemented using 2D memory technology according to the invention.

FIG. 34B shows another embodiment of a chip implemented using 3D memory technology according to the invention.

FIG. 35A shows a MAC function block that receives inputs and weights to generate one output as an example.

FIG. 35B shows how to increase the number of input neurons without increasing the hardware, according to the invention.

FIG. 35C shows how to increase the number of output neurons without increasing the hardware, according to the invention.

FIG. 35D shows a neural network with additional output neurons, according to the invention.

FIG. 36 shows another embodiment of the architecture of a bank according to the invention.

FIG. 37 shows an exemplary embodiment related to the disclosed architecture.

FIG. 38A shows an embodiment of a multiply-accumulate circuit and its operation.

FIG. 38B shows that to accumulate negative data, the sign of either the input SI or the weight SW may be inverted.

FIG. 38C shows an embodiment for processing positive data and negative data according to the invention.

FIG. 38D shows another embodiment configured to process positive data and negative data according to the invention.

FIG. 38E shows an embodiment of a multiply-accumulate circuit and its operation.

FIG. 38F shows an embodiment of a multiply-accumulate circuit and its operation.

FIG. 39 shows an embodiment of encoding circuitry used to generate output data.

FIGS. 40A-C show embodiments of a configuration of a MAC circuit.

FIG. 41A shows the format of a floating-point number using an exponent and a fraction as an example.

FIG. 41B shows an exemplary embodiment related to the disclosed architecture.

FIG. 41C shows an exemplary embodiment related to the disclosed architecture.

FIG. 41D shows an embodiment that uses MAC circuits to generate results for each power from 2⁸ to 2², respectively.

FIG. 42A shows an example of multiplying an input and a weight.

FIG. 42B shows the powers of the multiplication results for each input bit, to and each weight bit, weights to weights.

FIG. 42C shows an exemplary embodiment related to the disclosed architecture.

FIGS. 43A-C show embodiments of circuit implementation of a MAC circuit according to the invention.

FIG. 44 shows an example of total current compared against reference currents.

FIGS. 45A-C show embodiments of MAC circuits according to the invention.

FIGS. 46A-C show embodiments of a multiply-accumulate circuit and its operation.

FIGS. 47A-B show how sign bits are connected in accordance with the invention.

FIG. 48A shows another embodiment of an AI circuit array.

FIG. 48B shows an embodiment of a complete AI processing architecture based on the AI circuit array shown in FIG. 48A.

### DETAILED DESCRIPTION

Those of ordinary skill in the art will realize that the following detailed description is illustrative only and is not intended to be in any way limiting. Other embodiments of the present invention will readily suggest themselves to skilled persons having the benefit of this disclosure. Reference will now be made in detail to implementations of the exemplary embodiments of the present invention as illustrated in the accompanying drawings. The same reference indicators or numbers will be used throughout the drawings and the following detailed description to refer to the same or like parts.

Embodiments of this invention may be applied to any two-dimensional (2D) or three-dimensional (3D) memory technologies, including but not limited to dynamic random-access memory (DRAM), floating body cells (FBC), NOR flash memory, NAND flash memory, ferroelectric random-access memory (FRAM), resistive random-access memory (RRAM), phase-change memory (PCM), magneto-resistive random-access memory (MRAM), static random-access memory (SRAM), read-only memory (ROM), electrically erasable programmable random-access memory (EEPROM), and many others.

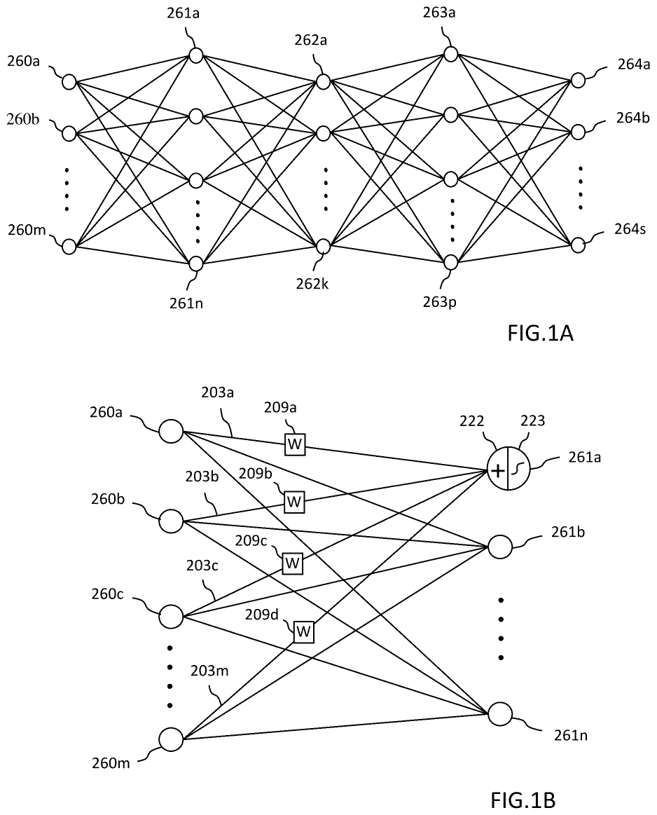

FIG. 1A shows an exemplary architecture of a neural network. The neural network may comprise multiple layers of neurons. As shown in FIG. 1A, neurons 260a to 260m are the neurons of the input layer, and neurons 264a to 264s are the neurons of the output layer. There may be multiple layers of neurons such as layers 261a to 261n, layers 262a to 262k, and layers 263a to 263p between the input layer and the output layer. These layers are called hidden layers. Each layer may have various numbers of neurons.

FIG. 1B shows one layer of the neural network. Neurons 260a to 260m are input neurons and neurons 261a to 261n are output neurons. Each output neuron 261a to 261n is connected to all the input neurons 260a to 260m through synapses 203a to 203m. Each synapse represents a value called ‘weight’ such as weights 209a to 209d. The weight determines the effect on the signal from the input neuron to the output neuron. The value of the weight may be positive, called a ‘positive weight’ or negative, called a ‘negative weight’. The basic operation of neural networks includes three functions. The first function is “multiplication” of the output from the input neurons 260a to 260d and the weights 209a to 209d. The second function is “accumulation”, for example, shown at 222 of the multiplication results. The multiplication and accumulation together are called a “MAC” operation. The third function is an ‘activation function’ 223 that converts linear inputs to non-linear outputs, such as sigmoid function or other suitable functions. The summation and activation are performed inside the output neurons 261a to 261n.

An artificial neural network array may comprise multiple neuron layers. The outputs of each layer are fed into the inputs of the next layer. The neural network may be trained to learn special tasks by changing the weights of each synapse through a training process.

A conventional AI chip stores the weights in memory chips, and then transfers the weights from the memory to the GPU to process the data. This separated data storage and processing results in significant delay and power consumption spent on transferring the weight data through the chip's data bus. To solve this problem, embodiments of the invention disclose a novel approach to process the data inside the memory chips.

For AI chip implementations, another important factor is “floating-point arithmetic (FP)”. Floating-point arithmetic (FP) is represented by subsets of real numbers using an integer with a fixed precision, called the significand, scaled by an integer exponent of a fixed base. Numbers of this form are called floating-point numbers. For example, the floating-point number for binary data 1101.01 is 1.10101×2³. In this example, 10101 is called the “fraction” or “mantissa” and 3 is called the “exponent” of the base “2”. The computation of floating-point numbers is quite complicated because of the limitations of finite precision. The computer must round the result of a floating-point calculation to fit it back into its finite representation. This can introduce small rounding errors. Rounding errors can accumulate, which can impact the accuracy of subsequent calculations. Therefore, the computer must tradeoff between accuracy and the range of numbers that can be represented.

To perform floating-point operations, a GPU or CPU must be used to utilize an add-on floating-point unit (FPU), which is hardware designed to carry out floating-point operations. It also needs a floating-point unit emulator, which is a floating-point library in software. This results in a separate system architecture that stores data in memory chips and executes data processing in the GPU. This greatly increases the latency and power consumption by transferring data between the memory chips and GPU.

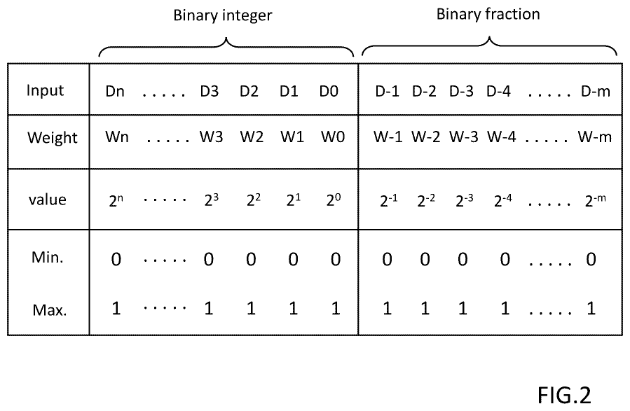

To solve this issue, as shown in embodiments illustrated in FIGS. 2-10, the invention discloses a novel approach by performing in-memory AI computations using a “binary fraction” rather than a floating-point number. This approach enables a memory array using binary fractions stored in memory cells to perform the multiplication and accumulation (MAC) function. Therefore, it greatly reduces the latency and power consumption spent in transferring the data between the memory chips and the GPU.

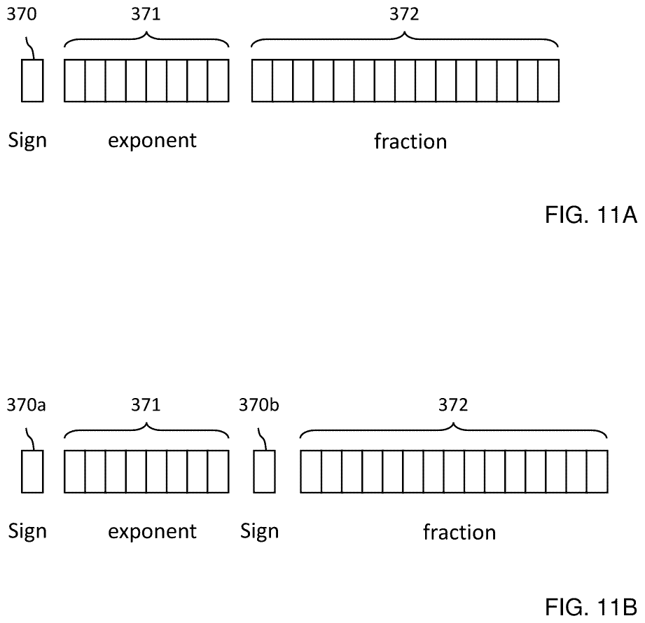

In other embodiments, shown in FIGS. 11A-14, the invention discloses a novel approach to perform the in-memory AI computation using floating-point numbers.

FIG. 2 shows an embodiment of the binary fraction system according to the invention. The input may comprise multiple bits of data, Dn to D−m as shown. Where, Dn to D0 represents binary integers. D−1 to D−m represents binary fraction. The Dn bit represents the value of 2ⁿ. The D−m bit represents the value of 2^{-m}. For example, assume n=m=7, the range of the integer part is from 0 to 255 with basic unit 1, and the range of the fraction part is from 0 to 0.9921875, with basic unit 0.0078125. Similarly, the weight may comprise a binary integer part, Wn to W0, and a binary fraction part, W−1 to W−m, as shown.

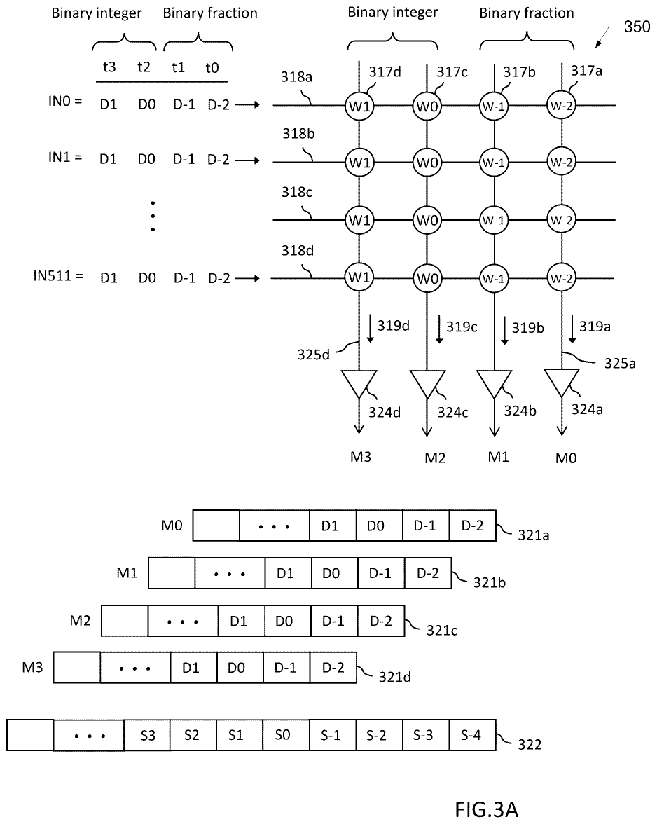

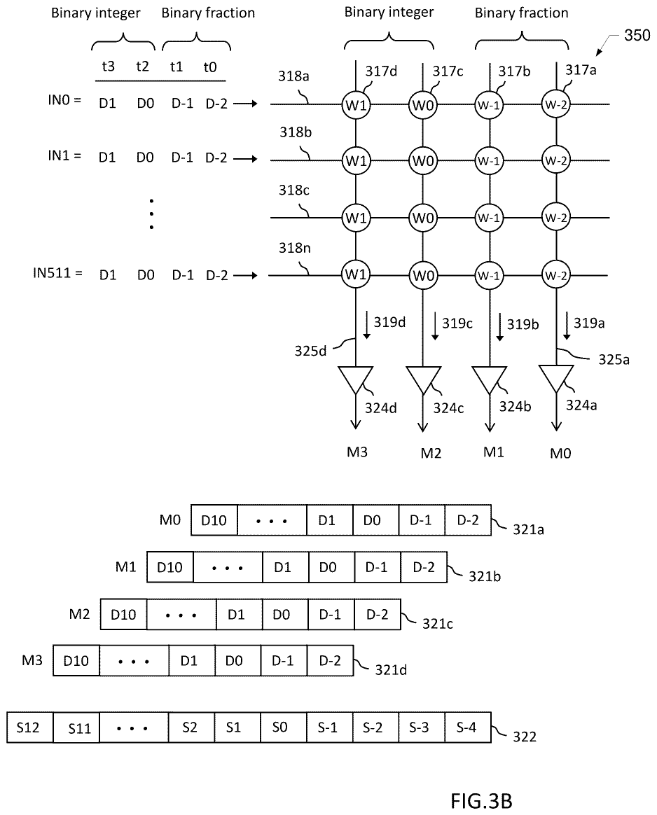

FIG. 3A shows an embodiment of the multiplication and accumulation (MAC) operation of a memory array using a binary fraction according to the invention. As illustrated in FIG. 3A, there are 512 input data, IN0 to IN511, used for an example. Assume each input data comprises two binary integer bits, D1 and D0, and two binary fraction bits, D−1 and D−2. The four bits, D−2, D−1, D0, and D1 of IN0 are sequentially loaded into a memory array 350 using the input line 318a at times t0, t1, t2, and t3, respectively.

The memory array 350 may comprise 512 synapses. Each synapse comprises four memory cells, such as memory cells 317a to 317d. The memory cells 317c and 317d store two bits of binary integer weights, W0 and W1, and the memory cells 317a and 317b store two bits of binary fraction weights, W−2 and W−1, respectively.

The input data D−2 to D1 may turn on or off the cells 317a to 317d according to the weight in the cells. If both the input data and the weight are 1, the cell will be turned on to conduct a current to indicate data 1. If either the input data or the weight is 0, the cell will be turned off to indicate data 0. This operation performs a “multiplication” function that multiplies the input data and the weight. Sense amplifier 324a to 324d will sense the current to determine the output data M0 to M3.

The sense amplifiers 324a to 324d each generate a one-bit digital output. This eliminates the analog current conversion used in conventional in-memory computing. This design results in a “pure digital” design for the MAC function. Compared with conventional analog design using A/D converters, this design has advantages including higher precision, smaller circuit layout size, and lower power consumption.

The output data, M0 to M3, of the sense amplifiers 324a to 324d is sent to four adder circuits 321a to 321c, respectively. The data M0 to M3 are located or loaded to the D−2, D−1, D0, and D1 bits, respectively, in each adder 321a to 321d as shown. Note each adder 321a to 321d shifts one bit location left because the cells 317a to 317d store different weights, W−2 to W1, respectively.

After that, the data stored in the adders 321a to 321c are added by an adder 322 to generate 8-bit data, S−4 to S3. The S3 bit is a carry bit from the S2 bit. This data represents the result of the multiplication of the D−2 to D1 bits of the input, IN0, with the W−2 to W1 bits stored in the cells 317a to 317d.

Referring now to FIG. 3B, the next input IN1 is loaded into the memory array 350 using the input line 318b. In a repetitive process, the inputs IN0 to IN511 are sequentially loaded into the memory array 350 using the input lines 318a to 318n to repeat the process shown in FIG. 3A. Each input data will be applied to the associated cells to generate the cell currents 319a to 319d and then converted to output data, M0 to M3. The output data generated from each input will be repeatedly loaded to the D−2 to D1 bit locations in each adder 321a to 321d, as described in FIG. 3A, and added to the previously stored data. As a result, the data stored in each adder 321a to 321d becomes the accumulation result of the output data generated from the inputs IN0 to IN511. Because the example uses 512 four-bit inputs, each adder 321a to 321d may comprise 13 bits, D−2 to D10. The D10 bit is a carry bit from the D9 bit.

After that, the data stored in the adders (321a) to (321c) are added by the adder 322 to generate 17-bit data, S−4 to S12. The S12 bit is a carry bit from the S11 bit. This data represents the result of the multiplication and accumulation of the inputs, IN0 to IN511 with the weights stored in the memory cells.

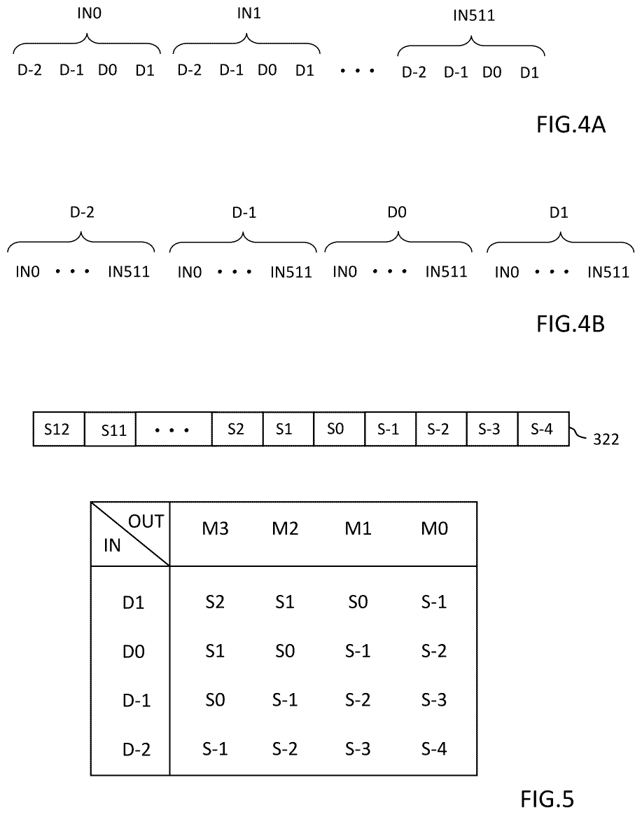

FIG. 4A shows the sequence of applying the input data, IN0 to IN511, shown in FIG. 3B. The inputs, IN0 to IN511, are sequentially applied to the input lines 318a to 318n. For each input, D−2 to D1 bits may be sequentially applied.

FIG. 4B shows another embodiment of applying the input data. First, the D−2 bit of the inputs IN0 to IN511 are sequentially applied to the input lines 318a to 318n. Then, the process is repeated with D−1, D0, and D1 bits. Note these two sequences shown in FIGS. 4A-B are examples only. The input data may be applied using any suitable sequences.

FIG. 5 shows another embodiment for implementing the adder circuits 321a to 321d and 322 shown in FIGS. 3A-B. In this embodiment, the adders 321a to 321d may be eliminated and the entire accumulation operation may be carried out by one adder 322. FIG. 5 shows the bit locations, S−4 to S12 of the adder 322 and a table of the bit locations in which the output data, M0 to M4, from the sense amplifiers 324a to 324d shown in FIGS. 3A-B will be located.

For example, when input data, D−2 to D1 bits, are located, the corresponding output data M0 will be located to the S−4 to S−1 bit locations in the adder 322. The corresponding output data M1 will be located to the S−3 to S0 bit location in the adder 322. The corresponding output data M2 will be located to the S−2 to S1 bit location in the adder 322. The corresponding output data M3 will be located to the S−1 to S2 bit location in the adder 322. The located data will be added to the previously stored data.

This process may be repeated for all the inputs IN0 to IN511 to add all the output data. As a result, the final data in the adder 322 represents the result of the multiplication and accumulation of the inputs IN0 to IN511 with the weights stored in the memory cells. Compared with the embodiment shown in FIGS. 3A-B, this embodiment can greatly reduce the circuit layout size.

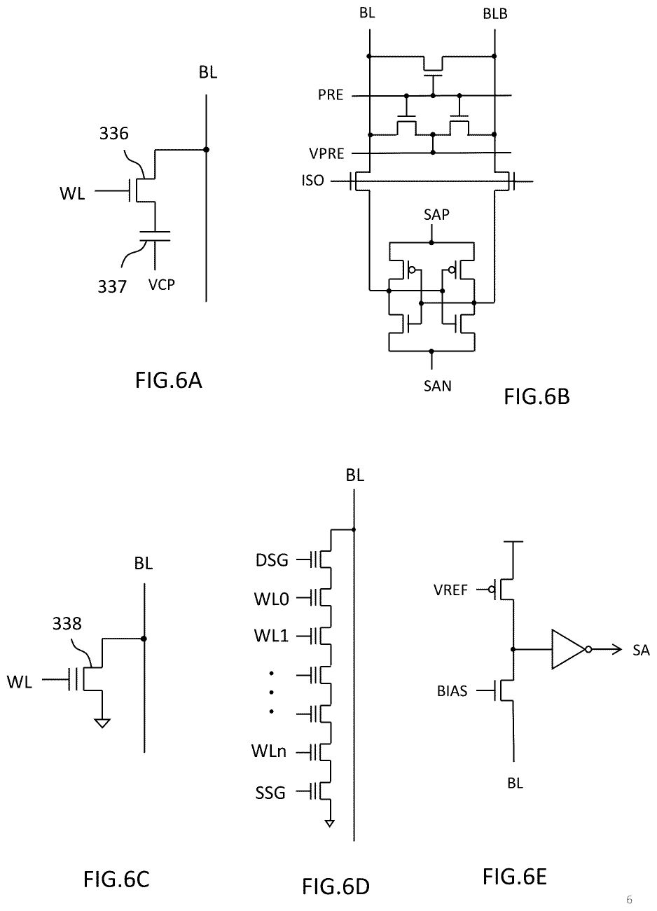

FIGS. 6A-E show circuits associated with other embodiments of the invention. It should be noted that for the embodiments shown in FIGS. 3A-B, because only one input line 318a to 318n is selected at one time, this embodiment may be applied to the traditional one-transistor-one-capacitor (1T1C) DRAM cells shown in FIG. 6A. The DRAM cell may comprise a select transistor 336 and a capacitor 337. The DRAM cell may be formed as 2D or 3D array structures. The capacitor 337 connects to a capacitor plate voltage, VCP, such as ½ VDD or 0V. In this embodiment, the input lines 318a to 318n, shown in FIGS. 3A-B, may be connected to word lines (WL) and the output lines 325a to 325d may be bit lines (BL). The cell capacitor may store VDD or 0V to represent data 1 or 0.

When the input data is 1 and the data stored in the cell capacitor is 1, charge-sharing may occur to increase the voltage of the output lines 325a to 325b to represent data 1. When the input data is 1 and the data stored in the cell capacitor is 0, charge-sharing may occur to decrease the voltage of the output lines 325a to 325b to represent data 0. When the input data is 0, no matter if the cell data is 1 or 0, the cell will be turned off thus the voltage of the output lines 325a to 325d will not increase, which represents data 0. Because the data stored in the capacitors of DRAM cells will be destroyed after charge-sharing, a “write-back” operation may be applied after the read operation to write the read data back to the cells.

In this embodiment, the sense amplifiers 324a to 324d may use the traditional latch-type of sense amplifiers used in DRAM, as shown in FIG. 6B. The sense amplifiers 324a to 324d may sense the voltage of the output lines 325a to 325d to generate the output data M0 to M3. Besides that, all the other operations for the adders 321a to 321d and 322 shown in FIGS. 3A-B and FIG. 5 and the input data sequences shown in FIGS. 4A-B may remain the same. By using this embodiment, the pure-digital MAC operation may be performed by a traditional DRAM cell array. This can greatly reduce the delay and power consumption spent in transferring the data from DRAM chips to GPU for MAC operations.

Besides 2D or 3D DRAM, the invention may be applied to any other memory technologies, including but not limited to 2D or 3D floating body cells, FRAM, RRAM, MRAM, PCM, NOR flash memory cells shown in FIG. 6C, NAND flash memory cells shown in FIG. 6D, ROM, and SRAM cells. These memory cells (except SRAM) may use a current-sensing type of sense amplifier shown in FIG. 6E. Using the invention in any other memory technologies is within the scope of the invention.

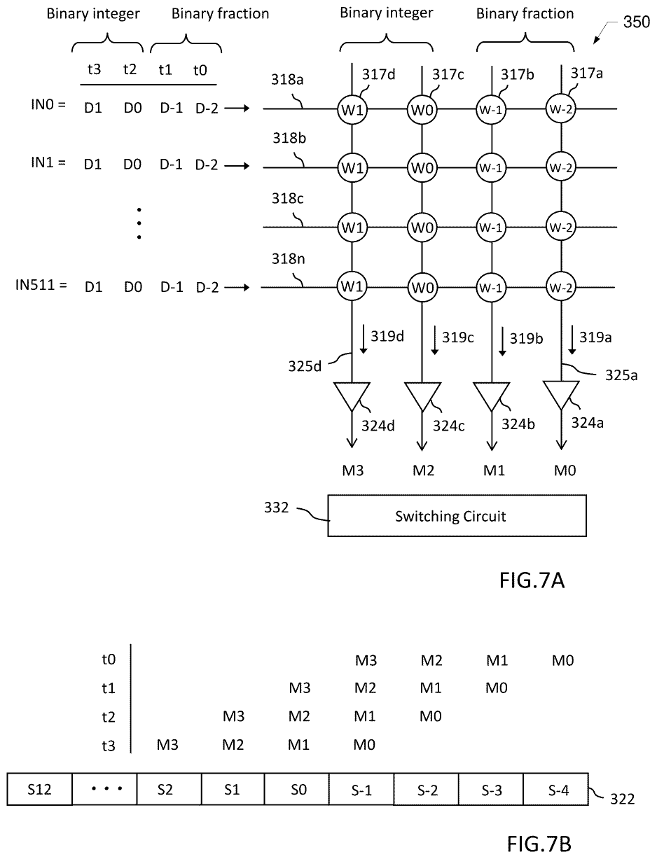

FIGS. 7A-B shows another embodiment to implement the multiplication and accumulation (MAC) operation based on the embodiment shown in FIGS. 3A-B according to the invention.

FIG. 7A shows memory array 350 having cells, such as 317a to 317d to store weights, W−2 to W1, input lines 318a to 318n, output lines 325a to 325d, and sense amplifiers 324a to 324d. The memory array 350 may receive multiple input data such as IN0 to IN511 to perform multiplication of the input data and the weights stored in the cells.

Assume each input comprises four bits, D−2, D−1, D0, and D1. When the first input, IN0, is input, its four-bit data, D−2, D−1, D0, and D1, are sequentially applied to the input line 318a at time t0, t1, t2, and to t3, respectively, to perform multiplication with the weights stored in the cells 317a to 317d to generate output data M0 to M3 from the sense amplifiers 324a to 324d. The output data M0 to M3 will be loaded to an adder 322 as described in FIG. 5. A switching circuit 332 may switch the outputs, M0 to M3, of the sense amplifiers 324a to 324d to the desired bit location in the adder 322 shown in FIG. 7B.

FIG. 7B shows adder 322. At time t0, the outputs M0 to M3 shown in FIG. 7A will be loaded to the S−4 to S−1 bits of the adder 322, respectively. At time t1, the outputs M0 to M3 will be loaded to the S−3 to S0 bits of the adder 322, respectively. Then, the data of S−3 to S0 bits will be added with S−4 to S−1 bits by the adder 322. At time t2, the outputs M0 to M3 will be loaded to the S−2 to S1 bits of the adder 322, respectively. Then, the data of S−2 to S1 bits will be added. At time t3, the outputs M0 to M3 will be loaded to the S−1 to S2 bits of the adder 322, respectively, Then, the data of S−1 to S2 bits will be added with S−4 to S1 bits by the adder 322.

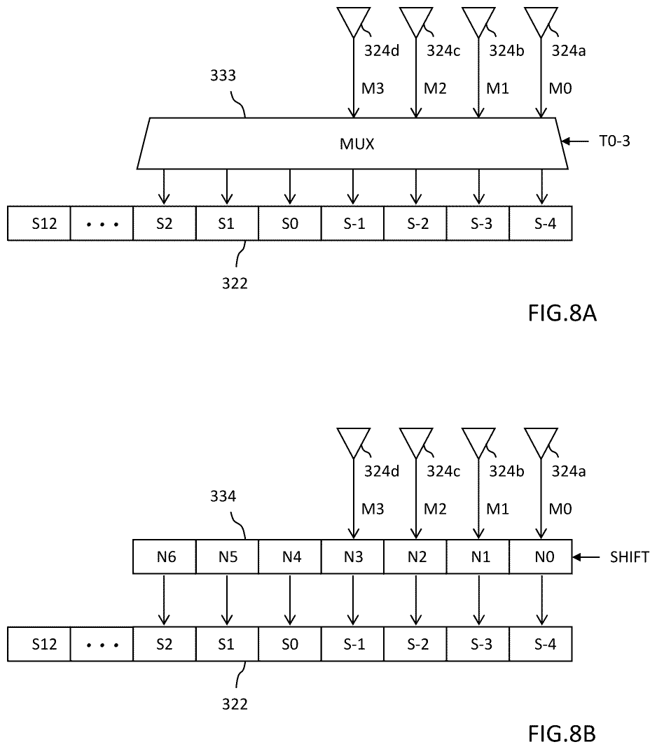

FIGS. 8A-B shows embodiments to implement the switching circuit 332 shown in FIG. 7A.

Referring to FIG. 8A, the switching circuit 332 may be implemented by using a multiplexer circuit 333. The multiplexer 333 loads the outputs M0 to M3 to the desired bit locations of the adder 322 according to the control signals T0-3. The control signals T0-3 select the bit locations according to the table shown in FIG. 7A.

FIG. 8B shows another embodiment that uses a shift register 334 to implement the switching circuit 332. The outputs M0 to M3 are loaded to N0 to N3 bits of the shift register 334. Next, the SHIFT signal may apply 0 to 3 clocks to shift the data to the desired bit location shown in table in FIG. 7B. Next, the data may be loaded to the adder 322.

Referring to FIGS. 7A-B, after the D−2, D−1, D0, and D1 bits of IN0 data is loaded to the input line 318a and the output data M0 to M3 are loaded to the S−4 to S2 bits of the adder 322. The D−2, D−1, D0, and D1 bits of the next input, IN1, may be applied to the next input line 318b, and the process described in FIGS. 7A-B may be repeated to load the new output data M0 to M3 to the S−4 to S2 bits of the adder 322 and added with the previous data. This process may be repeated until all the inputs, IN0 to IN511, are located. Then, the data stored in the adder 322 represents the result of the multiplication and accumulation (MAC) of the inputs, IN0 to IN511, with the weights, W−2 to W1, stored in the corresponding cells.

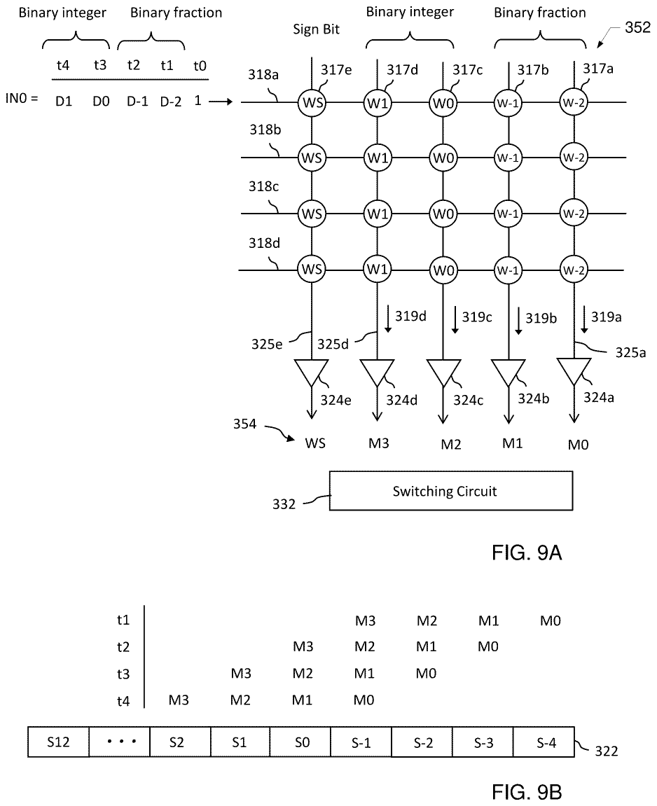

FIGS. 9A-B shows other embodiments to implement the multiplication and accumulation (MAC) operation according to the invention. These embodiments are similar to the embodiments shown in FIGS. 7A-B except that an additional “weight sign (WS)” bit is added to the weights thereby forming a modified memory array 352. This allows “negative weights” to be used. The WS bit may be stored in a memory cell such as cell 317e to indicate that the weight stored in the cells 317a to 317d is positive or negative. For example, if the WS bit is 1 or 0, it may indicate the weight is positive or negative, respectively.

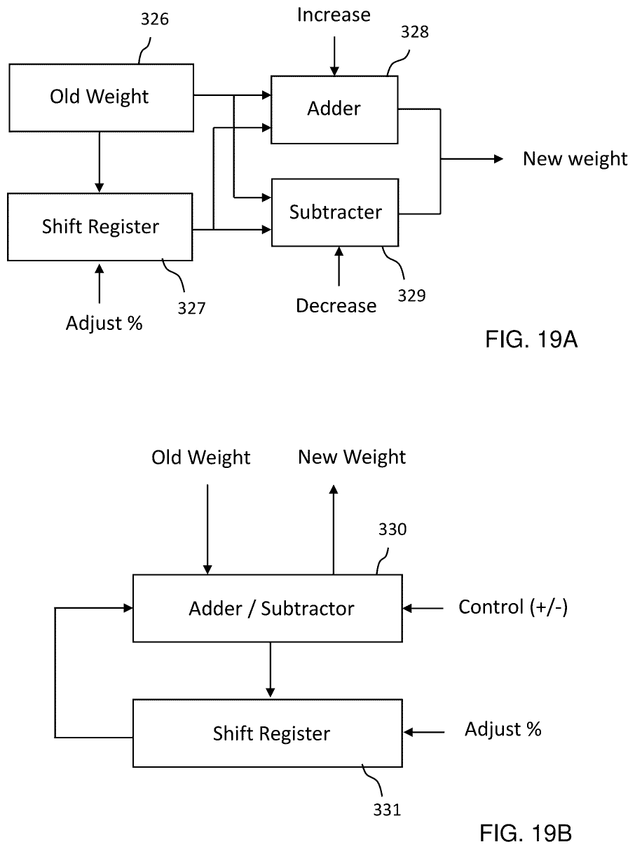

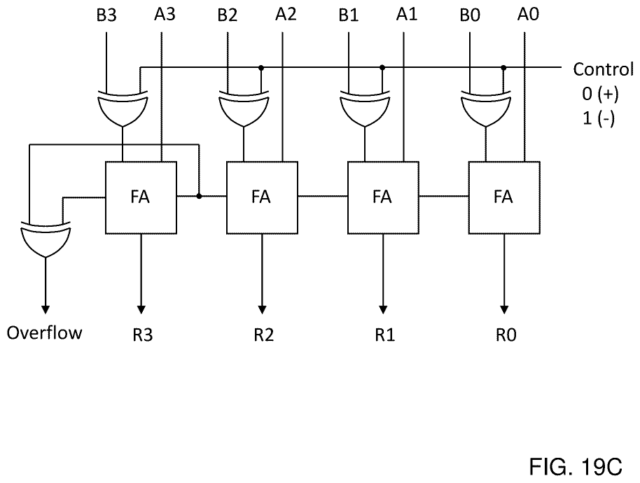

During the forward-propagation operation, the input applies data 1 (VDD) to the selected input line 318a at time t0. This may turn on the cell 317e to read the WS bit stored in the cell 317e to the output, shown by the output WS 354 of the sense amplifier 324e. Then, from time t1 to t4, the D−2, D−1, D0, and D1 bits of the input may be sequentially applied to the input lines 318a to perform the multiplication of the input data, D02 to D1, with the weight, W−2 to W1, and generate the outputs M0 to M3. The switching circuit 332 may load the outputs, M0 to M3, to the bit locations shown in the table in FIG. 9B. This operation is similar to the embodiments shown in FIGS. 7A-B. However, in this embodiment, the switching circuit 322 is an adder/subtractor circuit as shown in FIG. 19C. If the WS bit 354 is 1 “positive weight”, the output data, M0 to M3, will be added to the previous data stored in the adder/subtractor 322. If the WS bit 354 is 0 “negative weight”, the output data, M0 to M3, will be subtracted from the previous data stored in the adder/subtractor 322. By using this configuration and process, the functions of positive/negative weights are realized.

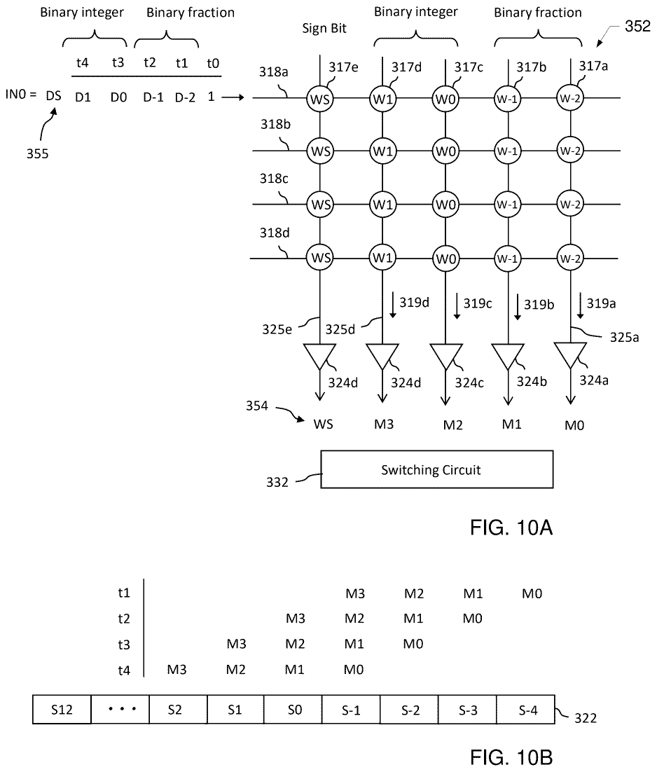

FIGS. 10A-B shows other embodiments to implement multiplication and accumulation (MAC) operations according to the invention. These embodiments are similar to the embodiments shown in FIGS. 9A-B except that an additional “data sign DS” bit 355 is added to the data. This allows “negative input data” to be used. The DS bit 355 does not need to be sent to the input line. Instead, the DS bit 355 and the WS bit 354 are used together to determine the operation of the adder/subtractor 322. For example, if both the DS bit 355 and WS bit 354 are 1 or 0, the output data, M0 to M3, is added to the previous data stored in the adder/subtractor 322. If one of the DS bit 355 or WS bit 354 is 1 and the other is 0, the output data, M0 to M3, is subtracted from the previous data stored in the adder/subtractor 322.

FIGS. 11A-14 show other novel approaches to perform the in-memory AI computation using floating-point numbers.

FIGS. 11A-B shows examples of the format of a floating-point (FP) number. A floating-point number is a way to represent real numbers in computing, using a combination of a fraction and an exponent in binary notation. The term “floating-point” refers to the fact that the decimal point can be positioned anywhere in the number, allowing for the representation of very large and very small numbers.

FIG. 11A shows the format of a floating-point number. In one embodiment, the floating-point number comprises a “sign” bit 370 to represent the positive/negative sign of the number, multiple “exponent” bits 371 to represent the number's magnitude, and multiple “fraction” or “mantissa” bits 372 to represent the number's significant digits. The most popular floating-point format for AI applications is FP16, which has 16 bits—one sign bit, 5 exponent bits, and 10 fraction bits. There are also other floating-point formats such as FP32, FP64, BF16, and so on.

FIG. 11B shows another example of the format of floating-point numbers. In this format, the floating-point number comprises a sign bit 370a to represent positive/negative exponents, and another sign bit 370b to represent positive/negative fractions. Generally, the format shown in FIG. 11B may be converted to the format shown in FIG. 11A by adding a constant value called “bias” to convert the exponent into a positive range to simplify the calculations. For example, assuming the format in FIG. 11A has N exponent bits 371, the number of the exponent may be subtracted by 2N−1 to obtain the final exponent. This will move the range of the exponent to cover −(2N−1) to +(2N−1).

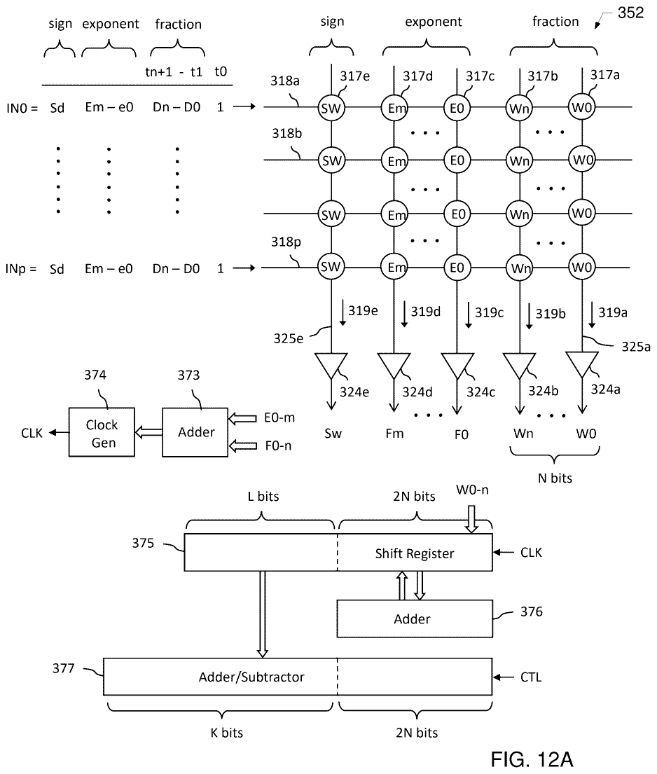

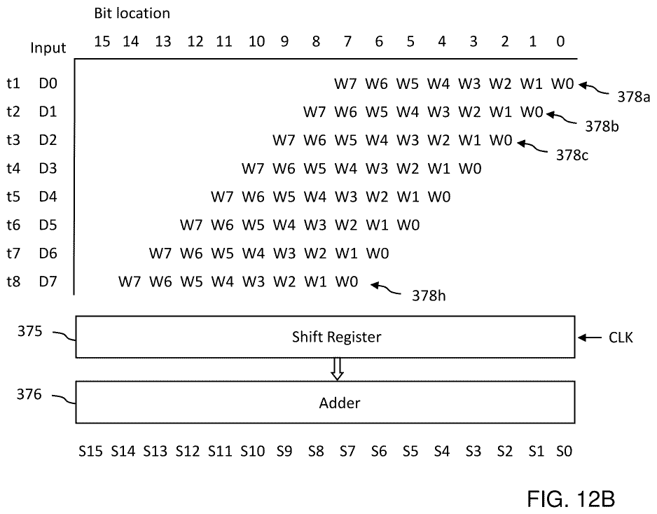

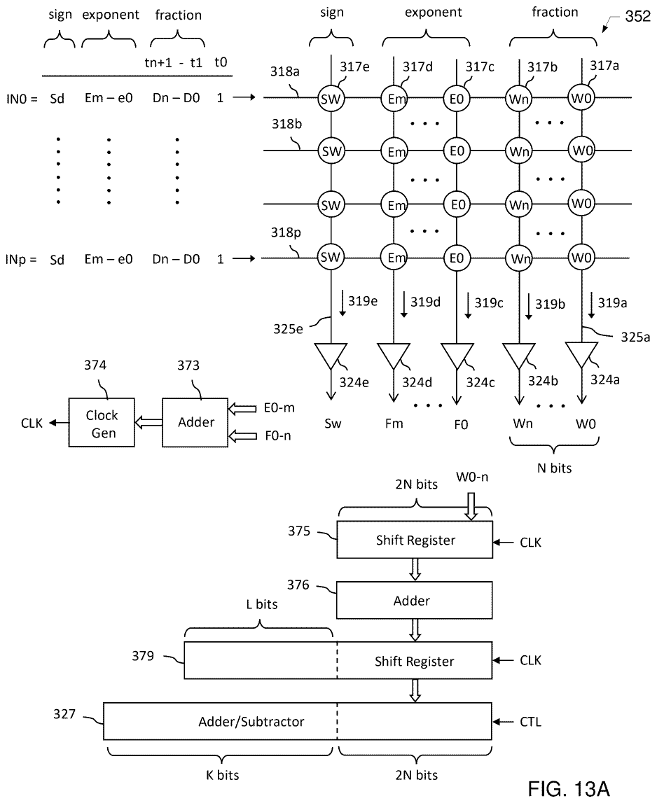

FIG. 12A shows an embodiment to implement the multiplication and accumulation (MAC) operations based on the floating-point number shown in FIG. 11A according to the invention. Assuming multiple inputs, IN0 to INp, are applied to the input lines 318a to 318p to perform multiplication with the weights stored in the memory cells of the array 352. Each input may comprise a sign bit (Sd), multiple exponent bits (E0-m), and multiple fraction bits (D0-n). Cells 317a to 317e may store digital (binary) data to represent a weight. A weight may comprise a sign bit (Sw), multiple exponent bits (F0-m) and multiple fraction bits (W0-n).

It should be noted that in the floating-point format shown in FIGS. 11A-B, a data ‘1’ is removed before the fraction bits to reduce the number of the bits. Therefore, a data ‘1’ bit may be added back to be the most significant bit of the fraction of the input data and the weight shown in FIG. 12A.

Referring again to FIG. 12A, at time t0, input data 1 (VDD) is applied to the input line 318a to read the sign bit (Sw) stored in the cell 317e and the exponent bits (E′0-m) stored in the cells 317c to 317d. The data will be sensed by the sense amplifiers 324c to 324e. The sign bit (Sw) will be compared with the sign bit (Sd) of the input to determine the operation of the adder/subtractor 377. If both the sign bits (Sw) and (Sd) are 1 or 0, the multiplication result will be positive, then the multiplication result will be added to the previous data stored in the adder/subtractor 377. If one of the sign bits (Sw) and (Sd) is 1 and the other is 0, the multiplication result will be negative, then the multiplication result will be subtracted from the previous data stored in the adder/subtractor 377.

The exponent bits (E′0-m) stored in the cells will be added with the exponent bits (E0-m) of the input by an adder circuit 373. The result will be sent to a clock generator 374 to generate the number of clock signals according to the result. These clocks will be sent to the shift register 375 to shift the data of the multiplication result. If bias is used in the exponent bits (E′0-m) and (E0-m), the data in the adder circuit 373 may be subtracted by the bias number times 2. If the resulting number is positive, the shift register 375 will shift the data to the left. If the resulting number is negative, the shift register 375 will shift the data to the right.

After the sign bit (Sw) and the exponent bits (F0-m) are read, from time t1 to tn+1, the fraction bit (D0 to Dn) of the first input (IN0) may be sequentially applied to the input line 318a to read the cells 317a to 317b. These input data (D0-n) may turn on or off the cells 317a to 317b according to the fraction bits (W0-n) stored in the cells. If both the input data and the weight are 1, the cell will be turned on to conduct a current to indicate data 1. If either the input data or the weight is 0, the cell will be turned off to indicate data 0. This performs a “multiplication” function for the fraction bits (D0-n) of the input with the fraction bits (W0-n) of the weight. The sense amplifiers 324a to 324b will sense the current to determine the output data (W0-n). The output data for each input bit (D0-n) will be sent to a shift register 375 sequentially.

FIG. 12B shows the operation of the shift register 375. Eight fraction bits are used as an example for demonstration. From time t1 to t8, the output data (W0-7) of the sense amplifiers 324a to 324b shown in FIG. 12A will be loaded to the shift register 375 sequentially. A clock signal (CLK) will shift the bits according to the bit location of the input data (D0-n). Then, the data will be sent to an adder circuit 376 to generate the sum of the data (S0-14).

For example, at time t1, the output data (W0-7) of the sense amplifiers are loaded to the bits 0 to 7 of the shift register 375 as shown by the arrow 378a. Because the input is D0, the output data (W0-7) will be loaded to the adder 376 without shifting. At time t2, the output data (W0-7) are loaded to the bits 0-7 of the shift register 375. Because the input is D1, the clock signal will shift the data one bit left, as shown by the arrow 378b. Then, the data will be loaded to the adder 376 and added with the previous data. At time t3, the output data (W0-7) are loaded to the bits 0-7 of the shift register 375. Because the input is D2, the clock signal will shift the data two bits left, as shown by the arrow 378c. Then, the data will be loaded to the adder 376 and added with the previous data. This operation will be repeated until the last data, shown by the arrow 378h, is processed. As a result, the sum of the multiplication results of the input data (D0-n) and the weight (W0-n) are stored in the adder 376.

Referring to FIG. 12A, after the sum of the multiplication is stored in the adder 376, the sum may be loaded from the adder 376 back to the shift register 375. Then, the clock generator 374 may generate a number of clock signals according to the result of the sum of the exponent bits (E0-m) and (E′0-m) to shift the data stored in the shift register 375. The data after shifting represents the final multiplication result for both the exponent part and the fraction part of both the input data with the weight.

This data will be loaded to an adder/subtractor circuit 377. According to the comparison result of the sign bits (Sw) and (Sd), the data may be added to or subtracted from the previous data in the adder/subtractor 377, controlled by the CTL signal. If both the sign bits (Sw) and (Sd) are 1 or 0, the multiplication result will be positive, then the multiplication result will be added to the previous data stored in the adder/subtractor 377. If one of the sign bits (Sw) and (Sd) is 1 and the other is 0, the multiplication result will be negative, then the multiplication result will be subtracted from the previous data stored in the adder/subtractor 377. This performs the “accumulation” function of neural networks.

This operation will be repeated until all the inputs (IN0-p) are applied to the input lines 318a to 318p to process the MAC operation. Then, the final data stored in the adder/subtractor 377 represents the result of the MAC operations for all the inputs IN0-INp and the weights stored in the cells. This result may be applied to an activation function of the neuron to generate the final output.

According to FIG. 12B, assuming both the fractions (D0-n) and (W0-n) have N bits, the adder 376 may have 2N bits, and the shift register 375 may have (2N+L) bits. L is determined by the sum of the exponent bits (E0-m) and (E′0-m). The adder/subtractor 377 may have (2N+K) bits. K is determined by the maximum possible number of the MAC operation result.

Because the first 2N bits of data are generated from multiplication of the fraction bits (D0-n) and (W0-n), these bits represent the bits with exponent number 0. The higher K bits represent the bits with exponent number 1 to K. For example, assuming the number 2N is 16 and K is 24. The 40-bit data stored in the adder/subtractor 377 will be the fraction, and the binary representation of K (24), which is 11000, will be the exponent.

It should be noted that to reduce the data size and required computations, the number of the fraction bits may be reduced by abandoning some LSB bits depending on the desired precision. For example, the (2N+K) data bits in the adder/subtractor 377 may be reduced to N bits by abandoning the last (N+K) bits to maintain the same precision of the inputs.

In addition, a constant value called “bias” may be added to or subtracted from the exponents (E0-m), (E′0-m), or the exponent of the final data to convert the exponent range to a positive value or move the exponent into a desired range to increase the calculation precision and reduce the data size.

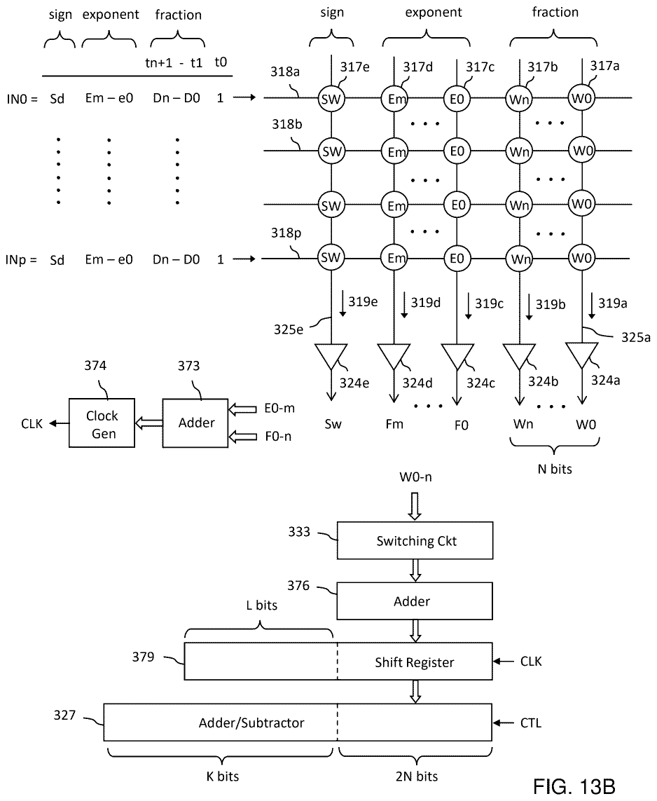

FIG. 13A shows another embodiment to implement the multiplication and accumulation (MAC) operations based on the floating-point number shown in FIG. 11A according to the invention. This embodiment is similar to the embodiment shown in FIG. 12A except that an additional shift register 379 is used. Therefore, after the process step shown in FIG. 12B, the data in the adder 376 may be loaded to the shift register 379 instead of shift register 375. The clock signals of the shift register 379 will shift the data by the clock signals generated by the clock generator 374 according to the result of the sum of the exponent bits (E0-m) and (E′0-m). After that, the data will be loaded to the adder/subtractor circuit 377. Then, the following process described in FIG. 12A will continue.

FIG. 13B shows another embodiment to implement the multiplication and accumulation (MAC) operation based on the floating-point number shown in FIG. 11A according to the invention. This embodiment is similar to the embodiment shown in FIG. 13A except that the shift register 375 is replaced with a switching circuit 333, such as a multiplexer 333 shown in FIG. 8A. The switching circuit may load the output data (W0-n) from the sense amplifiers 324a to 324e to the adder 376 according to the bit locations shown in FIG. 12B.

FIG. 13C shows another embodiment to implement the multiplication and accumulation (MAC) operation based on the floating-point number shown in FIG. 11B according to the invention. This embodiment is similar to the embodiment shown in FIG. 12A except that an additional sign bit (Se) for exponent is used. In this embodiment, the shift register 375 shown in FIG. 12A may be replaced with a universal shift register 380. This universal shift register 380 allows data to be shifted up left or shifted down right by controlling two clock signals CLK1 and CLK2. Therefore, when the exponent sign is positive, the data in the universal shift register 380 may be shifted up; and when the exponent sign is negative, the data in the universal shift register 380 may be shifted down.

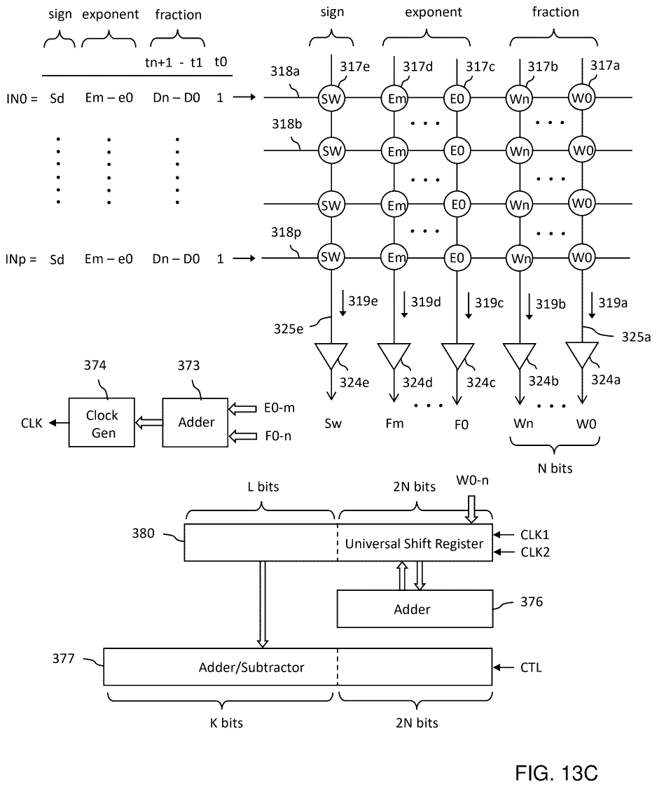

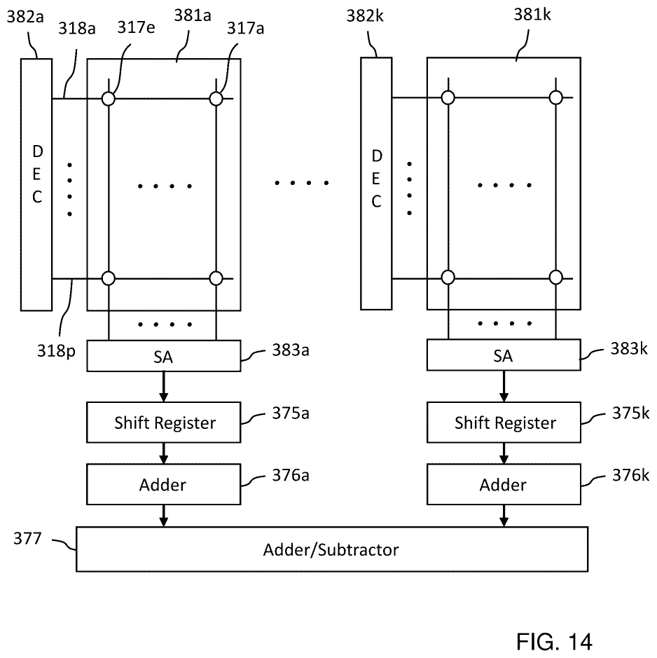

FIG. 14 shows another embodiment configured to implement the multiplication and accumulation (MAC) operations based on the embodiment shown in FIG. 12A according to the invention. In this embodiment, multiple memory arrays 381a to 381k may be used. Each memory array 381a to 381k comprises multiple cells such as 317a to 317e to store weights as described in FIG. 12A. Each memory array 381a to 381k are connected to a decoder or data buffer circuit 382a to 382k. This allows multiple inputs, such as IN0-Ink, to be applied from the decoders or data buffers 382a to 382k to different memory arrays 381a to 381k in parallel. Therefore, each memory array 381a to 381k may perform the MAC operation with the required circuits, such as sense amplifier circuits 383a to 383k, shift registers 375a to 375k, and adders 376a to 376k in parallel. After that, the data of each memory array may be loaded to a common adder/subtractor 377. By using this parallel processing scheme, the processing speed can be greatly increased.

In another embodiment, the multiple data bits of the input data, such as D0 to Dn shown in FIG. 13A, may be applied to different decoders 382a to 382k and memory arrays 381a to 381k, respectively. The operations shown in FIG. 12B may be applied during the accumulation operation to shift the data to the specific bit locations according to the input bits (D0-n).

It should be noted that the circuit blocks for MAC operations, such as 383a to 383k, 375a to 375k, and 376a to 376k shown in FIG. 14 are exemplary. The actual circuit blocks may depend on the circuit design such as in the other embodiments shown in FIGS. 13A-C.

In addition, the circuit implementation shown in FIGS. 12A-14 are examples to demonstrate the concept of the invention. It is obvious that the circuits may be changed, modified, added, or removed without changing the fundamental concepts of the invention. These modifications and variations shall remain within the scope of the invention.

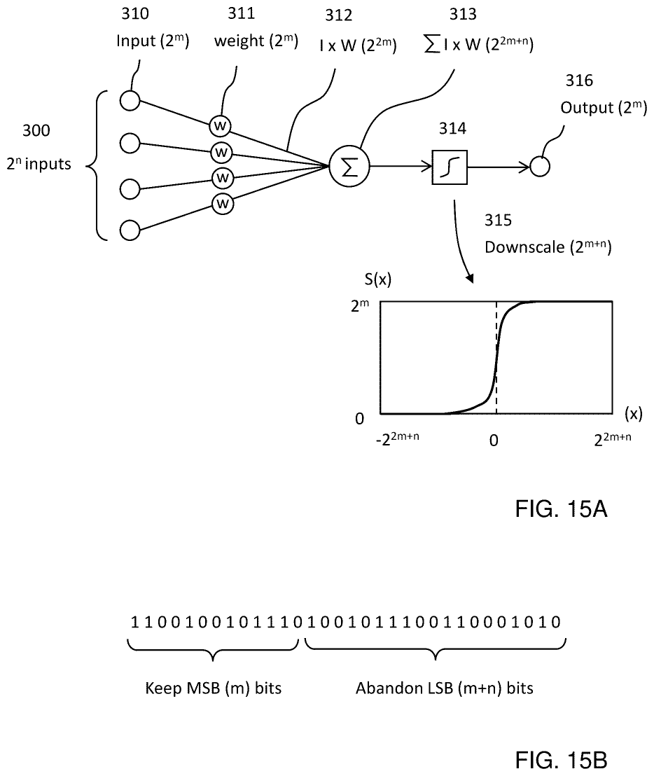

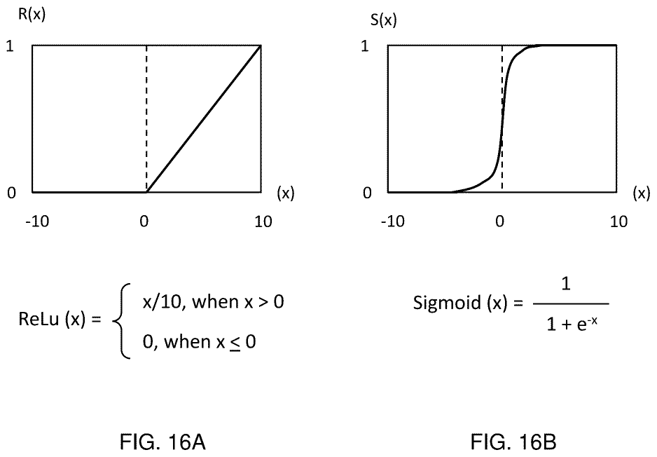

FIGS. 15A-16B demonstrates embodiments to adjust the data size and resolution for activation functions according to the invention.

FIG. 15A shows an embodiment of one neuron layer to demonstrate the data resolution design according to the invention. Assume the neuron layer has 2ⁿ inputs 300. Each input comprises m-bit data, which can represent 2^{m} levels of data. Assume each weight 311 also comprises m-bit data, which can represent 2^{m} levels of weights. Therefore, the multiplication result 312 of an input and a weight will comprise 2^{m}×2^{m}=2^{2m} levels of data. Because there are 2ⁿ inputs, the accumulation result 313 will comprise 2^{2m}×2ⁿ=2^{2m+n} levels of data.

Next, the accumulation result 313 will be sent to an activation function 314 to generate the output 316. Since the output 316 will be sent to the next neuron layer as an input, the output 316 needs to be scaled down to m-bits to prevent the size of data from dramatically increasing when the data propagates through many neuron layers. Therefore, during the data processing of the activation function 315, the size of the output data needs to be downscaled from 2^{2m+n} to 2^{m}.

FIGS. 16A-B shows two of the most used activation functions.

FIG. 16A shows a ReLU function. When the input (x) is larger than 0, the output equals (x/10). When the input (x) is smaller or equal to 0, the output is 0.

FIG. 16B shows a sigmoid function. The output equals 1/(1+e−x). In both examples, the output resolution is scaled down from scale of +10 to 0 to 1. In this case, the output resolution is reduced to 1/10 of the input resolution. In fact, the input resolution and output resolution can be freely decided according to the desired resolution. For example, in another embodiment, the input may be set as 8-bit data to represent −128 to +128 levels of data. The output may be set as 3-bit data to represent 8 levels of data. By choosing the desired number of bits for the input and output, the activation function 314 shown in FIG. 15A may downscale the input data from 2^{2m+n} levels to 2^{m} output levels.

In another embodiment, assume the chosen activation function 314 has no resolution loss, which means it generates the 2^{2m+n} levels of output data. The output data may be downscaled by using the approach shown in FIG. 15B, which keeps m bits of the most significant bits (MSB) and abandon (m+n) bits of the least significant bits (LSB) from the output data. As a result, the size of the output data is scaled down to 2^{m} levels.

The previous embodiments have demonstrated the operation of “forward-propagation” mostly used in inference.

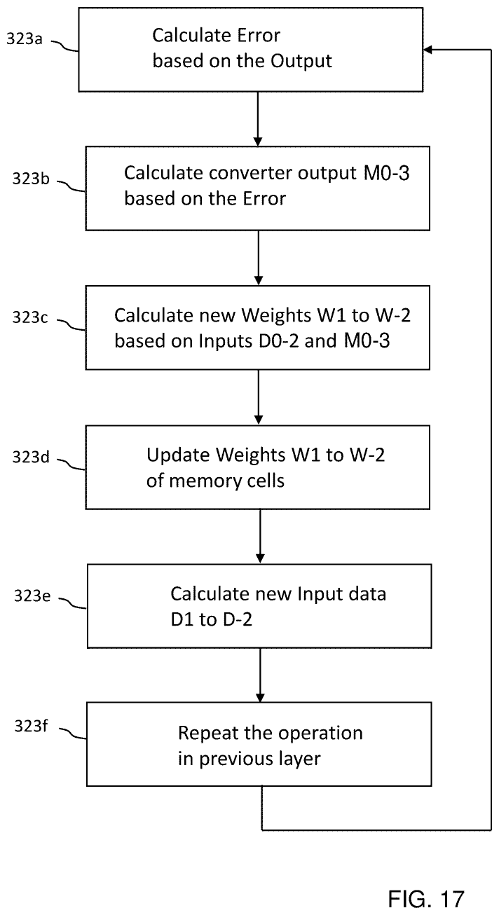

FIGS. 17-20B demonstrates “back-propagation” operation used in a training process according to the invention.

FIG. 17 shows an embodiment of the operation steps to provide back-propagation for the embodiments shown in FIGS. 7A-B. In one embodiment, the following operation steps are performed.

In Step (1) 323a—An error is calculated based on the output S−4 to S12.

In Step (2) 323b—A sense amplifier output M0-3 is calculated based on the error.

In Step (3) 323c—New weights W1 to W−2 are calculated based on inputs D0-2 and M0-3.

In Step (4) 323d—Weights W1 to W−2 of the memory cells are updated.

In Step (5) 323e—New input data D1 to D−2 is calculated.

In Step (6) 323f—The operations in previous layer are repeated.

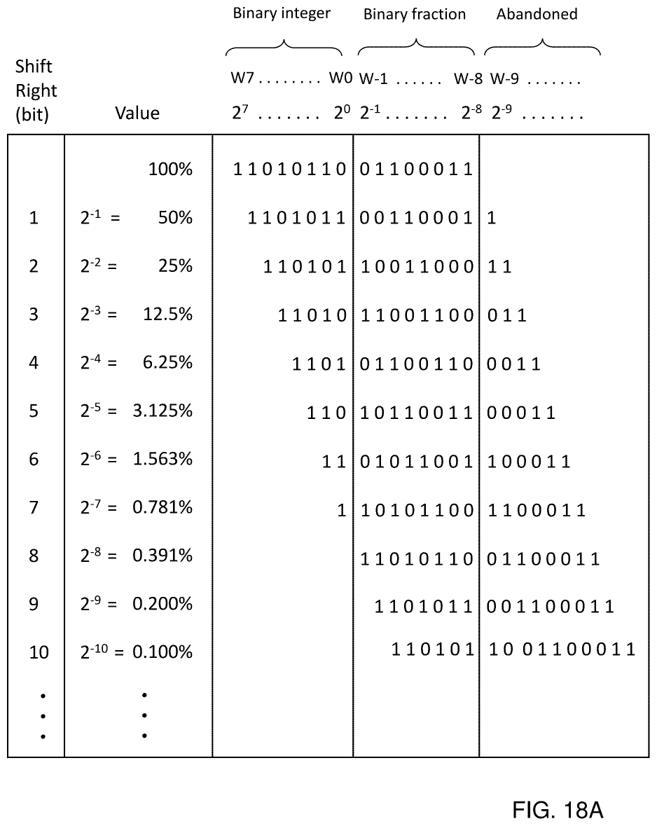

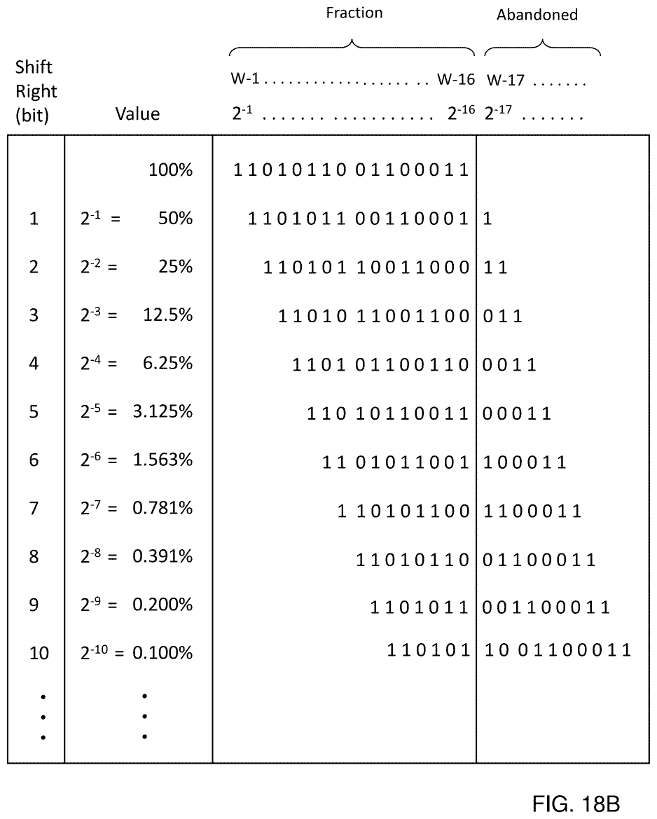

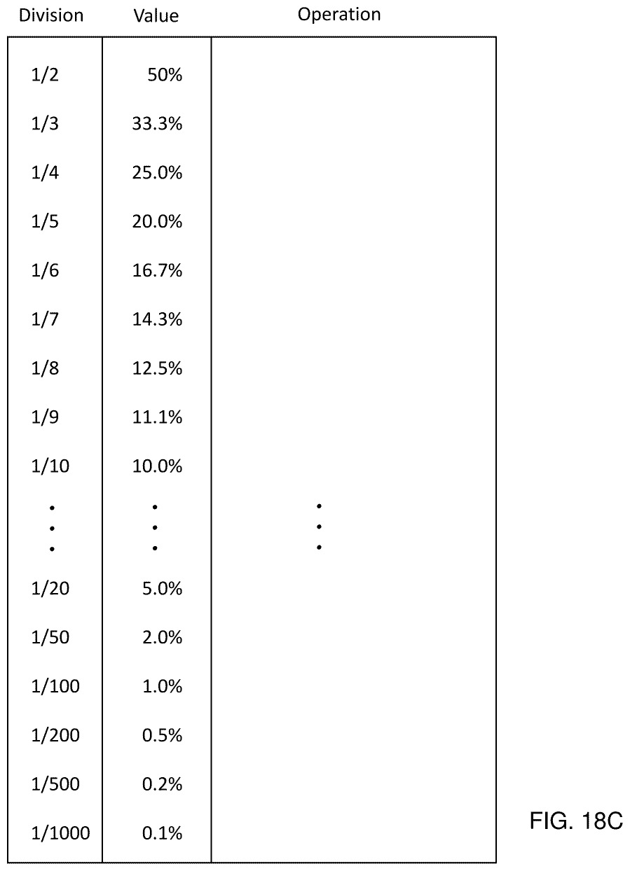

FIG. 18A shows another embodiment for adjusting the weights and inputs during back-propagation using the binary fraction system according to the invention. A binary weight data 11010110.01100011 is used for example. Assume the higher bits W0 to W7 are binary integers that represent value 2⁰ to 2⁷, respectively. The lower bits W−1 to W−8 are binary fractions that represent value 2⁻¹ to 2⁻⁸.

During back-propagation, the output data of each neuron layer is compared with target data to generate an “error”. Then, the back-propagation algorithm will calculate the adjusted amount of each weight based on the error, in order to reduce the error in the next operation. For example, assuming the output value needs to be increased by 20%, the positive weights (which increases the output value) may be increased by 20% times “X”. On the other hand, the negative weights (which decrease the output value) may be decreased by 20% times “X”. Where X is a fraction that decides how much percentage a weight is adjusted in one iteration.

Therefore, it is important that the percentage of the weights can be calculated down to a very small amount such as 1%. In conventional AI chips, this is done by using floating-point numbers. However, floating-point numbers require highly complicated calculation, which usually requires a GPU or CPU with a floating-point unit (FPU) to execute software to process the data. To solve this issue, the invention discloses a novel approach to directly adjust the weights using a binary fraction system instead of floating-point numbers. This allows the back-propagation to be executed in hardware, using the memory cell array and adders as shown in FIGS. 3A-B. This can greatly reduce the delay and power consumption spent in transferring the weight data back and forth between DRAM chips and the GPU.

Referring to FIG. 18A, to calculate the percentage of weight data, the weight data such as 11010110.01100011 may be loaded to a shift register. To generate 50% of the data, the shift register may shift the data one bit to the right. This will generate 50% data, 1101011.001100011 as shown. To generate 25% data, the shift register may shift the data two bits to the right. This may generate 25% data, 110101.1001100011 as shown. Similarly, the shift register may shift the data N bits to the right to obtain ½N data. By using this process, a very small percentage of data such as 0.1% may be obtained by shifting 10 bits to the right. Similarly, if a larger percentage is required, such as 200% or 400%, the value can be obtained by shifting the data one or two bits to the left, respectively.

FIG. 18B shows another embodiment for adjusting the weights and inputs during back-propagation using floating-point numbers according to the invention. Assume the floating-point format has 16 bits of fraction (or mantissa). The fraction bits for weights, W⁻¹ to W⁻¹⁶, are used for an example. Similar to the embodiment shown in FIG. 18A, the value of ½N weight may be obtained by shifting data N bits to the right, while keeping the exponent data unchanged. The bits lower than W−16 may be abandoned. By using this approach, down to 0.1% percentage of value may be obtained by shifting the data 10 bits to the right.

FIG. 18C shows an embodiment of the operation to calculate division using the binary fraction system according to the invention. During back-propagation, a division operation may be performed to decide the adjustment amount of a weight or an output. FIG. 18C shows examples of the division with various divisors such as 2, 3, 4, . . . , 10, 20, 50, 100, 200, 500, 1000. The value of the division can be obtained by using the operations of adding multiple binary fraction numbers as shown. For example, the value of ⅓ may be calculated by adding 2−2+2−4+2−6+2−8+2−10, which results in 33.3%. The values of each binary fraction may be obtained by shifting the data as shown in FIG. 18A-B.

By using this process, the division of the weight or the output may be calculated by using the circuit shown in FIGS. 19A-B. For example, in FIG. 19A, an old weight may be loaded to the shift register 327 and then shifted according to the table shown in FIGS. 18A-B to obtain the desired binary fraction. Then, the binary fraction may be sent to the adder 328. This operation may be repeated multiple times to obtain the desired multiple binary fractions shown in FIG. 18C and added by the adder 328 to obtain the final value.

FIG. 19A shows an embodiment to adjust the weights using the operations shown in FIGS. 18A-B according to the invention. To adjust a weight, first the input line such as 318a shown in FIG. 3A may be supplied with data 1. This may turn on the cells 317a to 317d to read out the old weight, W−2 to W1, stored in the cells to the sense amplifiers 324a to 324d, and then stored in a data buffer 326 shown in FIG. 19A. Then, the old weight may be loaded to a shift register 327. The shift register 327 may receive a control signal to shift the data bit location according to the desired percentage change, as described in FIGS. 18A-B. Then, depending on the desire to increase or decrease the weight, the data in the shift register 327 and the data buffer 326 may be sent to an adder circuit 328 or a subtractor circuit 329 to increase or decrease the data stored in the shift register 327 to the old weight stored in the data buffer 326.

The above-described operation may be performed multiple times to obtain the desired adjustment amount for the weight. For example, assume 70% adjustment is desired. Referring to FIGS. 18A-B, the weight stored in the shift register 327 may be shifted 4 times, including 1-bit, 3-bit, 4-bit, and 6-bit to the right to obtain 50%, 12.5%, 6.25%, and 1.563%, respectively. This data may be sequentially added in the adder circuit 328 to obtain 70.313% increase. Then, the new weight may be written back to the cells.

FIG. 19B shows another embodiment to adjust the weights according to the invention. In this embodiment, an adder/subtractor circuit 330 may be used.

FIG. 19C shows an example of a 4-bit adder/subtractor circuit. The circuit can add or subtract two sets of 4-bit data, A0-3 and B0-3, according to the control signal. In FIG. 19B, the old weight may be loaded to the adder/subtractor 330 and a shift register 331. The shift register 331 may receive a control signal to shift the data bit location according to the desired percentage change, as described in FIGS. 18A-B. Then, the data in the shift register 331 may be sent back to the adder/subtractor 330 and added to the old weight or subtracted from the old weight, depending on the control signal of the adder/subtractor 330. Similar to the description in FIG. 19A, this operation may be performed multiple times to obtain the desired adjustment amount. Then, the new weight may be written back to the cells.

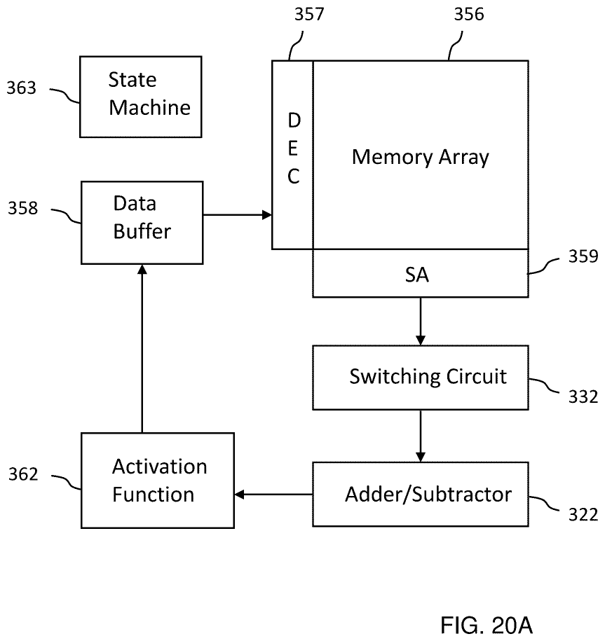

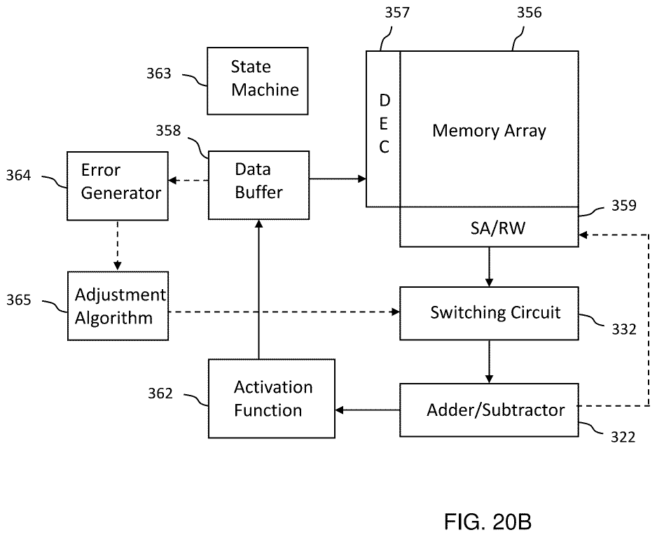

FIG. 20A shows an embodiment of circuit blocks of an AI chip configured for forward-propagation (or called inference according to the invention). The AI chip may comprise a memory array 356 that stores weights in memory cells. A decoder circuit 357 applies input data from a data buffer 358 to the memory array 356 to perform the multiplication of the input data and the weights. A sense amplifier 359 (SA block) senses cell currents to generate output data. The output data is sent to a switching circuit 332 and then loaded to an adder/subtractor 322 according to the bits of the input and the weight, as shown in the table in FIG. 7B. The output data may be added to or subtracted from the data stored in the adder/subtractor 322 according to the sign bits of the data and the weight.

Next, the data of the adder/subtractor 322 is sent to an activation function block 362, such as the embodiment shown in FIGS. 10A-B, to perform the activation function. The output of the activation function 362 is sent to the data buffer 358. This output data may be sent to the decoder 357 to perform the operation for the next neuron layer. This operation may be repeated until the operation of all the neuron layers are executed. These operations may be controlled by a state machine 363 or CPU block.

FIG. 20B shows another embodiment of circuit blocks of an AI chip configured to perform both forward-propagation (inference) and back-propagation (training) according to the invention. This embodiment is similar to the embodiment shown in FIG. 20A except that additional circuit blocks for back-propagation are added. During back-propagation, the output data of a neuron layer stored in the data buffer 358 will be sent to an error generator 364 to compare with the target to generate the error. The error will be sent to an adjustment algorithm block 365 to determine the percentage of the change for each weight.

Next, the weight is read by the sense amplifier block 359 and loaded to the switching circuit 332 and the adder/subtractor 322. The switching circuit 332 may be implemented by using a shift register 334 as shown in FIG. 8B. This shift register-based switching circuit 332 may perform the operation of the shift register 331 shown in FIG. 19B to generate the adjustment amount (data) of the weight according to the output of the adjustment algorithm block 365. Then, the adjustment amount (data) is added to or subtracted from the previous weight stored in the adder/subtractor 322 to generate the new weight. After that, the new weight is sent to the sense amplifier and read-write (RW) circuit 359. The read-write circuit 359 will write the new weight back to the cells to replace the previous weight. This operation may be repeated until all the weights in the neuron layer are updated. Then, the operation may be repeated to the next neuron layers until the weights of all the neuron layers are updated.

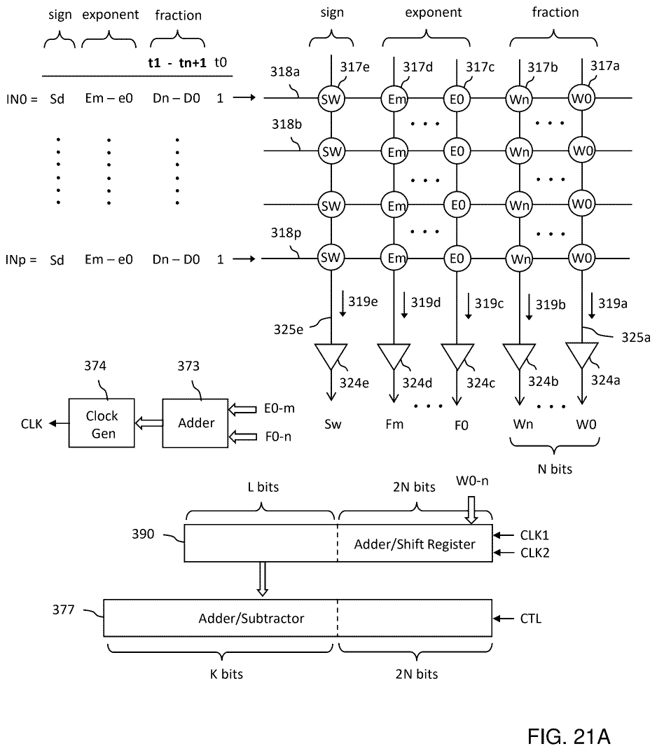

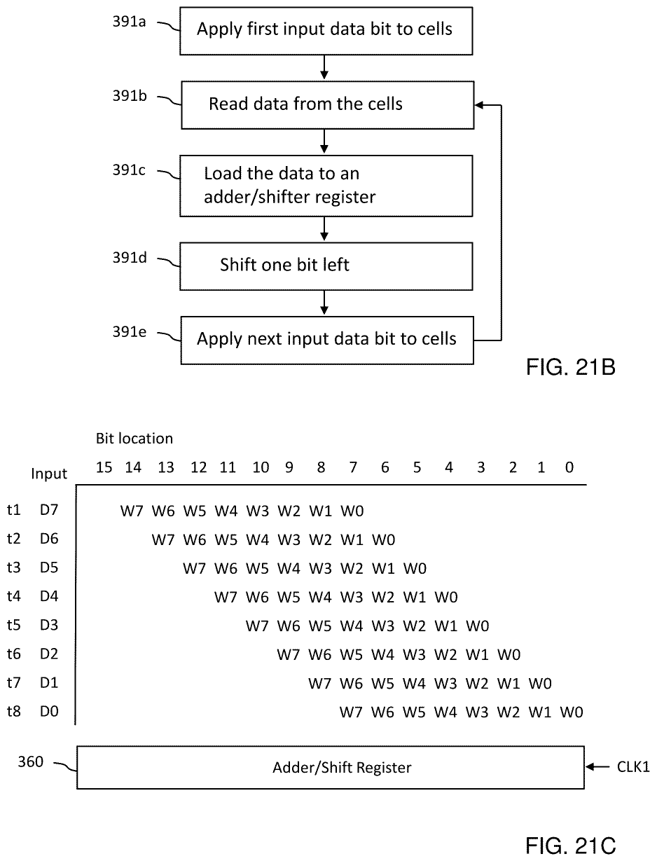

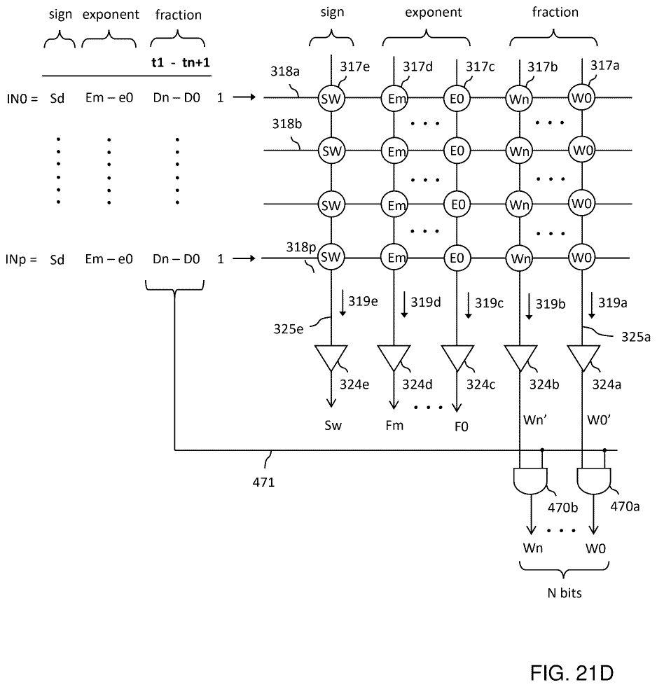

FIG. 21A shows another embodiment configured to implement the multiplication and accumulation (MAC) operations based on the floating-point number shown in FIG. 11A according to the invention. This embodiment is similar to the embodiment shown in FIG. 12A except that the shift register 375 and the adder 376 are replaced with a combined adder/shift register circuit 390 that can perform both the functions of an adder and a shift register.

In this embodiment, from time t1 to tn+1, the fraction bits of the selected input data may be sequentially applied to the input line 318a in the reversed order, Dn to D0. The input data will turn on or off the cells 317a to 317b according to the fraction bits W0-n of the weight stored in the cells and generate output data W0-n from the sense amplifiers 324a to 324b. The output data W0-n is loaded to the adder/shift register 390.

FIG. 21B shows a method that illustrates the operation of the memory array and the adder/shift register 390 shown in FIG. 21A. In steps 391a and 391b, the first input data bit (Dn) is applied to read the cells 317a to 317b. In step 391c, the output data is loaded to the adder/shift register 390 and added to the previous data stored in the adder/shift register 390. In step 391d, the data is shifted one bit left.

Next, in step 391e, the next input data bit (Dn−1) is applied to read the cells 317a to 317b, and the steps from 391b to 391e are repeated. These operations are repeated until the last input data bit (D0) is applied.

FIG. 21C shows the operation of the adder/shift register 390. Eight fraction bits (D0-7) are used as an example for illustration. From time t1 to t8, the input data bit D7 to D0 are sequentially applied to read the cells. The output data W0-7 will be loaded to the adder/shift register 360 sequentially. A clock signal (CLK1) will shift the data one bit left after each data is loaded and added to the previous data. As a result, the final data stored in the adder/shift register 390 represents the multiplication result of the fraction bits of the input data bits D0-n and the weight W0-n.

FIG. 21D shows another embodiment configured to implement the multiplication and accumulation (MAC) operations based on the floating-point number shown in FIG. 11A according to the invention. This embodiment is similar to the embodiment shown in FIG. 21A except that additional AND logic gates 470a to 470b are added. In this embodiment, the selected input line 318a to 318p is supplied with data 1 (VDD) to turn on the selected memory cells, such as cells 317a to 317e. The data of the memory cells will be read by the sense amplifiers 324a to 324e.

From time t1 to tn+1, the fraction bits of the selected input data, Dn to D0, are sequentially applied to the input line 471. The AND logic gates 470a to 470b perform a “multiplication” operation for the input data, Dn to D0, and the weights, Wn′ to W0′, read from the memory cells 317a to 317b. For example, if both the input data and weight are 1, the output of the AND logic gates 470a to 470b will be 1. If either one of the input data or weight is 0, the output of the AND logic gates 470a to 470b will be 0. Then, the output data, Wn to W0, of the AND logic gates 470a to 470b will be sent to the MAC circuit, such as 390 and 377 shown in FIG. 21A.

It should be noted that the feature of using the AND logic gates 470a to 470b to perform multiplication as shown in this embodiment may be applied to other embodiments shown in FIGS. 3A-B, 7A-B, 8A-B, 13A-B, 14A-B, 17A-B, and 18A-C as well.

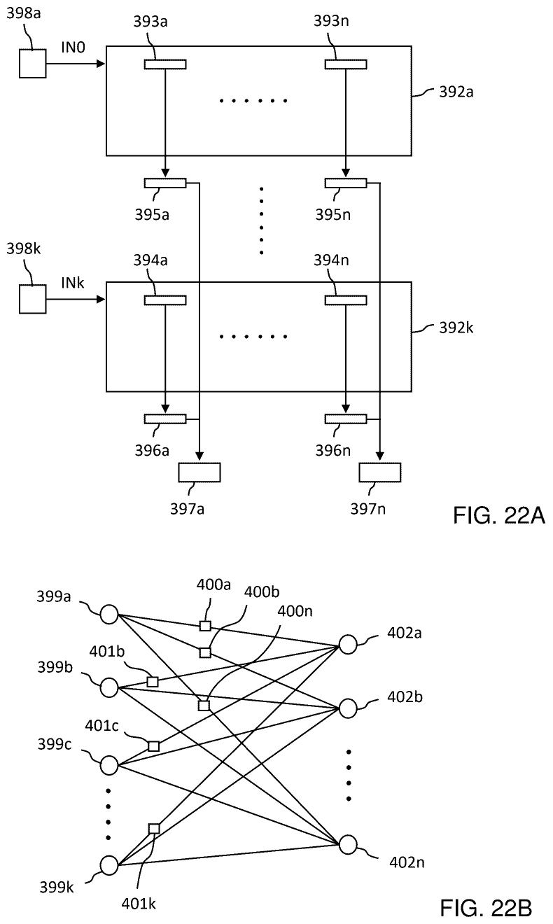

FIG. 22A shows an embodiment of the memory array and circuit architecture according to the invention. The architecture comprises multiple memory arrays 392a to 392k. Each memory array 392a to 392k comprise multiple bytes of memory such as memory bytes 393a to 393n and memory bytes 394a to 394n. Each memory byte, such as memory byte 393a may comprise multiple memory cells, such as cells 317a to 317e shown in FIG. 21A to store weight data, which may include a sign bit (Sw), exponent bits (E0-m), and fraction bits (W0-n) as shown.

Also shown in FIG. 22A are decoders 398a to 398k, and word line drivers, or data buffer circuits. The decoders 398a to 398k may apply multiple input data, IN0 to INk, to the multiple bytes of memory cells 393a to 393n and 394a to 394n in the multiple memory arrays 392a to 392k in parallel. For example, the first input data IN0 may be applied to the multiple bytes of memory cells 393a to 393n to generate output data from the sense amplifier circuits 395a to 395n as shown. Similarly, the second input data INk may be applied to the multiple bytes of memory cells 394a to 394n to generate output data from the sense amplifier circuits 396a to 396n as shown.

Next, the output data of the sense amplifiers 395a to 395n and 396a to 396n may be sent to adder/shift register circuits 397a to 397n to perform the accumulation function shown in previous embodiments, such as the embodiment shown in FIG. 21A.

FIG. 22B shows an embodiment of the neural network architecture implemented by the embodiment shown in FIG. 22A. The decoders 398a to 398k shown in FIG. 22A represent the input neurons 399a to 399k. The adder/shift register circuits 397a to 397n represent the output neurons 402a to 402n. The multiple bytes of memory cells 393a to 393n represent the weights 400a to 400n connected to the first input neuron 399a. The multiple bytes of memory cells 393a to 394a represent the weights 400a and 401b to 401k connected to the first output neuron 402a.

Although the embodiment in FIG. 22A shows a single memory array 392a, in another embodiment, each memory array, such as array 392a may comprise multiple sub-array architectures such as the embodiment shown in FIG. 14. For example, in one embodiment, the memory array 392a may comprise multiple sub-arrays 381a to 381k as shown in FIG. 14. The sub-arrays 381a to 381k may be supplied with different bits of input data, such as D0 to Dn, respectively. This allows the different bits of the input data to be processed in parallel, thus the processing speed is increased.

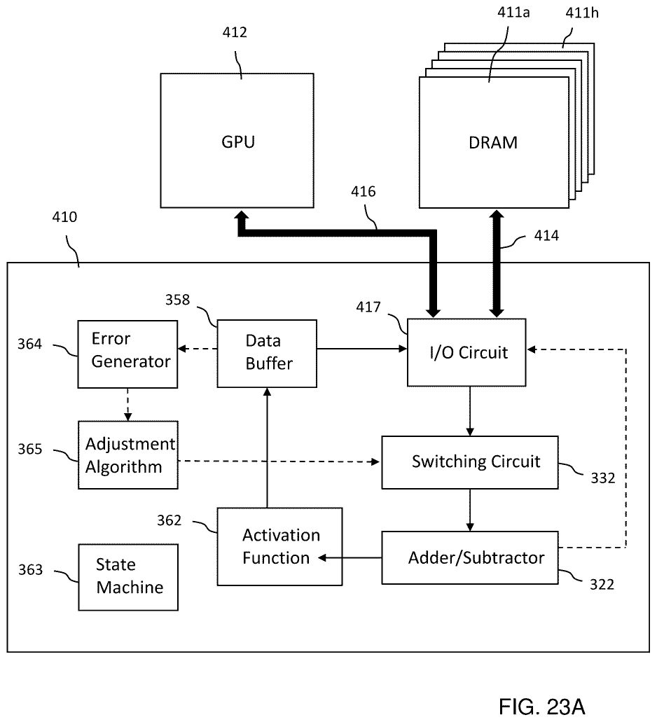

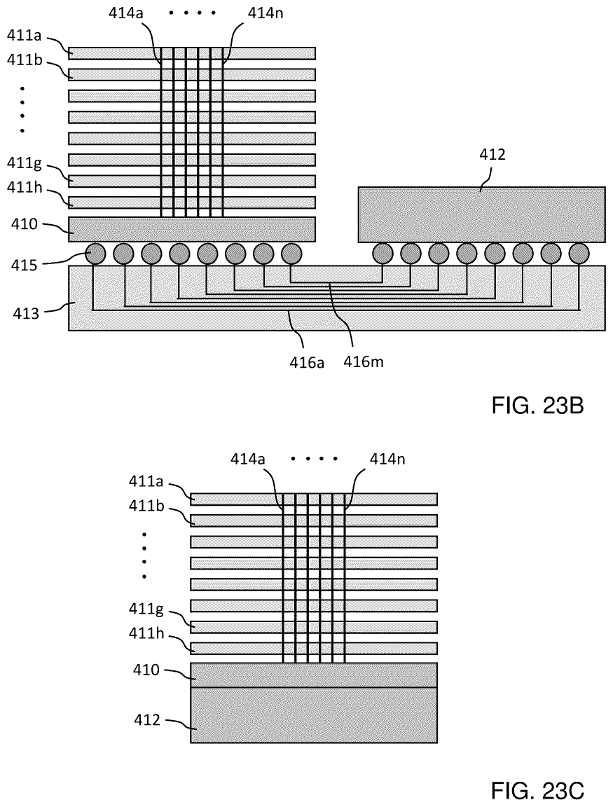

FIG. 23A shows another embodiment of an AI chip architecture according to the invention. This embodiment is similar to the embodiment shown in FIG. 20B except that the architecture is implemented by using separated dies or chips. In FIG. 23A, the data, such as weights, may be stored in multiple DRAM dies 411a to 411h. The other circuits, such as data buffer 358, switching circuit 332, adder/subtractor 322, activation function block 362, state machine 363, error generator 364, and adjustment algorithm block 365 may be located in a controller die or chip 410. The controller die or chip 410 may comprise an input/output (I/O) circuit 417 to transfer data between the controller dies or chip 410 and the DRAM dies 411a to 411h through data bus 414 and a graphic processing unit (GPU) 412 through data bus 416. During inference operation, the controller die or chip 410 may input weights from the DRAM dies 411a to 411h and input data from the GPU 412 to perform forward-propagation and then send the output data to the GPU 412. During a training operation, the controller die or chip 410 may input weights from the DRAM dies 411a to 411h and input data and target from the GPU 412 to perform back-propagation and then write the updated weights to the DRAM dies 411a to 411h.

FIG. 23B shows an embodiment in which the controller die 410 and the multiple DRAM dies 411a to 411h are bonded together to form a high-bandwidth memory (HBM) chip. The DRAM dies 411a to 411h and the control die 410 may be connected by thousands of data bus lines 414a to 414n called “through-silicon vias (TSV)”. Also shown in a solder ball 415 and a silicon interposer 413 that may comprise thousands of data bus lines 416a to 416m. The controller die 410 may transfer the weight data with the DRAM dies 411a to 411h through the TSV bus lines 414a to 414n to perform forward-propagation and/or back-propagation; and transfer the input and output data with the GPU 412 though the data bus lines 416a to 416m.

Because the MAC operation is performed inside the controller die 410, this eliminates the need to transfer all the weight data from the controller die 410 to the GPU 412 to perform the computation inside the GPU 412. This can greatly reduce the power consumption and heat generation caused by transferring the large amount of weight data through the data bus lines 416a to 416m.

FIG. 23C shows another embodiment in which the HBM dies 411a to 411h and the controller die 410 are bonded on top of the GPU 412 by using 3D bonding or integration technologies.

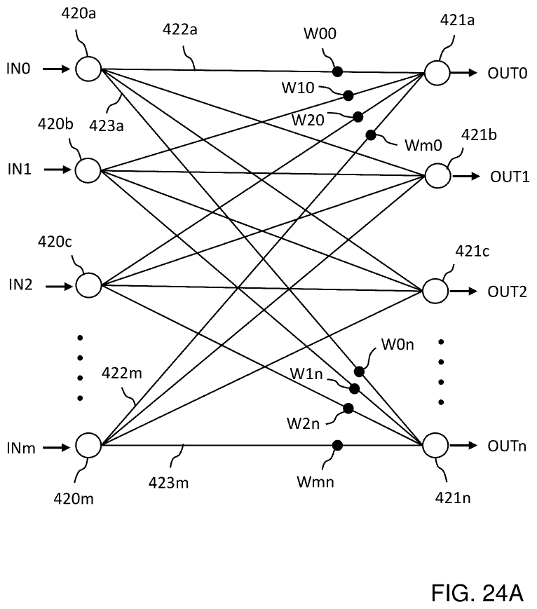

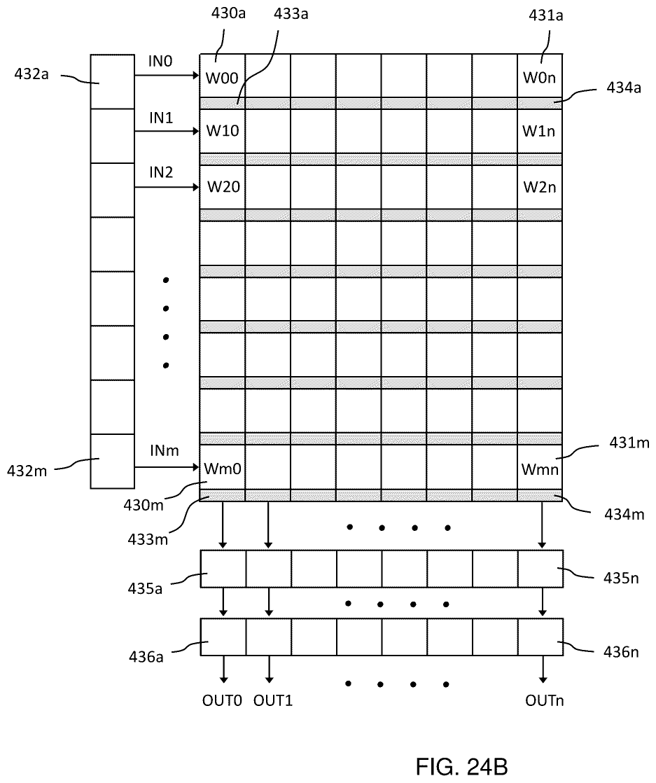

FIG. 24A-B shows another embodiment of an AI chip memory array and circuit architecture according to the invention. FIG. 24A shows one layer of a neural network. FIG. 24B shows the architecture according to the invention to simulate the neural network shown in FIG. 24A.

FIG. 24A comprises multiple input neurons 420a to 420m and multiple output neurons 421a to 421n. The input neurons 420a to 420m receive input data IN0 to INm, respectively, from the previous layer of the neural network. The output neurons 421a to 421n output data OUT0 to OUTn, respectively, to the next layer of the neural network. Each of the input neurons 420a to 420m is connected to each of the output neurons 421a to 421n through synapses. For example, the input neurons 420a to 429m are connected to the first output neuron 421a through synapses 422a to 422m. Each synapse 422a to 422m stores a weight, such as W00, W10, . . . , to Wm0, respectively. Similarly, the input neurons 420a to 429m are connected to the last output neuron 421n through synapses 423a to 423m. Each synapse 423a to 423m stores a weight, such as W0n, W1n, . . . , to Wmn, respectively.

FIG. 24B shows a memory array that comprises multiple sub-arrays such as sub-arrays 430a to 430n and 431a to 431n. Each sub-array may comprise multiple input lines (or called word lines, such as word lines 318a to 318p, multiple output lines (or called bit lines such as bit lines 325a to 325e, and multiple memory cells, such as memory cells 317a to 317e shown in FIG. 13A. The memory cells may store weights using the floating-point number, such as the example shown in FIG. 13A. The sub-arrays 430a to 430m may store the weights W00 to Wm0 of the synapses 422a to 422m that are connected to the first output neuron 421a shown in FIG. 24A. The sub-arrays 431a to 431m may store the weights W0n to Wmn of the synapses 423a to 423m that are connected to the last output neuron 421n shown in FIG. 24A.

Also shown in FIG. 24B are input neuron circuits 432a to 432, which simulate the input neurons 420a to 420m shown in FIG. 24A. Also shown are output neuron circuits 435a to 435n and 436a to 436n that simulate the output neurons 421a to 421n shown in FIG. 24A. The input neuron circuits 432a to 432m send input data, IN0 to INm, to the sub-arrays. The first input data, IN0, is sent to the sub-arrays 430a to 431a. The last input data, INm, is sent to the sub-arrays 430m to 431m. Each input data may comprise floating-point format, such as the example shown in FIG. 13A.

The input data may be multiplied with the weights using the operation shown in FIG. 13A by using the MAC circuits, such as 433a to 433m and 434a to 434m. The MAC circuits 433a to 433m may comprise the shift registers 375, 379, and the adder 376 shown in FIG. 13A, or shift registers 333, 379, and the adder 376 shown in FIG. 13B, or the shift register 380 and the adder 376 shown in FIG. 13C, depending on the desired architecture. As a result, the MAC circuit 433a may store the result of IN0×W00. The MAC circuit 433m may store the result of INm×Wm0. The MAC circuit 434a may store the result of IN0×W0n. The MAC circuit 434m may store the result of INm×Wmn.

Then, the data stored in the MAC circuits may be added by adder circuits 435a to 435n. For example, the data stored in the MAC circuits 433a to 433m are added by the adder circuit 435a. The data stored in the MAC circuits 434a to 434m are added by the adder circuit 435n. Then, the data stored in the adder circuits 435a to 435n are sent to activation circuits 436a to 436n to generate the output data, OUT0 to OUTn.

The architecture shown in FIG. 24B has several advantages. First, all the data in one layer may be processed in parallel, thus it greatly increases the processing data throughput. Second, all the data and weights use digital floating-point numbers, thus high computing resolution is achieved. Third, the architecture may be implemented by using almost any type of memory cells, including but not limited to DRAM, SRAM, FBC, NOR flash memory, NAND flash memory, FRAM, RRAM, PCM, MRAM, ROM, and so on.

Moreover, in addition to forward propagation, by using the embodiments of the weight adjustment shown in FIGS. 17-20B, the architecture shown in FIG. 24B may be used for back-propagation. This makes the architecture shown in FIG. 24B applicable to both inference and training tasks.

The architecture shown in FIG. 24B may be implemented by using 2D memory cell technologies, such as the conventional 2D DRAM, for example, FIG. 24C shows another embodiment of the memory array and circuit architecture using 3D memory cell technologies. In this embodiment, the memory sub-arrays such as 430a to 430m and 431a to 431m may be implemented by using 3D memory cells. These memory arrays may comprise multiple layers of memory cells to increase the memory density.

This embodiment is similar to the one shown in FIG. 24B, except that the 3D memory sub-arrays, such as 430a to 430m and 431a to 431m, may be located on top of the other circuits to reduce the chip footprint. The input data, IN0 to INm, are sent from the input neuron circuits 432a to 432m to the sub-arrays, such as 430a to 430m and 431a to 431m, as indicated by the arrows 437a to 437m. The input data are multiplied with the weights stored in the memory cells in the sub-arrays 430a to 430m and 431a to 431m using the operations described in FIG. 13A

Next, the multiplication results will be sent to the MAC circuits 433a to 433m and 434a to 434m located under the sub-arrays, as shown by the dashed lines 438a to 438m and 439a to 439m. The data in the MAC circuits 433a to 433m and 434a to 434m may then be added by adder circuits 435a to 435n and sent to activation circuits 436a to 436n to generate the output data, OUT0 to OUTn.

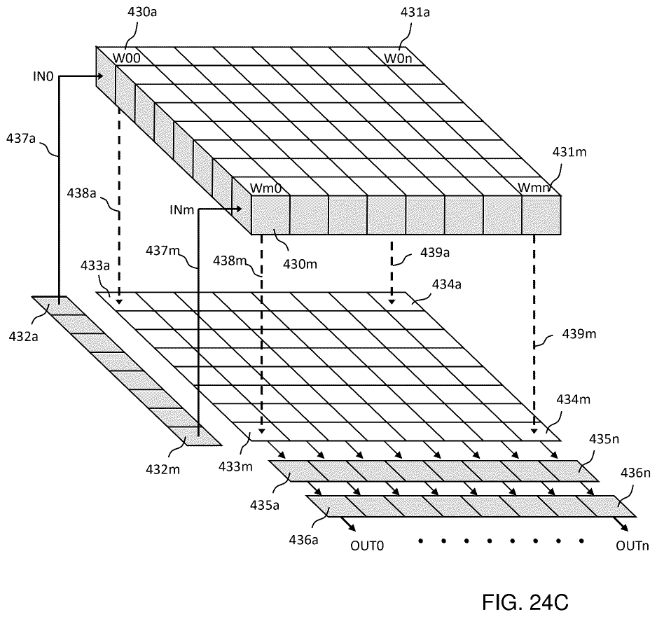

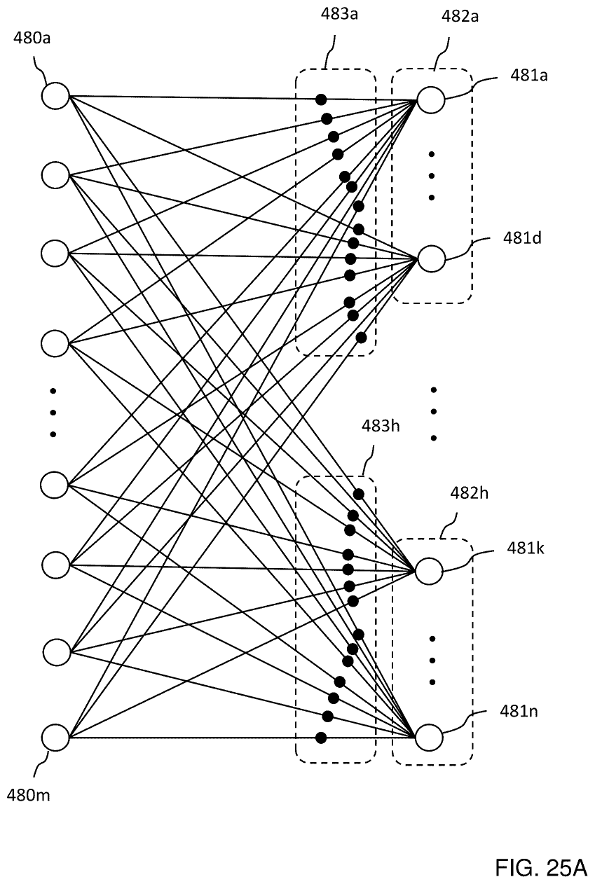

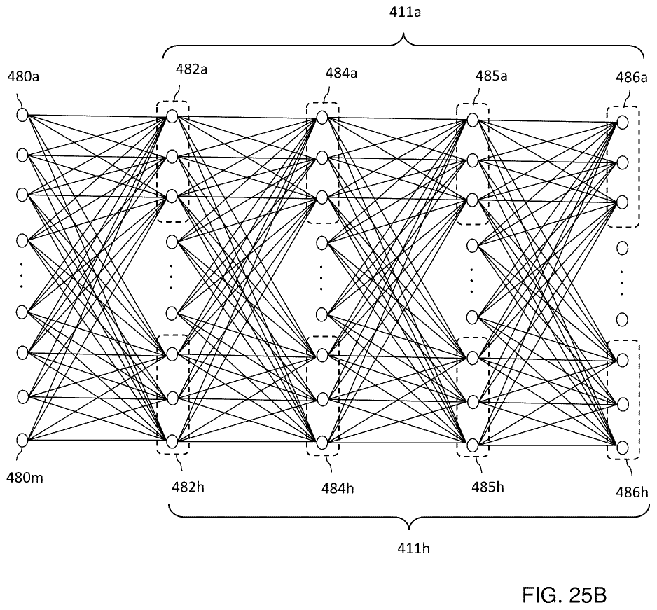

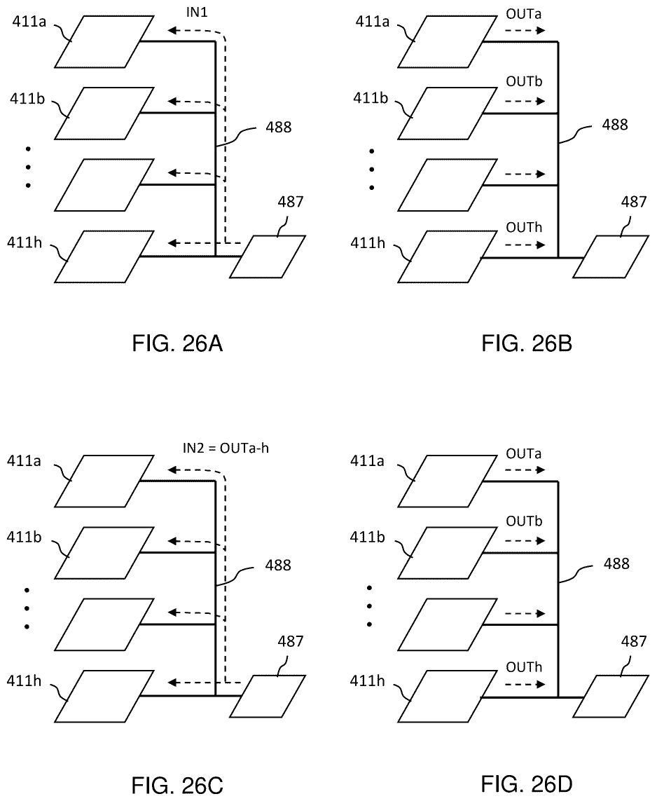

FIGS. 25A-26D describe another embodiment, according to the invention, for processing AI operations inside multiple memory dies, such as DRAM dies 411a to 411h, in the HBM shown in FIGS. 23B-C. This reduces the need to transfer weight data from the DRAM dies 411a to 411h to the GPU 412 to run the AI operations, thereby greatly reducing power consumption and heat generation caused by the TSV bus 414a to 414h and the data bus 416a to 416m.

However, to enable multiple memory chips to run AI operations together, a new approach is required to handle the inputs, outputs, and weight-data storage. Because neural networks—on which AI operations are based—use each layer's outputs as the next layer's inputs, the data must be processed layer by layer. In addition, each layer must use all outputs from the previous layer, rather than only a subset, to process the data correctly. Therefore, the neural network cannot be divided into multiple parts or layers such that each memory chip performs AI operations for only one part and the results are then assembled. This approach is not suitable for neural networks.

To solve the above described problems, the invention discloses a new approach shown in FIGS. 25A-B.

FIG. 25A shows a neural-network layer that comprises multiple input neurons 480a to 480m, multiple output neurons 481a to 481n, and multiple weight groups 483a to 483h. According to the invention, the output neurons 481a to 481n may be divided into multiple output neuron groups 482a to 482h. The first output neuron group 482a may comprise multiple output neurons such as 481a to 481d. The last output neuron group 482h may comprise multiple output neurons such as 481k to 481n.

Each output neuron group 482a to 482h and its associated weight groups 483a to 483h may be located in one memory die, such as the DRAM die 411a to 411h shown in FIGS. 23B-C. For example, the first DRAM die 411a may contain the first output neuron group 482a and its associated weight groups 483a. The last DRAM die 411h may contain the last output neuron group 482h and its associated weight groups 483h.

FIG. 25B shows an embodiment of a multi-layer neural network. The inputs of the first layer are 480a to 480m. The output neuron groups of the first layer are 482a to 482h. The output neuron groups of the second, third, and fourth layers are 484a to 484h, 485a to 485h, and 486a to 486h, respectively. According to the invention, the neural network may be simulated using multiple memory dies, such as the DRAM dies 411a to 411h shown in FIGS. 23B-C. Each memory die may simulate an output neuron group of each layer. For example, the first memory die 411a may store the weight groups associated with output neuron groups 482a, 484a, 485a, and 486a to simulate these neuron groups. The last memory die 411h may store the weight groups associated with output neuron groups 482h, 484h, 485h, and 486h to simulate these neuron groups.

FIGS. 26A-D show an embodiment for running AI operations of the neural network shown in FIG. 25B using multiple memory dies 411a to 411h. The multiple memory dies 411a to 411h may be connected to a controller or GPU 487 through a TSV bus or data bus 488. According to the invention, the multiple memory dies 411a to 411h may store the weight groups associated with the output neuron groups shown in FIG. 25B.

FIG. 26A shows how the controller or GPU 487 may send the first-layer inputs, IN1, to all memory dies 411a to 411h. Referring to FIG. 25B, the inputs are processed with the weight groups stored in the memory dies 411a to 411h to generate the output groups 482a to 482h, respectively. In FIG. 26B, these output groups 482a to 482h, denoted as OUTa to OUTh, are output from the memory dies 411a to 411h to the controller or GPU 487. The controller or GPU 487 may then combine the first-layer output groups, OUTa to OUTh, to form the inputs of the second layer, IN2.

FIG. 26C shows how the controller or GPU 487 may send the second-layer inputs, IN2, to all memory dies 411a to 411h. Referring to FIG. 25B, the second-layer inputs are processed with the second-layer weight groups stored in the memory dies 411a to 411h to generate the second-layer output groups 484a to 484h, respectively. In FIG. 26D, these output groups 484a to 484h, denoted as OUTa to OUTh, are output from the memory dies 411a to 411h to the controller or GPU 487 again. The controller or GPU 487 may then combine the second-layer output groups, OUTa to OUTh, to form the inputs of the third layer.

The process described in FIGS. 26A-D may be repeated to process data for multi-layer neural networks. Using this approach, a very large-scale neural network may be simulated using multiple memory dies. This approach provides several advantages. First, because the data is processed in multiple memory dies simultaneously, data-processing throughput is greatly increased. Second, because the multiple memory dies can collectively contain a total of ten thousand to one hundred thousand bytes of input-data buffer, a very large-scale AI model—such as generative AI or a large language model (LLM) can be simulated. Third, because the number of input and output bits of each memory die can be freely configured, this approach provides high flexibility in the number of layers and the number of neurons in each layer.

It should be noted that, although the embodiment in FIG. 26C shows the controller or GPU 487 sending all input data, IN2, to all memory dies 411a to 411h, in another embodiment the controller or GPU 487 may send only partial input data to the memory dies 411a to 411h. Because each memory die—such as 411a, for example—may still contain the previous output, OUTa, the controller or GPU 487 may send only the missing outputs, OUTb to OUTh, to the memory die 411a.

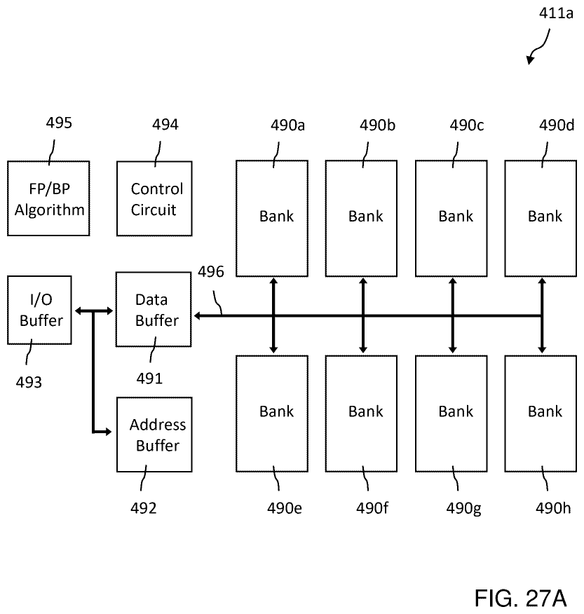

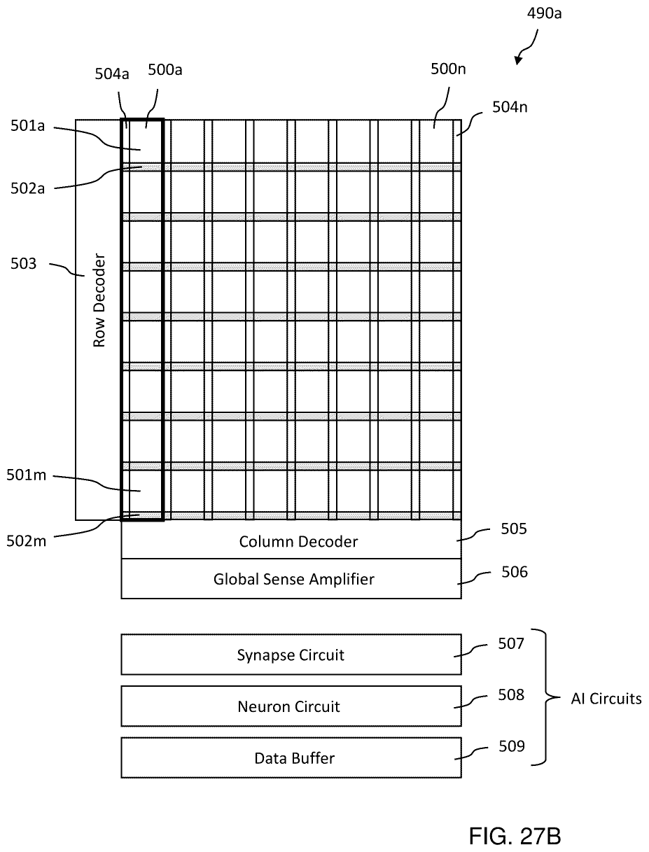

FIG. 27A shows an embodiment of the architecture of a memory die, such as 411a to 411h shown in FIGS. 26A-D, according to the invention. The memory die may comprise multiple banks 490a to 490h. The banks 490a to 490h may connect to a data buffer 491 through a data bus 496. The data buffer 491 may be connected to an input/output (I/O) buffer 493. The I/O buffer 493 may be connected to an external TSV bus or data bus to transfer data with other memory dies and the controller or GPU. The I/O buffer 493 may also load an address into an address buffer 492. The address buffer 492 may output the address to the banks 490a to 490h to select memory cells. A control circuit 494 may control operations, timing, and voltages of the die. The die may also contain a forward-propagation/back-propagation (FP/BP) algorithm model 495 to control AI operations and parameters for inference and training operations.

FIG. 27B shows an embodiment of the architecture of a bank 490a to 490h shown in FIG. 27A. The bank may comprise a memory array that is divided into multiple blocks 500a to 500n, as shown by the bolder outline. Each block may comprise multiple sub-arrays, such as 501a to 501m. Each sub-array may comprise multiple memory cells to store weight data. According to the invention, the memory cells may use any type of memory technology, including but not limited to DRAM, SRAM, FBC, NOR flash, NAND flash, FRAM, RRAM, PCM, MRAM, ROM, EEPROM, and others. The weight data may use the floating-point format shown in FIGS. 11A-B.

The memory cells are connected to input lines (word lines) and output lines (bit lines). The bit lines of each sub-array, such as 501a to 501m, are connected to sense amplifier circuits 502a to 502m or local data buffers to store data read from or written to the memory cells. A column decoder 505 may select the sense amplifiers 502a to 502m to transfer data to and from a global sense amplifier 506.

The word lines of each sub-array, such as 501a to 501m, are connected to local word line drivers or decoders 504a to 504n. The local word line drivers or decoders 504a to 504n are connected to a row decoder 503. The row decoder 503 and column decoder 505 may receive addresses from the address buffer 492 shown in FIG. 27A. The bank may also comprise AI circuits, including a synapse circuit 507, a neuron circuit 508, and a data buffer 509. The AI circuits handle data processing for AI operations.

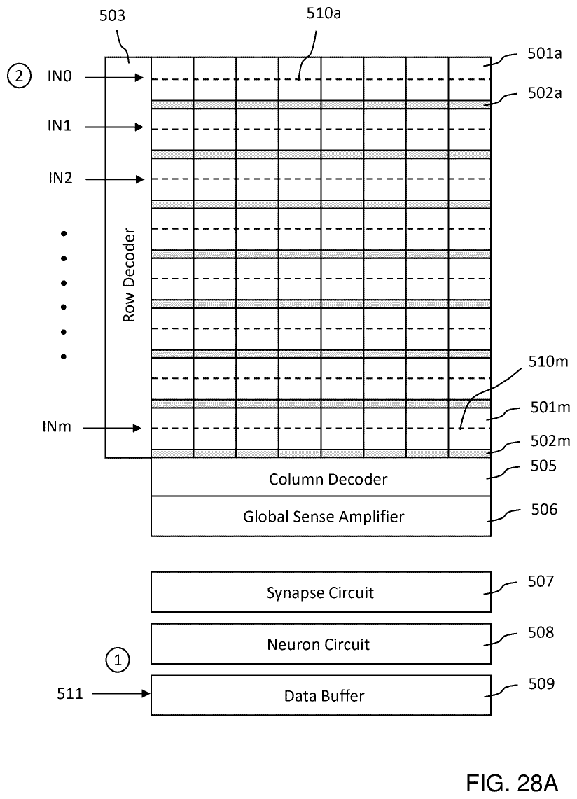

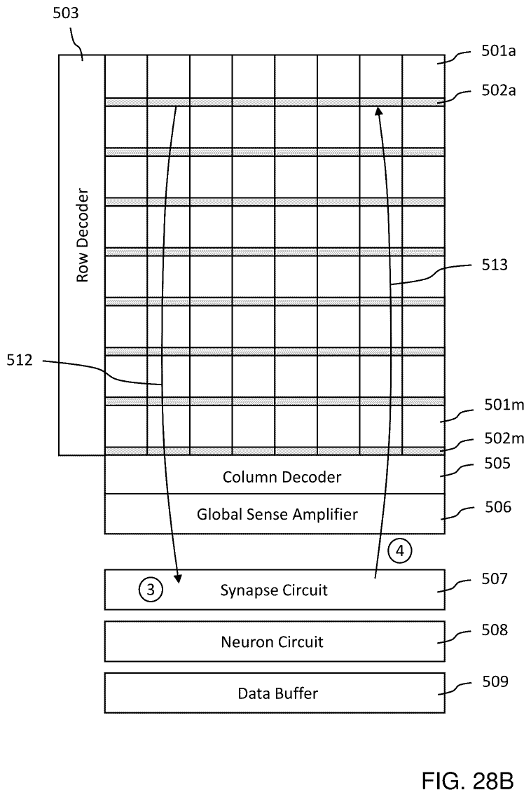

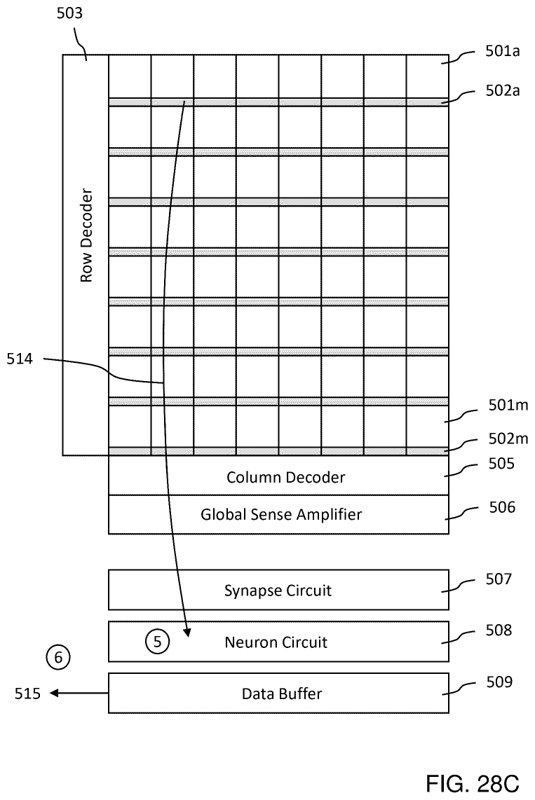

FIGS. 28A-28F show the operation of the bank. For demonstration purposes, the local word line drivers or decoders 504a to 504n are not shown. FIG. 28A shows steps (1) and (2) of the operation. In step (1), the input data is loaded to the data buffer 509, as shown by the arrow 511. The input data, IN0 to INm, may use the floating-point format shown in FIGS. 11A-11B.

In step (2), the input data, IN0 to INm, are sequentially loaded from the data buffer 509 to the row decoder 503 and applied to the selected word lines 510a to 510m, respectively. The selected word lines 510a to 510m are located in different sub-arrays 501a to 501m, as shown. Each word line may include multiple selected weights. Each input may be multiplied with multiple weights to generate multiple outputs, as in the architecture shown in FIG. 24B.

For each input, the loading sequence of the fraction bits, D0 to Dn, shown in FIGS. 12A-B may be applied. Using the first input, IN0, as an example, and referring to FIGS. 12A-B, when the first fraction bit, D0, is loaded, it may be multiplied with the fraction bits, W0 to Wn, of the weight stored in the selected memory cells 317a to 317b and generate a result to be stored in the sense amplifier 502a shown in FIG. 28A. This result may be sent to the synapse 507 in steps (3) and (4) of the operation shown in FIG. 28B.

Referring to FIG. 28B, in step 3, the data stored in the sense amplifiers 502a may be sent to the global sense amplifier 506 and then loaded to the synapse circuit 507, as shown by the arrow 512. The synapse circuit 507 may comprise the shift register circuit 375 and adder circuit 356 shown in FIG. 12A. These circuits may perform the operation shown in FIG. 12B to generate the multiplication result of the fraction bits of the input data, D0 to Dn, and the weight, W0 to Wn.

Next, in step (4), the result may be transferred to the global sense amplifier 506 and then stored back into the sense amplifier 502a to overwrite the previous data, as shown by the arrow 513. This operation may be repeated until all the input data, IN0 to INm, are loaded onto the word lines 510a to 510m shown in FIG. 28A and processed. As a result, the multiplication results of the inputs IN0 to INm and the weights may be stored in the sense amplifiers 502a to 502m, respectively.

It should be noted that, in the operation shown in FIGS. 28A-28B, the inputs IN0 to INm may be applied to the word lines 510a to 510m one by one, or multiple inputs may be applied at the same time. The synapse circuit 507 may comprise multiple shift-register and adder circuits to process data from the sense amplifiers in one row, or in multiple rows, in parallel to increase processing throughput.

After the multiplication results of each input and the weights are obtained, operation steps (5) and (6) shown in FIG. 28C may be performed. In step (5), the multiplication results stored in the sense amplifiers 502a to 502m may be sequentially transferred to the neuron circuit 508, as shown by arrow 514, to perform the accumulation operation. Please refer to FIGS. 12A-12B for a detailed description of the accumulation operation. The accumulated results may then be sent to activation-function circuits in the neuron circuit 508 to generate the final outputs, and the final outputs may be stored in the data buffer 509. In step (6), the final outputs may be transferred from the data buffer 509, as shown by arrow 515, to the global data buffer 491 shown in FIG. 27A. The operation of the bank is then finished.

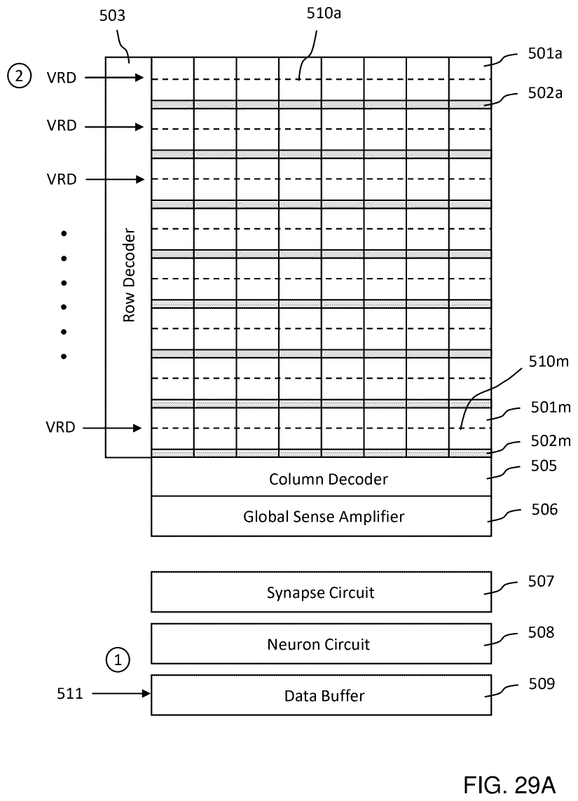

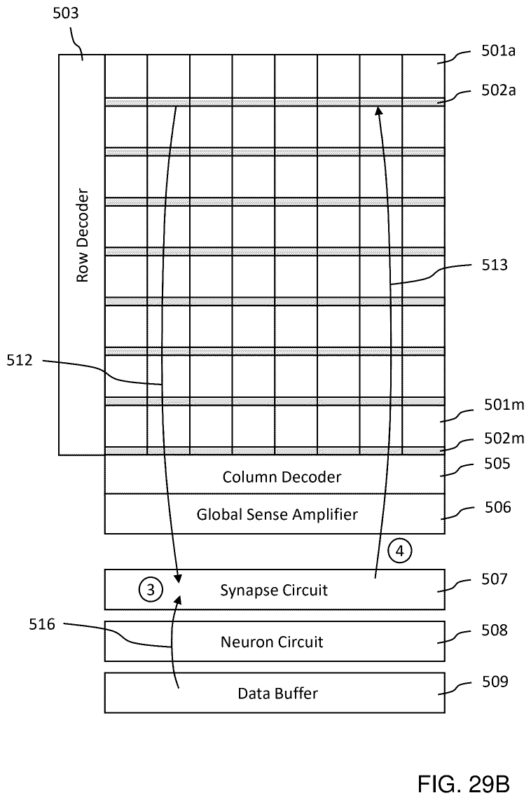

FIGS. 29A-29B show another embodiment of steps (1) to (4) of the bank operation. Referring to FIG. 29A, this embodiment is similar to the embodiment shown in FIGS. 28A-28B, except that in step (2), the selected word lines 510a to 510m are sequentially applied with a read voltage VRD, instead of the input data. The read voltage may turn on the memory cells to read the weight data. The weight data may then be stored in the sense amplifiers 502a to 502m.

Referring to FIG. 29B, the weight data stored in the sense amplifiers 502a to 502m are sequentially transferred to the global sense amplifier 506 and then loaded to the synapse circuit 507, as shown by the arrow 512. Meanwhile, the input data stored in the data buffer 509 are transferred to the synapse circuit 507, as shown by the arrow 516. The synapse circuit 507 performs a multiplication operation on the input data and the weight data. The multiplication results are then loaded to the global sense amplifier 506 and stored back to the sense amplifiers 502a to 502m, as shown by the arrow 513, to overwrite the previous data.

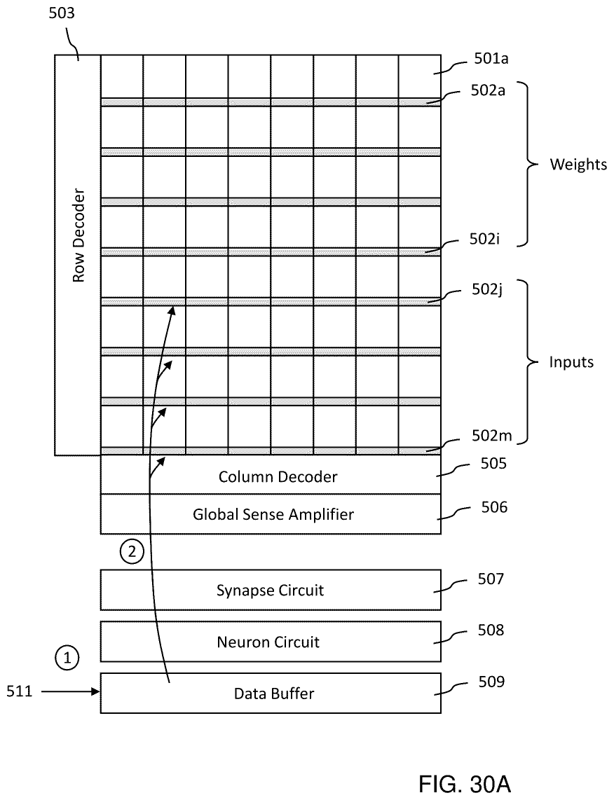

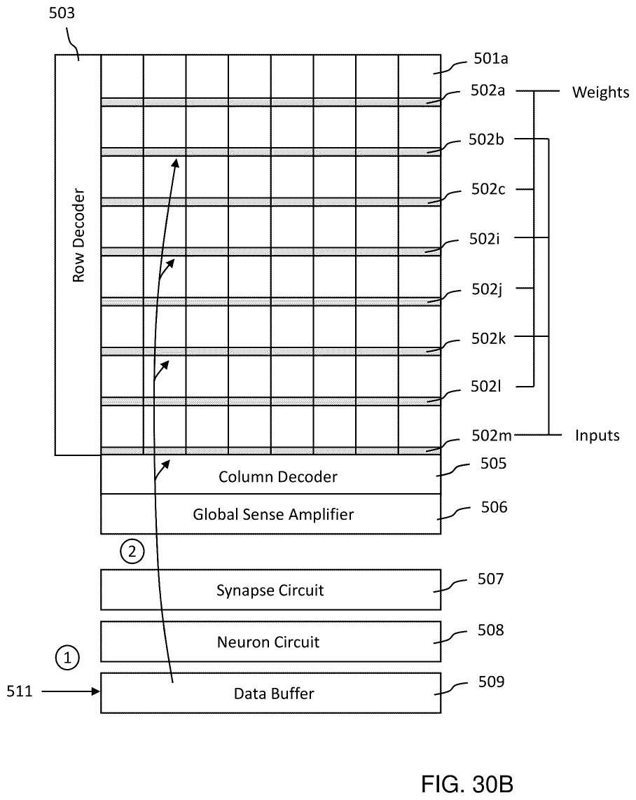

FIGS. 30A-30B show another embodiment of the operation of the bank.

Referring to FIG. 30A, in this embodiment, the sense amplifiers 502a to 502m may be divided into two or more groups. The first group of sense amplifiers 502a to 502i may be used to store the weight data or multiplication results, as in the previous embodiments shown in FIGS. 28A-29B. The second group of sense amplifiers 502j to 502m may be used to store the input data. Compared with the previous embodiments that store the input data in the data buffer 509, this embodiment greatly increases the amount of input data, thereby increasing processing throughput.

To operate this circuit, in step (1), the first group of input data is loaded into the data buffer 509, as shown by arrow 511. Then, in step (2), the first group of input data is transferred to the sense amplifiers 502j to 502m. This process may be repeated until the sense amplifiers 502j to 502m are fully loaded. After that, operation step (2) shown in FIG. 28A or FIG. 29A may be performed to generate the multiplication results or to read the weight data into the first group of sense amplifiers 502a to 502i. During the operation, the input data may be fetched from the second group of sense amplifiers 502j to 502m.

FIG. 30B shows another embodiment of the operation of the bank. This embodiment is similar to the one shown in FIG. 30A, except that the input data may be stored in the even sense amplifiers such as 502b to 502m, and the weight data or the multiplication results may be stored in the odd sense amplifiers 502a to 502l.

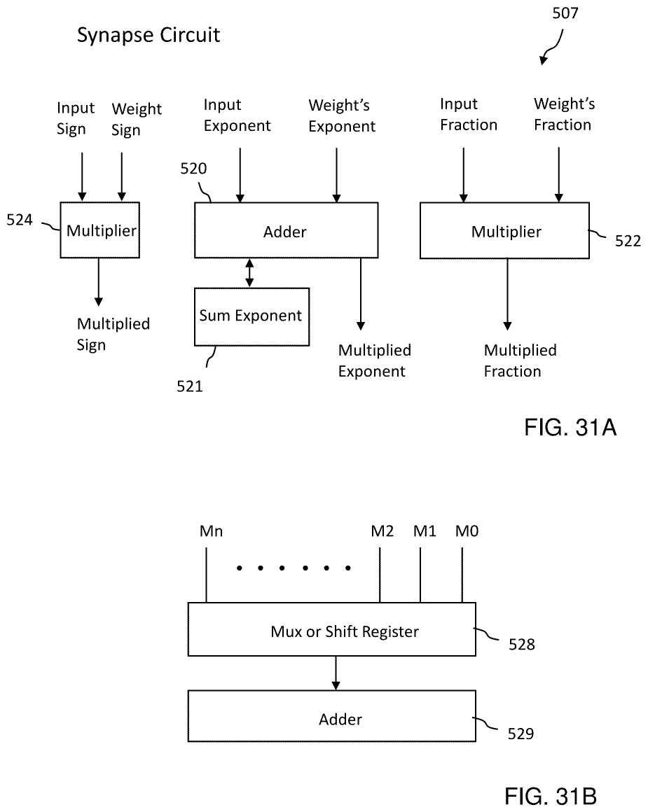

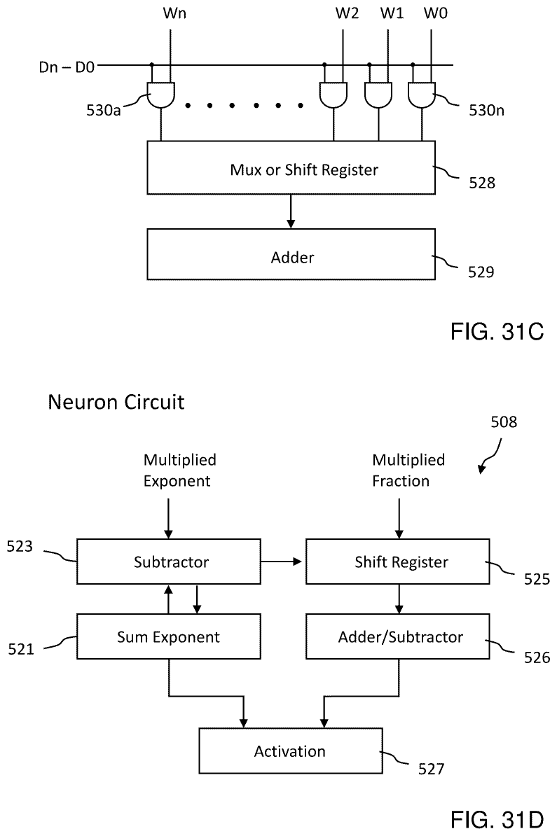

FIG. 31A shows an embodiment of the synapse circuit 507 implementation. The circuit comprises an adder circuit 520, a single-bit multiplier circuit 524, a multiple-bit multiplier circuit 522, and a register 521 that stores the exponent of the current sum. The adder 520 may add the exponent bits of the input and the weight to generate the exponent bits of the multiplication result. The result may be stored in the sum exponent register 521 and compared with the next result. The larger result may be stored in the register 521 to become the exponent of the current sum.

The multiple-bit multiplier circuit 522 multiplies the fraction bits of the input and the weight. In one embodiment, a conventional parallel multiplier circuit may be used. However, this circuit has a large layout size, which is disadvantageous.

FIGS. 31B-31C show another embodiment of the multiplier circuit implementation according to the invention.

FIG. 31B shows an embodiment using the operation shown in FIGS. 28A-28B. In this embodiment, the multiplication results are stored in the sense amplifiers 502a to 502m shown in FIG. 28A. Therefore, the fraction bits of the multiplication results, M0 to Mn, may be applied to a multiplexer or shift register 528 and an adder circuit 529 to perform the operation shown in FIG. 12B.

FIG. 31C shows another embodiment using the operation shown in FIGS. 29A-29B. In this embodiment, the weight data is stored in the sense amplifiers 502a to 502m shown in FIG. 29A. Therefore, the fraction bits of the weight data, W0 to Wn, may be applied to one input of AND logic gates 530a to 530n, as shown. The other input of the AND logic gates 530a to 530n is sequentially applied with the fraction bits of the input, D0 to Dn. The AND logic gates 530a to 530n may perform multiplication of the inputs and the weights, and then send the results to the multiplexer or shift register 528 and the adder circuit 529 to perform the operation shown in FIG. 12B.

FIG. 31D shows an embodiment of the neuron circuit 508 implementation. The circuit may comprise a subtractor circuit 523 and a shift register circuit 525. The circuit may receive the multiplication results from the sense amplifiers 502a to 502m shown in FIG. 28. The exponent bits are loaded to the subtractor 523, and the fraction bits are loaded to the shift register 525. The exponent bits are subtracted from the exponent bits of the current sum stored in the register 521 shown in FIG. 31A. The result determines how many bits the fraction is shifted to the right. Then, the fraction bits are shifted in the shift register 525 and loaded to the adder/subtractor 526.

Next, the next multiplication result may be read from the next sense amplifiers and loaded to the subtractor 523 and the shift register 525 to repeat the above-described process. The result may be loaded to the adder/subtractor 526 and then added to or subtracted from the previous data stored in the adder/subtractor 526, depending on the sign bit generated by the single-bit multiplier 524. The single-bit multiplier 524 may multiply the sign bits of the input and the weight to determine whether the multiplication result is positive or negative. This process may be repeated until all multiplication results are processed. Then, the final data stored in the adder/subtractor 526 and the sum exponent register 521 may be sent to an activation function block 527 to generate the final output.

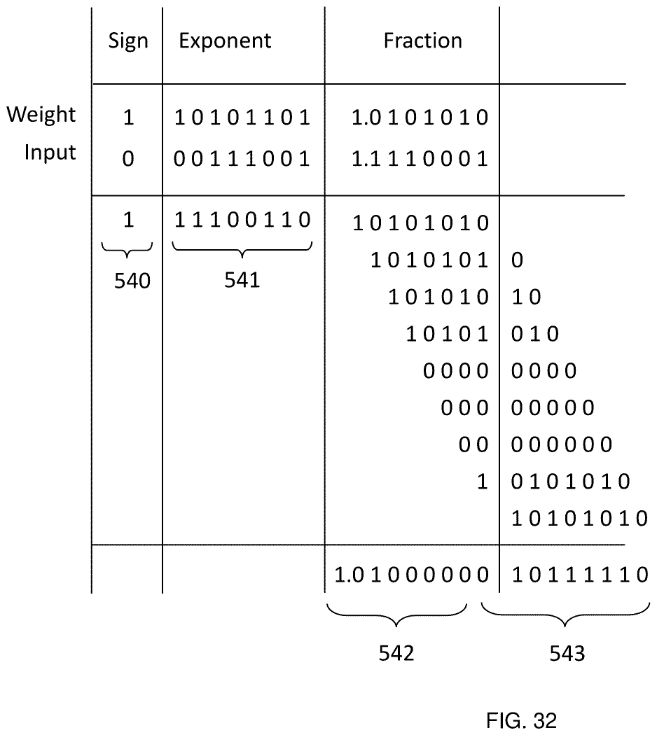

FIG. 32 shows an embodiment of the multiplication operation performed by the synapse circuit 507 shown in FIG. 31A. Assume the weight and the input use the brain floating-point (BF16) format, which has one sign bit, 8 exponent bits, and 8 fraction bits, as shown. 540 shows the multiplication result of the sign bits. 541 shows the result of the addition of the exponent bits. 542 and 543 show the multiplication result of the fraction bits. Depending on the desired precision, the LSB in 543 may be discarded to maintain BF16 precision.

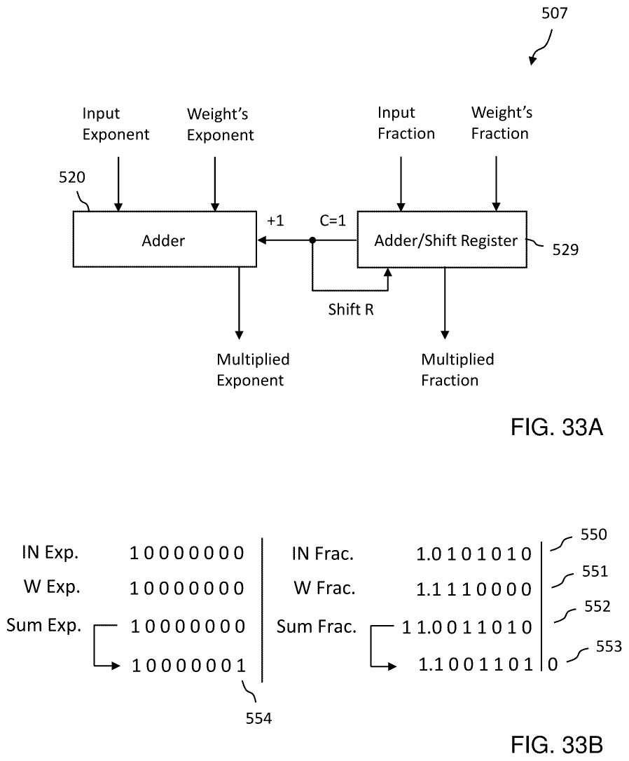

FIGS. 33A-33B show another embodiment of the synapse circuit for handling overflow in the adder 529 shown in FIGS. 31B-31C.

FIG. 33A shows that the adder 529 includes a shift-register function. When an overflow occurs, the carry bit C outputs a logic 1. This triggers the data stored in the adder/shift register to be shifted right by one bit, and a logic 1 is added to the exponent adder 520.

FIG. 33B shows an example of adding two data values 550 and 551 using the circuit shown in FIG. 33A. The sum 552 has an overflow, which triggers the fraction of the sum 553 to be shifted right by one bit. The least significant bit (LSB) of the fraction of the sum 553 is discarded. This keeps the number of fraction bits unchanged. Meanwhile, the exponent of the sum is incremented by 1, as shown by 554.

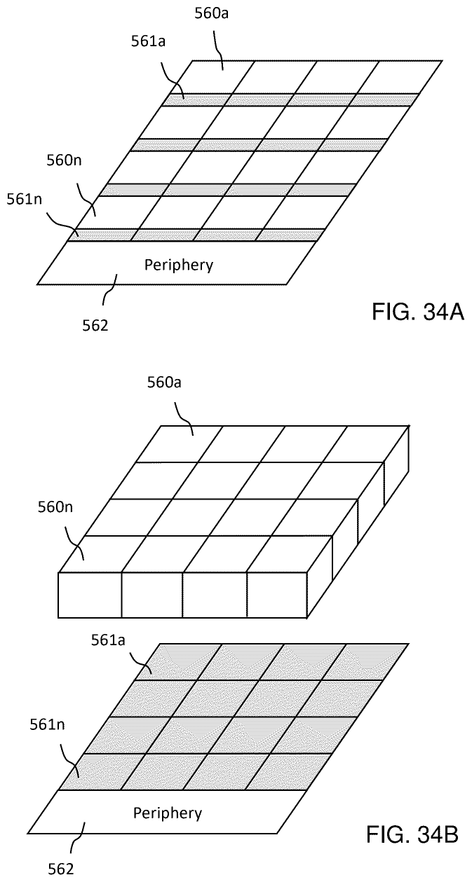

FIG. 34A shows an embodiment of a chip implemented using 2D memory technology according to the invention. The memory arrays 560a to 560n, AI circuits 561a to 561n, and a peripheral circuit 562 may be located on the surface of the chip.

FIG. 34B shows another embodiment of a chip implemented using 3D memory technology according to the invention. The memory arrays 560a to 560n may be located on top of the AI circuits 561a to 561n.

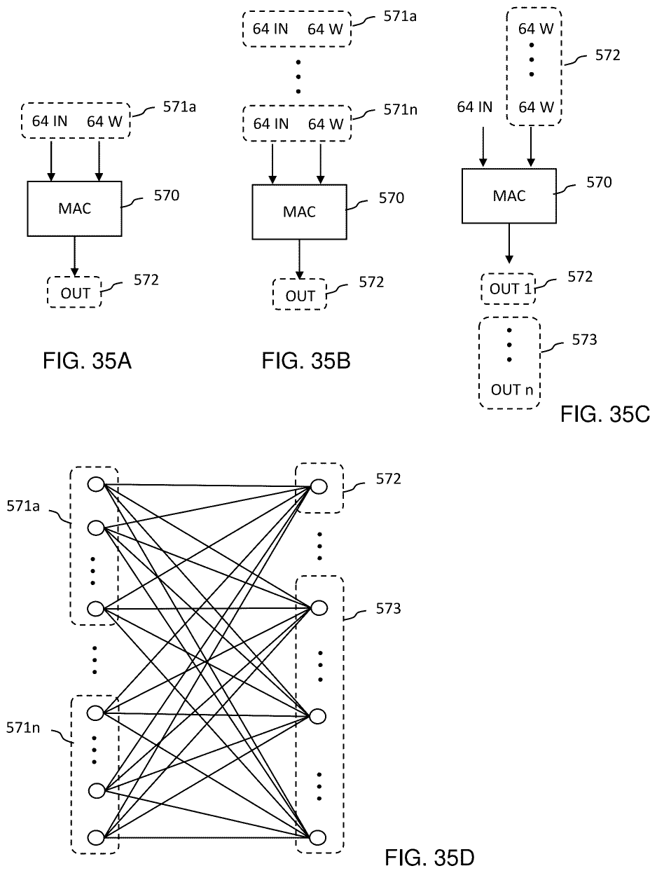

FIGS. 35A-D show an embodiment for flexibly configuring the number of inputs and outputs of a neural network according to the invention.

FIG. 35A shows a MAC function block 570 that receives 64 inputs and 64 weights 571a to generate one output 572, as an example. This circuit simulates the inputs 571a and the output 572 of the equivalent neural network shown in FIG. 35D.

FIG. 35B shows how to increase the number of input neurons without increasing the hardware, according to the invention. To do so, multiple groups of inputs and weights, such as 571a to 571n, may be repeatedly input to the MAC function block 570 to generate one output 572. This may simulate additional input neurons, such as 571n, shown in FIG. 35D. For the embodiment shown in FIG. 28A, this may be implemented by repeating step 2 and loading additional groups of input data to the memory array to multiply with different weights. For the embodiment shown in FIG. 29B, this may be implemented by repeating step 3 and loading additional groups of input data to the synapse circuit 507 to multiply with different weights.

FIG. 35C shows how to increase the number of output neurons without increasing the hardware, according to the invention. To do so, multiple groups of weights, such as 572, may be repeatedly input to the MAC function block 570 to multiply with the same inputs and generate additional outputs 573. This may simulate additional output neurons, such as 573, shown in FIG. 35D. This embodiment may be implemented by repeating the operations shown in FIG. 28A and FIG. 29B with the same inputs but different weights.

However, the approach shown in FIGS. 35B-35C may cause an output-range problem. Because the MAC function block 570 is designed to handle a fixed number of inputs and weights, when additional inputs are fed into the MAC function block 570, the accumulation result may exceed the maximum range of the MAC function block 570. On the other hand, if the number of inputs is lower than the maximum supported by the MAC function block 570, the accumulation result may not fall within the proper range of the activation function.

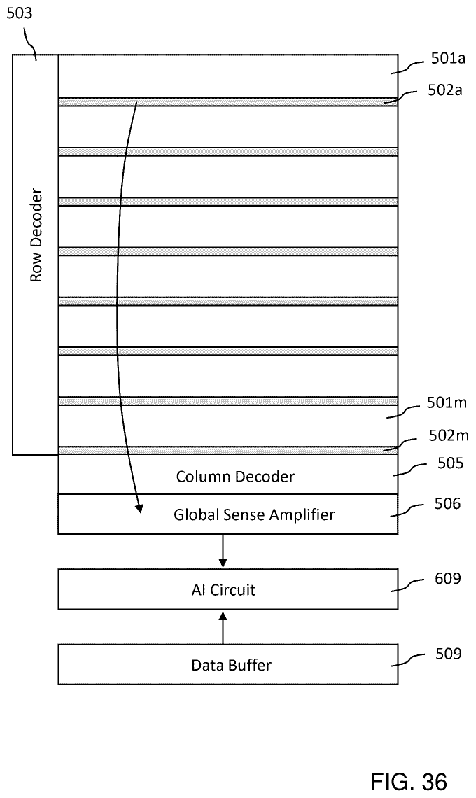

FIG. 36 shows another embodiment of the architecture of a bank 490a according to the invention. In this embodiment, the sub-arrays 501a to 501m may store weight data. The weight data stored in the cells may be read into sense amplifiers 502a to 502m and then transferred to a global sense amplifier 506. The input data is loaded into the data buffer 509. Then, both the weight data and the input data may be transferred to the AI circuit 609 to perform the calculations.

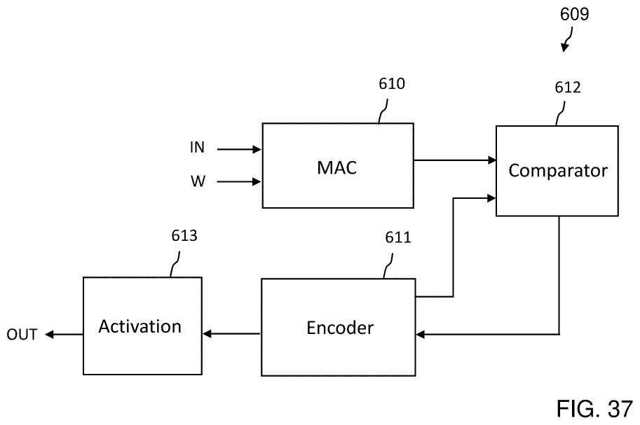

FIG. 37 shows an embodiment of the architecture of the AI circuit 609 shown in FIG. 36 according to the invention. The circuit may comprise a MAC circuit 610, an encoder 611, a comparator 612, and an activation circuit 613. The MAC circuit 610 may input the weight W and input data IN to perform a MAC operation. The result is sent to the comparator 612 for comparison with a reference generated by the encoder 611. The comparison result may be sent to the encoder 611 to determine the data. Then, the data may be sent to the activation circuit 613 to generate the final output OUT.

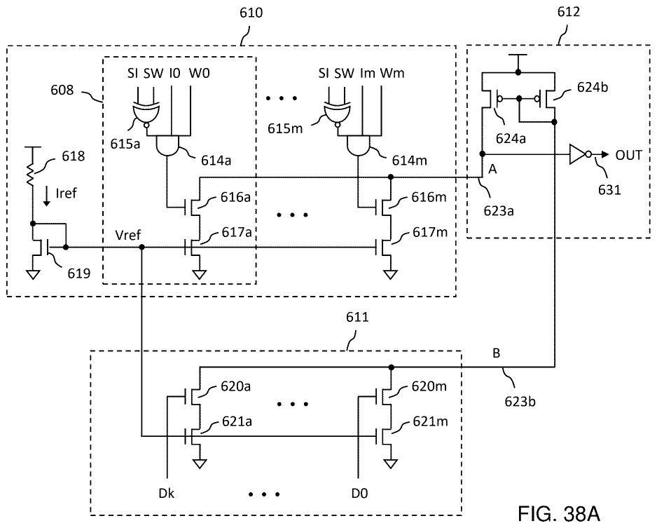

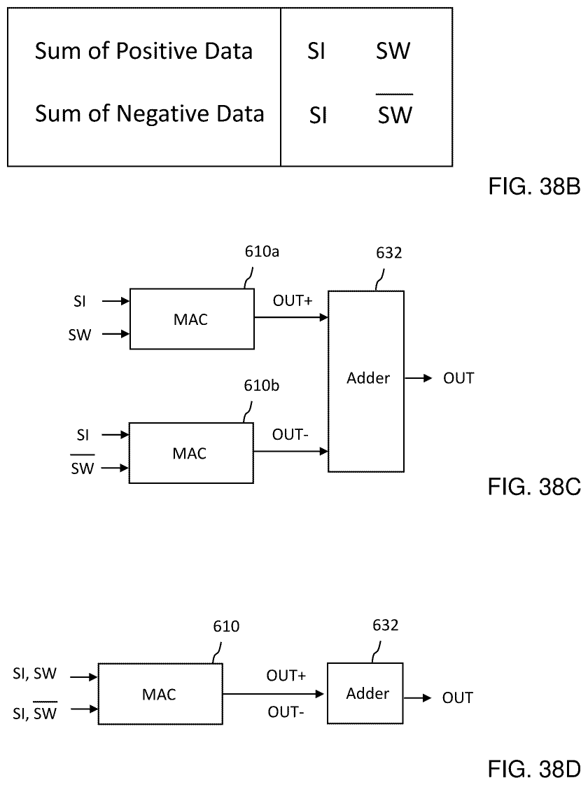

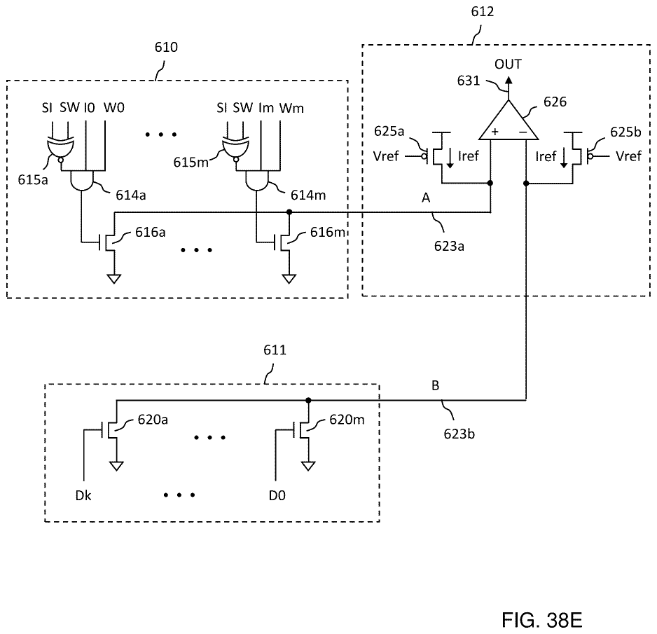

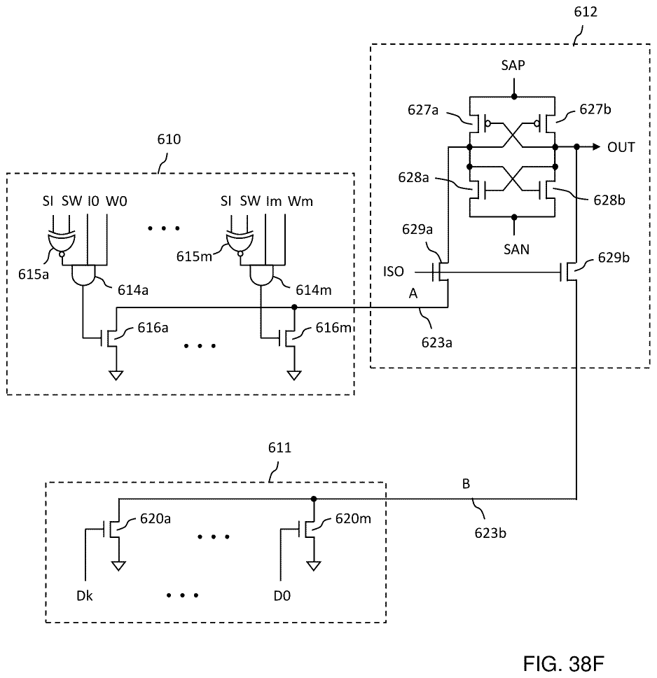

FIG. 38A shows an embodiment of the circuit implementation of the MAC circuit 610, encoder 611, and comparator 612 shown in FIG. 37 according to the invention. The MAC circuit 610 may comprise multiple unit circuits such as 608 to perform multiplication of the input data I0 to Im, the weights W0 to Wm, and the sign bits of each input SI and weight SW. The unit circuit 608 may comprise an AND gate 614a, an XNOR gate 615a, and transistors 616a and 617a.

When the output of the XNOR gates 615a to 615m is 1, the AND gates 614a to 614m are enabled. The AND gates 614a to 614m multiply the inputs I0 to Im by the weights W0 to Wm. When both an input and its corresponding weight are 1, the output of the corresponding AND gate 614a to 614m is 1; otherwise, the output is 0.

When the output of the AND gates 614a to 614m is 1, transistors 616a to 616m are turned on and conduct current from node A 623a to ground. The sum of the currents represents the accumulation result of the multiplication products of all the inputs and weights.

The current may be controlled by transistors 617a to 617m. Transistors 617a to 617m and transistor 619 form a current mirror. Transistor 619 may be connected to a constant current source, such as a resistor 618, to generate a reference current Iref. This generates a reference voltage Vref to control the current of transistors 617a to 617m. By adjusting the current-mirror ratio, the current may be adjusted to reduce the circuit's power consumption.

When both sign bits SI and SW are 1 (negative) or 0 (positive), the outputs of XNOR gates 615a to 615m will be 1, enabling AND gates 614a to 614m. If one sign bit is 1 (negative) and the other is 0 (positive), AND gates 614a to 614m will output 0 to turn off transistors 616a to 616m. Therefore, the sum of the current represents the accumulation result of all positive data.

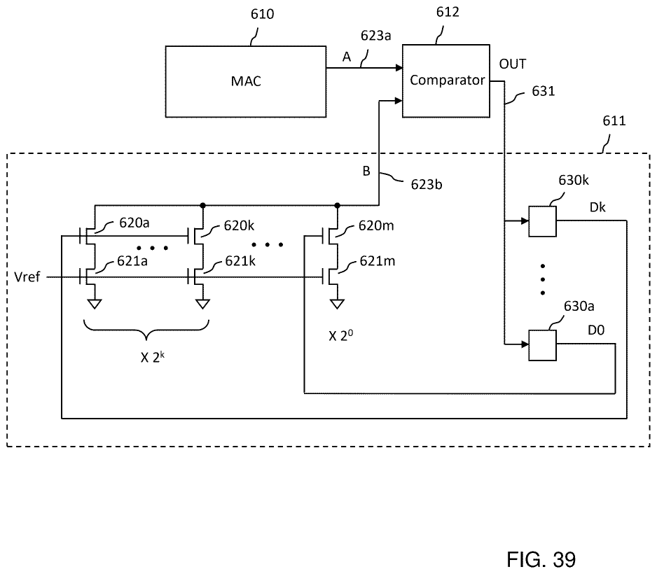

The encoder circuit 611 may comprise a structure similar to the MAC circuit 610, except that the gates of transistors 620a to 620m are connected to data Dk to D0 to generate a reference current flowing from node B (623b) to ground. The transistors 621a to 621m may be connected to the same current mirror to provide tracking. Please refer to FIG. 39 for a detailed description of the encoder 611.

The comparator 612, formed by PMOS transistors 624a and 624b, compares the currents at node A 623a and node B 623b to generate output 631. If the current at node A 623a is higher than the current at node B 623 b, the output 631 of the comparator 612 is 1; otherwise, the output is 0.

FIG. 38B shows that to accumulate negative data, the sign of either the input SI or the weight SW may be inverted. Therefore, when the sign bits SI and SW are one 1 (negative) and one 0 (positive), the outputs of XNOR gates 615a to 615m will be 1 to enable AND gates 614a to 614m. This causes the sum of the current to represent the accumulation result of all negative data.

FIG. 38C shows an embodiment for processing positive data and negative data according to the invention. The positive data and negative data may be processed by two MAC circuits 610a and 610b, respectively. The sign bits SI and SW may be input to MAC circuit 610a to process the positive data. The sign bits SI and SW-bar may be input to MAC circuit 610b to process the negative data. Then, the outputs OUT+ and OUT− may be added by an adder circuit 632 to obtain the final data, OUT.

FIG. 38D shows another embodiment configured to process positive data and negative data according to the invention. This embodiment is similar to the one shown in FIG. 38C except that it uses only one MAC circuit 610. This embodiment may be performed in two steps. In the first step, the sign bits SI and SW may be input to MAC circuit 610 to process the positive data. In the second step, the sign bits SI and SW-bar may be input to MAC circuit 610 to process the negative data. Then, the outputs OUT+ and OUT− may be added by an adder circuit 632 to obtain the final data, OUT.

FIG. 38E shows another embodiment of the circuit implementation of the MAC circuit 610, encoder 611, and comparator 612 shown in FIG. 37 according to the invention. This embodiment is similar to the one shown in FIG. 38A except in MAC circuit 610 and the encoder 611, the current mirror transistors 617a to 617m and 621a to 612m are eliminated. Instead, the current is controlled by two PMOS transistors 625a and 625b. The gates of the PMOS transistors 625a and 625b are connected to a reference voltage (Vref) to generate reference currents (Iref). The reference currents will be ration with the current of the node A 623a and node B 623b to generate the input voltages for the comparator circuit 626.

FIG. 38F shows another embodiment of the circuit implementation of the MAC circuit 610, encoder 611, and comparator 612 shown in FIG. 37 according to the invention. This embodiment is similar to the one shown in FIG. 38E except the comparator 612 uses a latch type comparator widely used in sense amplifier circuit of DRAM. The transistors 627a, 627b, 628a, and 628b form a latch. Initially, the isolation transistors 629a and 629b are turned on to ratio the current of node A 623a and node B 623b with the PMOS transistors 627a and 627b. Then, the isolation transistors 629a and 629b are turned off to develop the data of the latch.

FIG. 39 shows an embodiment of the circuit implementation of the encoder 611 shown in FIG. 37 according to the invention. This circuit is similar to the MAC circuit 610 shown in FIG. 38A, except that the gates of transistors 620a to 620m are connected to multiple data latches 630a to 630k. The outputs D0 to Dk of the data latches 630a to 630k represent data bits 2⁰ to 2^{k}, respectively. These outputs are connected to different numbers of transistors 620a to 620m according to their corresponding data bits. For example, output D0 is connected to one 2⁰ transistor 620m. Output Dk is connected to 2^{k} transistors 620a to 620k, as shown. The gates of transistors 621a to 621m are connected to a reference voltage to control the current, as shown in FIG. 38A. If the embodiments shown in FIGS. 38E-F are used, transistors 621a to 621m may be eliminated.

To operate the circuit, first, the data latches 630a to 630k are reset to data 0. Then, the last data latch 630k is set to data 1. This may turn on 2^{k} transistors 620a to 620k, which is equal to half of the total transistors. The comparator 612 will compare the current of node B 623b with node A 623a of the MAC circuit 611 to generate output 631. Then, output 631 will be loaded into data latch 630k to flip data bit Dk.

For example, if output 631 is 1, that means the current of node A 623a is higher than the current of node B 623b. The new data bit Dk will be set to 1. If output 631 is 0, that means the current of node A 623a is lower than the current of node B 623b. The new data bit Dk will be set to 0. This procedure will be repeated for the remaining data latches 630b to 630a to set data bits Dk−1 to D0.

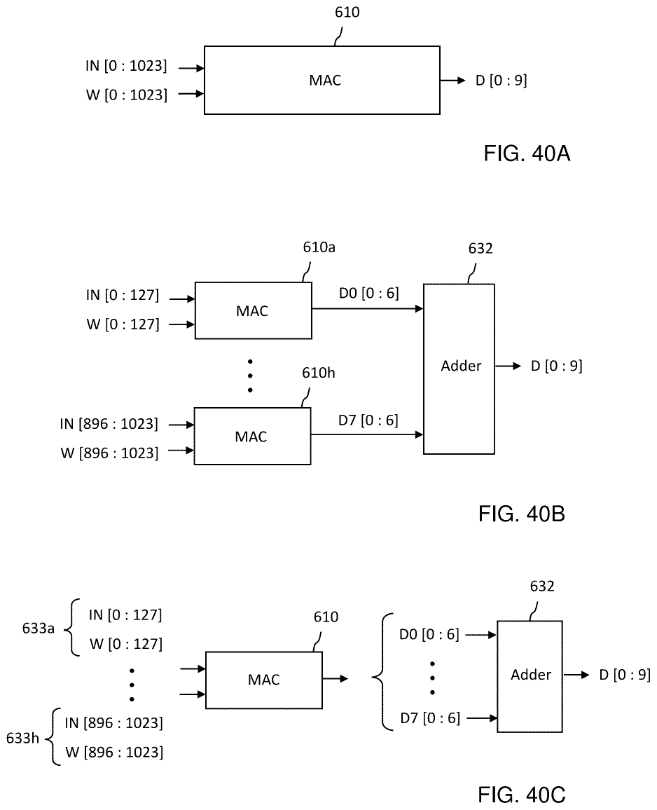

FIG. 40A-C shows embodiments of various configurations of the MAC circuit 610 shown in FIG. 37 according to the invention.

In FIG. 40A, it is assumed that the MAC circuit 610 comprises 1024 inputs, IN[0:1023], and 1024 weights, W[0:1023]. The circuit may comprise 1024 unit-circuits 608 shown in FIG. 38A to perform multiplication and accumulation of the inputs and weights and may use the encoder 611 to generate a 10-bit output, D[0:9].

FIG. 40B shows another embodiment of the configuration of the MAC circuit 610. This embodiment divides the MAC circuit into multiple smaller MAC circuits, such as eight MAC circuits 610a to 610h. Each MAC circuit may comprise 128 unit-circuits to process 128 inputs, such as IN[0:127] through IN[896:1023], and 128 weights, such as W[0:127] through W[896:1023]. Each MAC circuit may generate 7-bit outputs, such as D0[0:6] through D7[0:6]. The outputs may then be added by an adder circuit 632 to generate a 10-bit output, D[0:9].

FIG. 40C shows another embodiment of the configuration of the MAC circuit 610. This embodiment uses one smaller MAC circuit 610 (for example, with 128 unit-circuits) and applies it multiple times (for example, eight times) to different sets of inputs and weights, such as 633a to 633h, to generate eight outputs, D0[0:6] through D7[0:6]. The outputs may then be added by an adder circuit 632 to generate a 10-bit output, D[0:9].

The MAC circuit shown in FIG. 38A may process the multiplication and accumulation of a large number of single-bit inputs and weights. Therefore, for fixed-point numbers such as those shown in FIG. 2, bits D0 to Dn of multiple inputs and bits W0 to Wn of multiple weights may be applied to the MAC circuit sequentially to obtain the sums of D0×W0, D0×W1, . . . , through Dn×Wn, and then add them together.

However, for floating-point numbers, the MAC operation is much more complicated. It typically requires multiple steps, including finding the maximum exponent among all inputs and weights, subtracting the maximum exponent from the exponent of each input and each weight, shifting the fraction bits based on the subtraction results, multiplying the fraction bits, and then adding the exponent bits. This process is time-consuming and requires a substantial amount of circuitry.

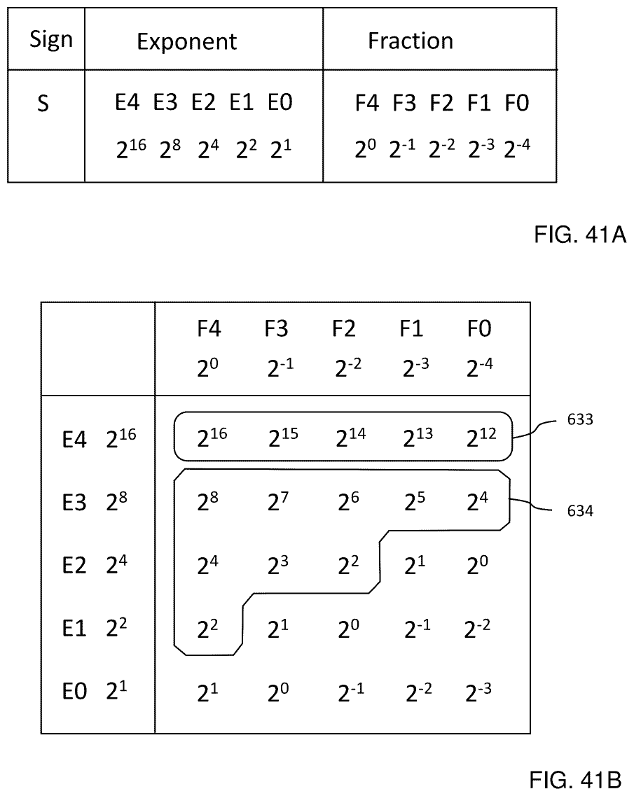

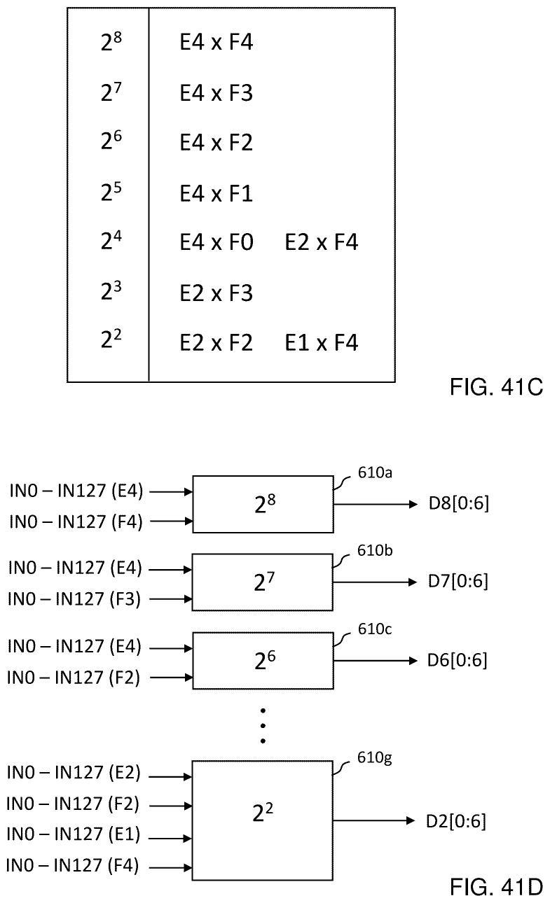

FIGS. 41A-D show an embodiment of a process for floating-point numbers using the MAC circuit 610 shown in FIGS. 38A-F, according to the invention.

As an illustration, FIG. 41A shows the format of a floating-point number using a 5-bit exponent and a 5-bit fraction as an example. The number comprises one sign bit S, five exponent bits E4 to E0 (representing 2¹⁶ to 2¹), and five fraction bits F4 to F0 (representing 2⁰ to 2⁻⁴). Please note that the exponent bits E4 to E0 have a higher power than the fraction bits F4 to F0.

Because the MAC circuit 610 can process multiplication and accumulation of a large number of single-bit inputs and weights, each exponent bit and fraction bit may be multiplied using this circuit and then added together to convert it into a fixed-point-number-like number.

FIG. 41B shows the power of the multiplication result for each exponent bit, E4 to E0, and each fraction bit, F4 to F0. It shows that the multiplication results involving E4, from 2¹⁶ to 2¹² as shown in 633, are far larger than the others. This means the E4 bit may be over-dominant, so the E4 bit should be avoided. Assuming 7-bit resolution is selected as an example, the power range from 2⁸ to 2² may be selected, as shown in 634.

FIG. 41C shows the combinations of exponent bits multiplied by fraction bits to form the powers from 2⁸ to 2².

FIG. 41D shows an embodiment that uses MAC circuits 610a to 610g to generate results for each power from 2⁸ to 2², respectively. For example, the MAC circuit 610a may multiply the E4 bit and the F4 bit of multiple inputs (for example, 128 inputs) to generate an 8-bit result, D8[0:6]. Then, the results D2[0:6] to D8[0:6] may be added using an adder circuit according to their respective powers to generate fixed-point-number-like final data.

This embodiment has several advantages. First, the complicated operations used in conventional approaches to process floating-point numbers are eliminated. Second, large numbers of inputs and weights may be processed by the MAC circuits in parallel, thus greatly increasing processing throughput. Third, the circuits required to perform the MAC operation are greatly reduced, thereby reducing die size.

The process shown in FIGS. 41A-41C may be used to convert both the input data and the weights into fixed-point-number-like data. After that, the input data and the weights may be multiplied and accumulated using the same operation.

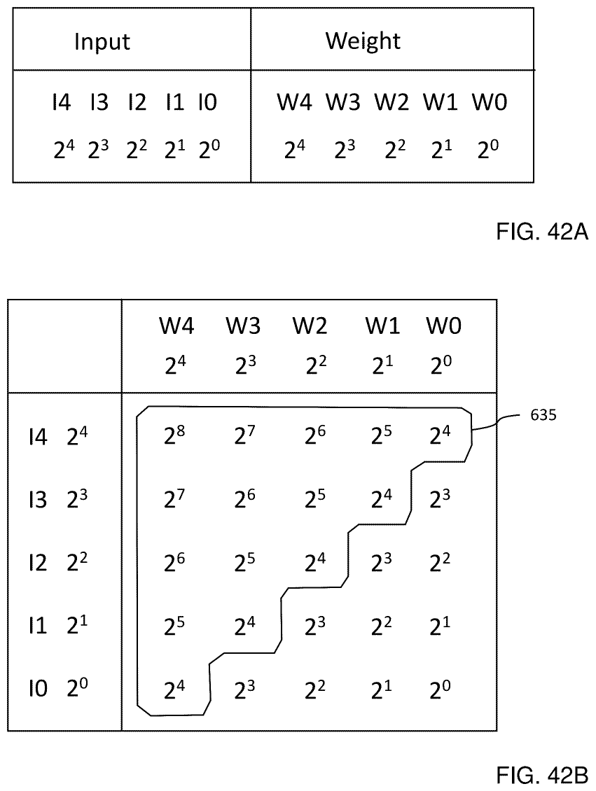

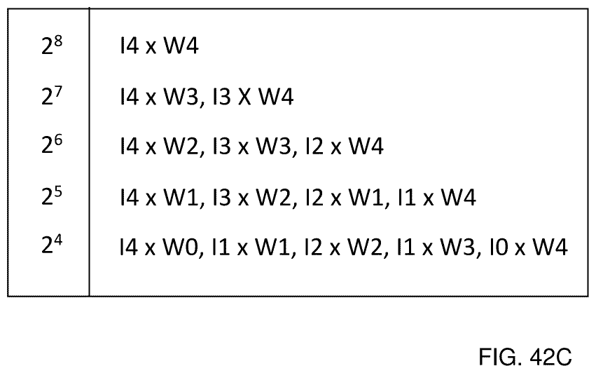

FIG. 42A shows an example of multiplying a 5-bit input and a 5-bit weight. Both the input and the weight comprise five bits, such as I4 to I0 and W4 to W0, representing 2⁴ to 2⁰.

FIG. 42B shows the powers of the multiplication results for each input bit, I4 to I0, and each weight bit, W4 to W0. Please note that, because the powers of the input and the weight differ from those of the exponent, the results shown in FIG. 42B differ from those in FIG. 41B. Assuming a 4-bit resolution is selected as an example, the power range from 2⁸ to 2⁴ is selected, as shown in 635.

FIG. 42C shows the combinations of the exponent bits multiplied by the fraction bits to form powers from 2⁸ to 2⁴. These combinations may be implemented using circuits similar to those shown in FIG. 42B.

Because the operations shown in FIGS. 41A-42C use the same operation, the MAC circuits 610a to 610h shown in FIG. 41B may be repeatedly used to process (i) multiplication of the exponent and fraction and (ii) multiplication of the inputs and weights, thereby reducing circuit layout size.

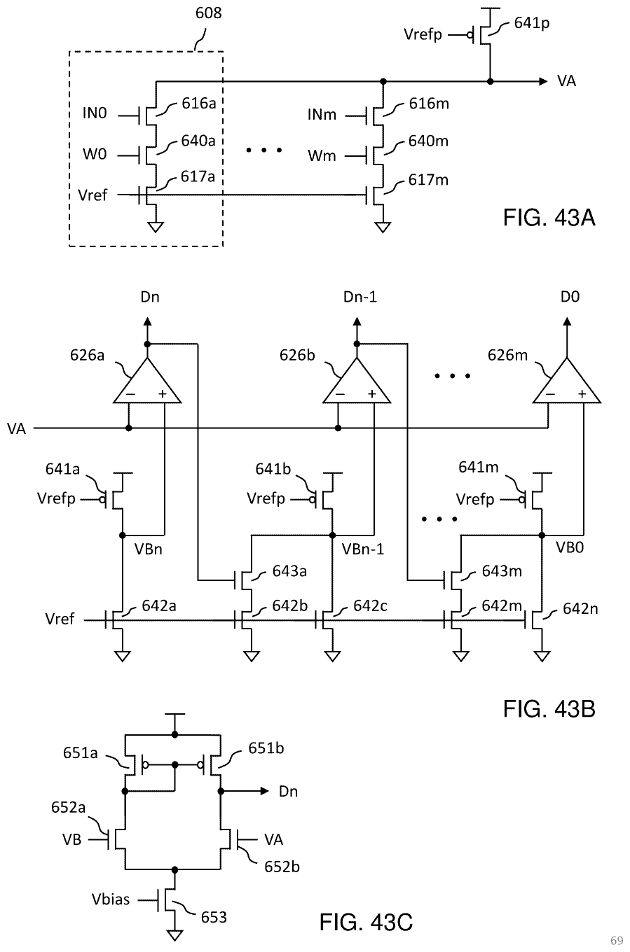

FIG. 43A shows an embodiment of a circuit implementation of a MAC circuit according to the invention. The MAC circuit may comprise multiple unit-circuits such as 680. The unit-circuit 680 is similar to the one shown in FIG. 38A but may require only three transistors. This design reduces transistor count, enabling integration of more circuits within a chip and enhancing parallel processing efficiency.

The gates of transistors 616a to 616m and 640a to 640m are connected to input data, IN0-INm, and weights, W0-Wm, respectively. The transistors 616a to 616m and 640a to 640m may perform a multiplication function for the input data and the corresponding weights. For example, if both IN0 and W0 are logic 1 (VDD), transistors 616a and 640a will turn on, allowing current conduction. Conversely, if either IN0 or W0 is logic 0 (0 V), transistor 616a or 640a will turn off, preventing current flow.

The gates of transistors 617a to 617m may be connected to a current mirror, such as transistor 619 shown in FIG. 38A, to generate substantially constant currents. The channel widths of transistors 617a to 617m may be selected based on the corresponding input data and weights. For example, for input data I0 to I4 in FIG. 42A, the channel widths may follow a scaling pattern of 1X, 2X, 4X, 8X, and 16X, respectively. The same scaling pattern may be applied to weights W0 through W4.

The total current flowing through the unit circuits represents the accumulated sum of the products of all inputs and their corresponding weights. The drains of transistors 616a through 616m are connected to transistor 641p, whose gate is tied to a reference voltage Vrefp to establish a substantially constant loading current. This loading current helps determine the output voltage VA, which may be set by the ratio between the loading current and the total current of the unit circuits. Note that the final current flowing through the entire MAC circuit may be constrained by the loading current of transistor 641p. This design may reduce power consumption compared to traditional architectures that rely on analog-to-digital converters.

FIG. 43B shows a circuit that receives the output voltage VA shown in FIG. 43A. In the circuit shown in FIG. 43B, comparators 626a through 626m compare VA against reference voltages VBn to VB0, thereby generating output data Dn to D0, respectively. The gates of transistors 641a to 641m are connected to a reference voltage Vrefp to generate substantially constant loading currents.

The gates of transistors 642a to 642n may be connected to a current mirror, such as transistor 619 shown in FIG. 38A, to generate substantially constant currents. The channel widths of transistors 642a through 642n may be designed based on the corresponding output data and weights. For example, for output data D0 through Dn, the channel widths may follow a scaling pattern of 1X, 2X, 4X, up to 2ⁿX, respectively.

The reference voltages VB0 through VBn are defined by the ratio of the loading currents of transistors 641a through 641m to the currents of transistors 642a through 642n.

FIG. 43C presents an embodiment of the comparator implementation for 626a through 626m, where inputs VA and VB are applied to the gates of transistors 652a and 652b. Additionally, the operating current of this circuit is limited by the current of transistor 653, controlled by the reference voltage Vbias. As a result, the MAC circuit depicted in FIGS. 43A-43C can achieve very low power consumption. Compared with traditional architectures that rely on analog-to-digital converters, this circuit provides many advantages, including lower transistor count, lower power consumption, and high processing throughput.

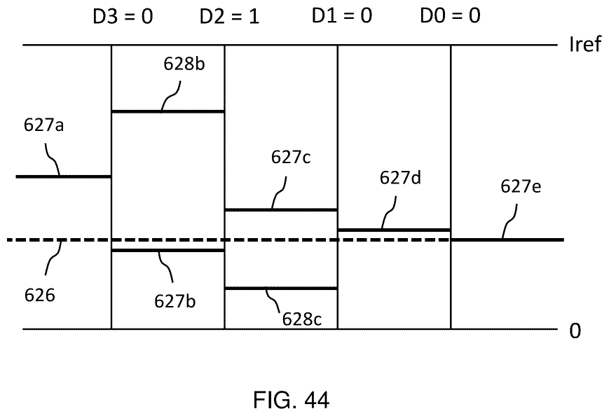

FIG. 44 illustrates an example wherein the total current 626 of the MAC circuit is compared against reference currents 627a through 627e, thereby generating the output data D3 through D0.

Referring again to FIG. 43B, the first comparator 626a compares the total current 626 with the reference current 627a, which is set to ½ Iref, in terms of voltages VA and VB3. Since current 626 is lower than reference current 627a, comparator 626a outputs a data value of 0 for D3, turning off transistor 643a and thereby lowering the next reference current to ¼ Iref, as 627b shown in FIG. 44. Conversely, if the output data is 1, transistor 643a turns on, increasing the next reference current to ¾ Iref, as shown 628b.

The second comparator 626b compares the total current 626 with the reference current 627b in terms of voltage VA against VB2. Since current 626 is higher than reference current 627b, comparator 626b generates an output data value of 1 for D2, turning on transistor 643m and increasing the next reference current to ⅜ Iref, as 627c shown in FIG. 44. Conversely, if the output data is 0, transistor 643m turns off, reducing the next reference current to ⅛ Iref, as depicted in 628c. Similar operations occur for reference currents 627d and 627e to generate output data D1 and D0. Please note that the comparisons for D3 through D0 occur in parallel, which significantly enhances the circuit's processing throughput.

The operating currents of the circuit shown in FIG. 43B are limited by the loading currents of transistors 641a through 641m, which are regulated by the reference voltage Vrefp.

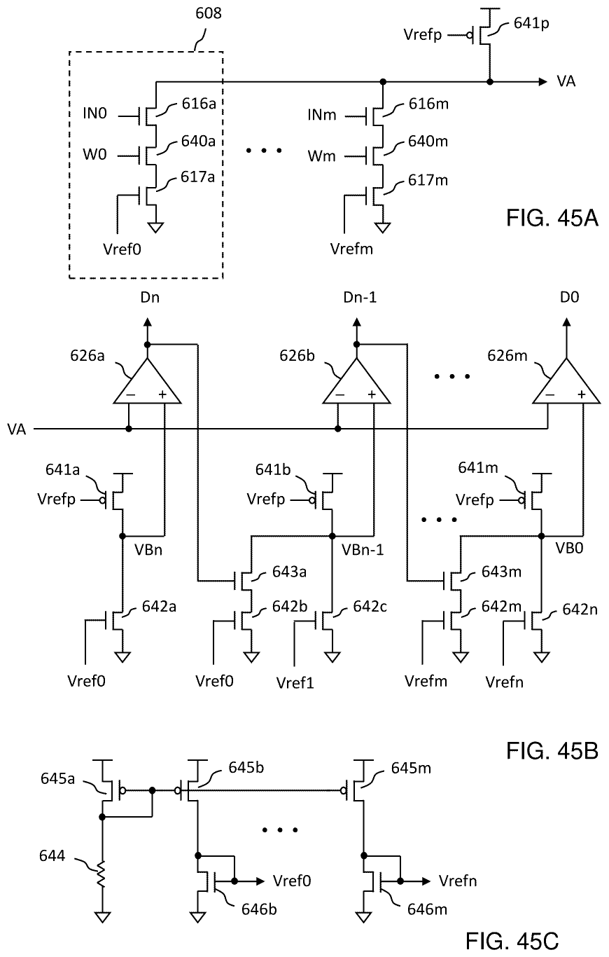

FIG. 45A illustrates another embodiment of the MAC circuit according to the invention. This embodiment is similar to the one shown in FIG. 43A, except that the gates of transistors 617a through 617m are connected to multiple reference voltages, Vref0 through Vrefm, as shown. These reference voltages may be generated by the circuit shown in FIG. 45C, where 644 serves as a constant current source, such as a resistor. Current mirror circuits 645a through 645m replicate the constant current at scaling factors of 1X, 2X, . . . up to 2mX. The resulting currents are then converted into reference voltages, Vref0 through Vrefm, by transistors 646b to 646m, and then replicated to transistors 617a through 617m shown in FIG. 45A by another set of current mirror circuits. This approach allows transistors 617a through 617m to use the same channel width. Because the reference voltages can be shared across multiple MAC circuits, this approach minimizes the overall circuit layout size.

FIG. 45B shows another embodiment of the comparator circuit, similar to FIG. 43B, except that the gates of transistors 642a through 642n are connected to multiple reference voltages, Vref0 through Vrefn, as shown. These reference voltages, which may be generated by the circuit in FIG. 45C, enable transistors 642a through 642n to use the same channel width, thereby reducing the overall circuit layout size.

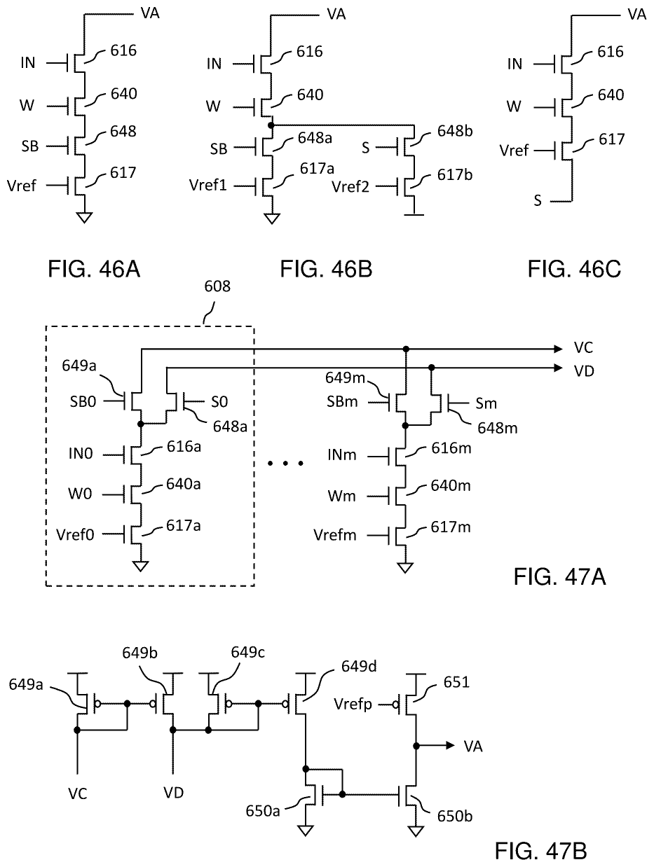

FIGS. 46A-46C illustrate an alternative embodiment of the unit circuit 608 within the MAC circuit shown in FIG. 43A. In these embodiments, the “sign” bit S of a weight is incorporated.

FIG. 46A shows how the complementary sign bit SB is applied to the gate of transistor 648. When the sign bit is 0, indicating a positive value, transistor 648 is turned on, allowing current to flow. Conversely, when the sign bit is 1, indicating a negative value, transistor 648 is turned off, preventing current flow.

FIG. 46B shows how additional transistors 648b and 617b are used to facilitate current flow in the reverse direction when the sign bit is 1, indicating a negative value.

FIG. 46C shows how the sign bit is applied to the source of transistor 617, allowing current to flow in reverse directions depending on whether the sign bit is 1 or 0.

FIGS. 47A-B illustrate another embodiment of the MAC circuit that incorporates sign bits.

FIG. 47A shows that, in this design, the sign bits S0 through Sm are connected to the gates of transistors 648a through 648m, while the complementary sign bits SB0 through SBm are connected to the gates of transistors 649a through 649m. As a result, depending on whether the sign bit is 0 or 1, current is conducted from either output node VC or VD, respectively.

FIG. 47B shows how the outputs VC and VD are connected to the drains of transistors 649a and 649b. Transistors 649a through 649d form a current mirror circuit that replicates the differential current between nodes VC and VD to transistor 649d. The differential current corresponds to the multiplication-accumulation result, derived from the subtraction of negative weights from positive weights. The differential current is mirrored from transistor 650a to transistor 650b, generating an output voltage VA, which is determined by the ratio of the differential current to the loading current of transistor 651. The output voltage VA is then sent to the comparator circuit shown in FIG. 43B or FIG. 45B to generate the output data, Dn-D0.

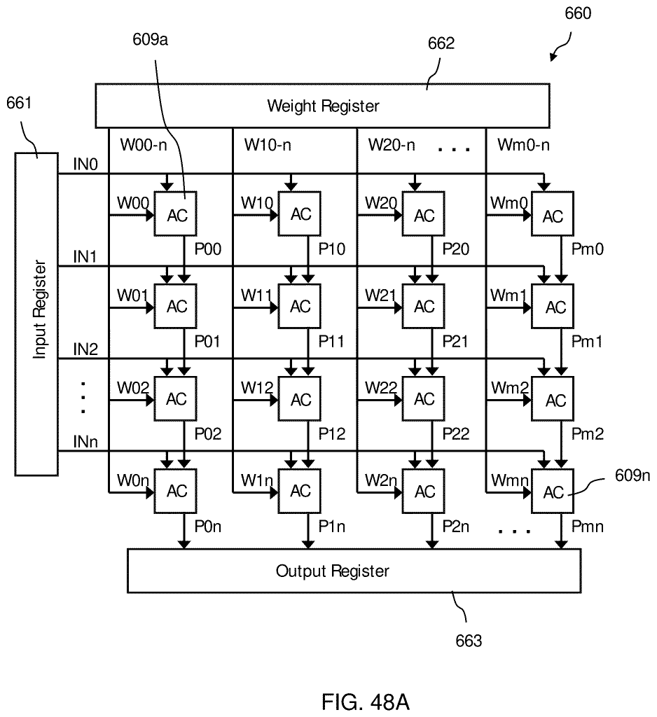

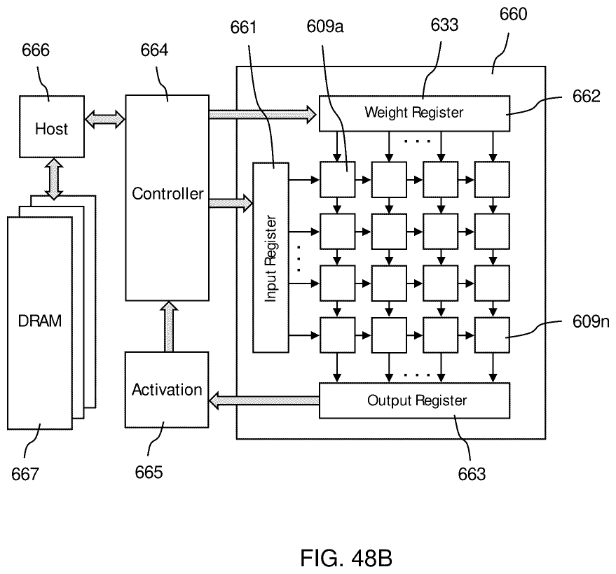

FIG. 48A shows another embodiment of the invention of an AI circuit array 660 that comprises multiple AI circuits (AC) such as 609a to 609n, input register 661, weight register 662, and output register 663. The input register 661, weight register 662, and output register 663 may be implemented using suitable memory cells, including static random-access memory (SRAM), dynamic random-access memory (DRAM), and one-transistor (1T) DRAM. In another embodiment, the registers 661, 662, and 663 may be implemented by register circuits, including shift registers, latches, and flip-flops. In another embodiment, the registers 661, 662, and 663 may contain non-volatile memories, including NOR flash memory, magneto-resistive random-access memory (MRAM), and ferroelectric random-access memory (FRAM).

The input register 661 stores and outputs input data, IN0-INn, to the AI circuits 609a to 609n. The weight register 662 stores and outputs weight data, W00-n to Wm0-n, to the AI circuits 609a to 609n. Please notice, each input data, IN0-Inn, and each weight data, W00-n to Wm0-n, may contain multiple bytes of data, which is determined by the desired data structure, as described in previous paragraphs. Each AI circuit 609a to 609n may perform multiplication and accumulation operations from the input data and weight data to generate output data, P00 to Pmn, as described in FIG. 37-47B. Afterward, the final output data, P0n to Pmn, will be sent to the output register 663 for the next operations.

FIG. 48B shows an embodiment of a complete AI processing architecture based on the AI circuit array 660 shown in FIG. 48A according to the invention. The architecture contains an AI circuit array 660 that comprises multiple AI circuits such as 609a to 609n, input register 661, weight register 662, and output register 663. The architecture also contains a controller unit 664 that may access main memory 667 through a host 666. The main memory 667 may be implemented using external DRAM or embedded DRAM to achieve high storage capacity.

The main memory 667 stores the weights of AI models, such as large language models. The controller unit 664 transfers the weights from the main memory 667 to the weight register 633, and input data to input register 661, to enable the AI circuits 609a to 609n to perform the multiplication and accumulation operations described previously. After the output is generated, the output register 663 will send the output to the activation unit 665 to process the output with the activation function.

In a typical AI architecture, the registers 661, 662, and 663 may be configured with memory capacity sufficient to align the data throughput of the main memory 667 with the processing throughput of the AI circuits 609a to 609n. In another embodiment, the registers 661, 662, and 663 may be implemented with increased memory capacity, such as using SRAM cells, to enable preloading of large volumes of data from the main memory 667. This configuration reduces repeated access to the main memory 667, thereby improving data transfer latency and lowering power consumption. This embodiment may be referred to as a “near-memory computing” architecture.

It should be noted that, for all embodiments of the invention, the numbers of inputs, outputs, cells, and data are provided as examples only. Variations in these numbers remain within the scope of the invention. Additionally, all circuit implementations and operations presented in the above embodiments are illustrative examples. Minor modifications to these implementations or operations also fall within the scope of the invention.

While exemplary embodiments of the present invention have been shown and described, it will be obvious to those with ordinary skill in the art that based upon the teachings herein, changes and modifications may be made without departing from the exemplary embodiments and their broader aspects. Therefore, the appended claims are intended to encompass within their scope all such changes and modifications as are within the true spirit and scope of the exemplary embodiments of the present invention.

What is claimed is:

1. An AI processing apparatus, comprising:
a memory array configured to store weight data including positive and negative values represented in binary integer and fraction parts with corresponding power-of-two values;
a multiply-accumulate (MAC) circuit coupled to the memory array and configured to receive input data, the MAC circuit comprising a plurality of unit circuits each configured to generate a current representative of a product of an input data bit and a weight data bit, with sign handling to produce currents in opposing directions or selectively enabled paths for positive and negative products;
a summing node coupled to the unit circuits and configured to sum the currents to produce a summed voltage representative of a net signed accumulation;
a comparator circuit coupled to receive the summed voltage and configured to compare the summed voltage against a plurality of reference voltages to generate comparison outputs, wherein the reference voltages are adjustable or dynamically scaled;
an encoder coupled to the comparator circuit and configured to encode the comparison outputs into a multi-bit digital representation; and
an activation circuit coupled to the encoder and configured to apply a non-linear activation function to the digital representation to produce a final output, wherein the MAC circuit is further configured to process floating-point data by sequentially handling exponent and fraction components to generate and combine intermediate results corresponding to different power-of-two levels.

2. The AI processing apparatus of claim 1, wherein each unit circuit comprises a first transistor having a gate coupled to receive the input data bit, a second transistor having a gate coupled to receive the weight data bit, and a third transistor configured to receive a sign bit to control current flow direction or enablement for positive and negative products.

3. The AI processing apparatus of claim 1, wherein the sign handling comprises directing currents to opposing output paths or selectively enabling paths based on the sign of the weight data bit, such that positive and negative products contribute differentially to the summed voltage.

4. The AI processing apparatus of claim 1, further comprising a current mirror circuit coupled between the summing node and the comparator circuit, the current mirror circuit configured to mirror differential currents corresponding to positive and negative contributions and generate the summed voltage provided to the comparator circuit.

5. The AI processing apparatus of claim 1, wherein the comparator circuit comprises a plurality of latch-type comparators, each including cross-coupled transistors forming a latch and isolation transistors configured to ratio currents from the summed voltage and a reference before developing latch data.

6. The AI processing apparatus of claim 1, wherein the encoder comprises a plurality of data latches configured to sequentially set data bits from a most significant bit to a least significant bit based on the comparison outputs, with each data bit controlling a scaled adjustment to subsequent reference voltages to implement successive approximation.

7. The AI processing apparatus of claim 1, wherein the MAC circuit is divided into a plurality of smaller MAC sub-circuits, each sub-circuit processing a subset of the input data and weight data to generate partial outputs, and further comprising an adder circuit configured to combine the partial outputs into the summed voltage representative of the net signed accumulation.

8. The AI processing apparatus of claim 1, wherein the MAC circuit is configured to process the floating-point data by sequentially applying exponent bits and fraction bits to generate intermediate results for respective power-of-two levels, and wherein the intermediate results are combined according to their respective powers to form the net signed accumulation.

9. The AI processing apparatus of claim 1, wherein the reference voltages are dynamically scaled such that each comparison output controls a transistor to add or subtract a scaled current from the next reference voltage, thereby enabling successive approximation encoding of the multi-bit digital representation.

10. The AI processing apparatus of claim 1, wherein the activation circuit is configured to apply one of a sigmoid function, ReLU function, or tanh function to the digital representation, and the apparatus is further configured to support back-propagation operations for neural network training by propagating errors through the memory array.

11. The AI processing apparatus of claim 1, wherein the memory array is a three-dimensional (3D) memory array, and the weight data and input data are represented using binary integer parts and binary fraction parts, with each bit corresponding to a power-of-two value, and wherein the apparatus is configured to process minimum and maximum ranges defined by the binary representations.

12. The AI processing apparatus of claim 1, wherein the MAC circuit is configured to sequentially load bits of the input data over time while the weight data remains stored in the memory array, accumulating partial products from each sequential bit to form the net signed accumulation.

13. A neural network computing system, comprising:
a memory array configured to store weight data including positive and negative values represented in binary integer and fraction parts with corresponding power-of-two values and minimum/maximum ranges, the memory array serving as synapses interconnecting multiple neuron layers of the neural network;
a multiply-accumulate (MAC) circuit coupled to the memory array and configured to receive input data representing activations from a prior neuron layer, the MAC circuit comprising a plurality of unit circuits each configured to generate a current representative of a product of an input data bit and a weight data bit, with sign handling to produce currents in opposing directions or selectively enabled paths for positive and negative products;
a summing node coupled to the unit circuits and configured to sum the currents to produce a summed voltage representative of a net signed accumulation corresponding to a neuron output in a subsequent layer;
a comparator circuit coupled to receive the summed voltage and configured to compare the summed voltage against a plurality of reference voltages to generate comparison outputs, wherein the reference voltages are adjustable or dynamically scaled;
an encoder coupled to the comparator circuit and configured to encode the comparison outputs into a multi-bit digital representation; and
an activation circuit coupled to the encoder and configured to apply a non-linear activation function to the digital representation to produce a final neuron output for propagation to a next neuron layer, wherein the MAC circuit is further configured to process floating-point data by sequentially handling exponent and fraction components to generate and combine intermediate results corresponding to different power-of-two levels.

14. The system of claim 13, wherein each unit circuit includes a first transistor gated by the input data bit, a second transistor gated by the weight data bit, and a third transistor controlled by a sign bit to direct current flow for positive or negative products.

15. The system of claim 13, wherein the MAC circuit is configured to sequentially load bits of the input data over time while the weight data remains stored, accumulating partial products to form the net signed accumulation.

16. The system of claim 13, wherein the sign handling comprises differential paths for positive and negative currents, such that positive products contribute positively and negative products contribute negatively to the net signed accumulation voltage.

17. The system of claim 13, further comprising a controller configured to perform back-propagation training by propagating error signals backward through the neuron layers and updating the weight data stored in the memory array.

18. A method for performing computations in a neural network using in-memory processing, comprising:
storing weight data, including positive and negative values represented in binary integer and fraction parts with corresponding power-of-two values and minimum/maximum ranges, in a memory array that functions as synapses connecting neuron layers of the neural network;
receiving input data representing activations from a prior neuron layer;
generating, in a multiply-accumulate (MAC) circuit coupled to the memory array, signed currents at a plurality of unit circuits, each current corresponding to a product of an input data bit and a weight data bit, with sign handling producing currents in opposing directions or selectively enabled paths for positive and negative products;
summing the signed currents to produce a summed voltage representative of a net signed accumulation for a neuron output;
comparing the summed voltage against a plurality of reference voltages to generate comparison outputs, wherein the reference voltages are adjustable or dynamically scaled;
encoding the comparison outputs into a multi-bit digital representation; and
applying a non-linear activation function to the digital representation to produce a final neuron output for propagation to a subsequent neuron layer, wherein the MAC circuit processes floating-point data by sequentially handling exponent and fraction components to generate and combine intermediate results corresponding to different power-of-two levels.

19. The method of claim 18, wherein generating the signed current at each unit circuit comprises applying the input data bit to a gate of a first transistor, the weight data bit to a gate of a second transistor, and a sign bit to control a third transistor for directing current flow based on the sign.

20. The method of claim 18, wherein the MAC circuit sequentially loads bits of the input data over time while the weight data remains stored, accumulating partial products from each sequential bit to form the net signed accumulation.
